(19) United States
(12) Patent Application Publication
(10) Pub. No.: US 2014/0285375 A1
(43) Pub. Date: Sep. 25, 2014

(54) SYNTHETIC APERTURE RADAR APPARATUS AND METHODS

(71) Applicant: SADAR 3D, Inc., St. Louis, MO (US)

(72) Inventor: Stephen Bryan Crain, St. Louis, MO (US)

(73) Assignee: SADAR 3D, Inc., St. Louis, MO (US)

(21) Appl. No.: 14/209,442

(22) Filed: Mar. 13, 2014

Related U.S. Application Data
(63) Continuation of application No. PCT/US2012/055256, filed on Sep. 13, 2012.
(60) Provisional application No. 61/534,183, filed on Sep. 13, 2011.

(51) Int. Cl. G01S 13/90

(52) U.S. Cl. CPC G01S 13/90
USPC 342/25 A

(57) ABSTRACT

Synthetic aperture radar apparatus and methods provide for a compact and usable system to scan behind and underneath surfaces. A synthetic aperture radar pod can be portable and self contained for low cost and ease of transportation. The synthetic aperture radar system may be used at close range to the target area without a fixed and predetermined scan pattern and still provide usable three dimensional images of a surface and/or what is behind or beneath the surface. In some embodiments, the synthetic aperture radar apparatus may be used with common vehicles not dedicated to scanning to provide a useful three dimensional image.

### CROSS-REFERENCE TO RELATED APPLICATIONS

This application is a continuation of PCT/US2012/055256, filed Sep. 13, 2012, and claims priority to U.S. Provisional Patent Application No. 61/534,183, filed Sep. 13, 2011, each of which is hereby incorporated by reference in its entirety.

### FIELD OF THE INVENTION

The present invention is directed generally to radar, and more particularly to apparatus and methods associated with synthetic aperture radar.

### BACKGROUND OF THE INVENTION

Synthetic aperture radar (SAR) is defined by the use of relative motion between an antenna and its target region to provide distinctive signal variations used to obtain finer resolution than is possible with conventional radar. SAR uses an antenna from which a target scene is repeatedly illuminated with pulses of radio waves from different antenna positions. The reflected radio waves are processed to generate an image of the target region.

A particular example of an SAR apparatus is disclosed in U.S. Pat. No. 6,094,157 (“the '157 patent”), which is hereby incorporated by reference in its entirety. The '157 patent discloses a ground penetrating radar system which uses an oblique or grazing angled radiation beam oriented at a Brewster angle to provide improved coupling of radar energy into the earth, reducing forward and back scatter and eliminating the need to traverse the surface of the earth directly over the investigated volume. An antenna head is moved along a raster pattern lying in a vertical plane. The antenna head transmits and receives radar signals at regular intervals along the raster pattern. In particular, measurements are taken at thirty-two spaced intervals along the width of the raster pattern at thirty-two vertical increments, providing a total of 1,024 transmit/receive positions of the antenna head. For reliably moving the antenna head along the raster pattern, the antenna head is mounted on a horizontal boom supported by an upright telescoping tower. The antenna head is movable along the horizontal boom by a cable and pulley assembly. The antenna head is movable vertically by movement of the telescoping tower. The horizontal boom and telescoping tower provide a relatively “rigid” platform for the antenna head to enable reliable movement of the antenna head to predetermined positions along the raster pattern. Processing of the radar signals received along the raster pattern yields a three-dimensional image of material beneath the surface of the earth.

Although the basic theory of SAR is known, practical use of this technology has encountered numerous formidable barriers. The present invention is directed to providing usable, practical, and economical SAR solutions.

### SUMMARY OF THE INVENTION

In one aspect, the present invention includes a synthetic aperture radar pod adapted for movement along a scan path for scanning material in a volume beneath a surface of the volume at a scan area. The synthetic aperture radar pod includes a support structure and a radar system mounted on the support structure. The radar system includes a radar transmitter for providing an electromagnetic wave signal. The radar system also includes antenna structure operatively connected to the radar transmitter for receiving the electromagnetic wave signal from the radar transmitter and producing a radar signal in response to receiving the electromagnetic wave signal. A radar receiver is operatively connected to the antenna structure for receiving reflected radar signals from the antenna structure. The reflected radar signals indicate distance of the material beneath the surface of the volume from the antenna structure in time delay from production of the radar signal. The pod also includes a position indicating system mounted on the support structure adapted to generate information indicative of a position of the radar system corresponding to transmitted and received radar signals.

In another aspect, the present invention includes a method of operating a radar unit capable of providing data for generating a three-dimensional image. The method includes emitting a radar signal from the radar unit toward the scan area as the radar unit moves and receiving reflected radar signals from the scan area with the radar unit as the radar unit moves. Information indicative of the position of the radar unit is generated in real time. The position of the radar unit is correlated with the emitted and received reflected radar signals.

In yet another aspect, the present invention includes a method of scanning material beneath a surface of the earth and scanning a topography of the surface of the earth at an area of interest. The method includes performing a synthetic aperture radar scan of the area to collect image data representing material beneath the surface of the earth at the area. The synthetic aperture radar scan includes the steps of orienting an antenna structure toward a scan area, moving the antenna structure along a scan path, and directing a radar signal from the antenna structure toward the scan area. The scan also includes the steps of receiving radar signals reflected from material beneath the surface of the earth with the antenna structure and generating information indicative of position of the phase centers corresponding to transmitted and received radar signals. The method also includes collecting image data representing the topography of the surface of the earth at the area.

In yet another aspect, the invention includes a method of performing a synthetic aperture radar scan and repeating a signal. The method includes performing a synthetic aperture radar scan using a radar unit including a radar system to collect image data representing material beneath the surface of a volume at a scan area. The synthetic aperture radar scan includes the steps of orienting an antenna structure toward the scan area, moving the antenna structure along a scan path, directing a radar signal from the radar structure toward the scan area, receiving reflected radar signals with the antenna structure, and indicating the positions of the radar system corresponding to transmitted and received radar signals. The method also includes repeating a signal with a repeater onboard the radar unit to transmit the signal to a location away from the scan area.

In yet another aspect, the invention includes a method of performing a synthetic aperture radar scan of an area to collect image data representing material beneath a surface of the earth and collect image data representing a topography of the surface of the earth. The method includes orienting an antenna structure toward a scan area and moving the antenna structure along a scan path. The method also includes directing a radar signal having of a first frequency band from the antenna structure toward the scan area and reflecting the radar signal off material beneath the surface of the earth at the scan area. The method also includes directing a radar signal having of a second frequency band higher than the first frequency band from the antenna structure toward the area and reflecting the radar signal off the surface of the earth. Reflected radar signals are received with the antenna structure. The received reflected radar signals provide image data representing the material beneath the surface of the earth and the topography of the surface of the earth.

Other objects and features will be in part apparent and in part pointed out hereinafter.

### BRIEF DESCRIPTION OF THE DRAWINGS

FIG. 1 is a diagrammatic view showing a scan of a surface area and adjoining underground volume using a synthetic aperture radar (SAR) system according to the present invention;

FIG. 2 is the diagrammatic view of FIG. 1 showing a different scanning pattern;

FIG. 3 is a diagrammatic plan view of the scan illustrated in FIG. 1;

FIG. 4 is an enlarged view of FIG. 3 showing an SAR pod attached to the end of a boom;

FIG. 5 is a diagrammatic side view of an SAR scan illustrating vertical movement during scanning;

FIG. 6 is a plan view similar to FIG. 4, but illustrating the scan area as a portion of the total surface area illuminated by the SAR without reorientation of the SAR pod;

FIG. 7 is the view similar to FIG. 6, but illustrating reorientation of the SAR pod during scanning;

FIG. 8 is a diagrammatic view illustrating possible components of the SAR pod;

FIG. 9 is a diagrammatic view illustrating the electrical connections of various components of the SAR system;

FIG. 10 is a block diagram showing components of a suitable radar device of the SAR system;

FIG. 11 is a block diagram showing data processing components of the SAR system;

FIG. 12 is a front elevation of an SAR pod of a second embodiment shown mounted on a fragmentary portion of the boom;

FIG. 13 is a left side elevation of the SAR pod of FIG. 12;

FIG. 14 is the elevation of FIG. 13, but illustrating relative movement of antenna structure of the SAR pod;

FIG. 15 is a top plan view of the SAR pod of FIG. 12;

FIG. 16 is a vertical section of the SAR pod of FIG. 15;

FIG. 17 is a block diagram showing components of the SAR pod of FIG. 12;

FIG. 18 is a diagrammatic plan view showing a scan using the SAR pod of FIG. 12;

FIG. 19 is an enlarged portion of FIG. 18 showing the SAR pod at one location in the scan;

FIG. 20 schematically illustrates a vision system showing maintaining the target;

FIG. 21 is the schematic of FIG. 20 showing variance from the target;

FIG. 22 is the schematic of FIG. 20 showing a first different variance from the target;

FIG. 23 is the schematic of FIG. 20 showing a second different and large variance from the target;

FIG. 24 is a diagrammatic plan view showing a scan similar to FIG. 18, but showing a non-centrally located target;

FIG. 25 is a schematic elevation showing the SAR pod in a scanning position and in a raised position for acquiring an image with a camera associated therewith;

FIG. 26 schematically illustrates acquisition of images of both a subsurface volume and an adjoining surface of a scan area;

FIG. 27 is a front elevation of an SAR pod of a third embodiment and a fragmentary portion of a boom on which the SAR pod is mounted;

FIG. 28 is a front elevation similar to FIG. 27 of an SAR pod of a fourth embodiment;

FIG. 29 is a schematic top plan view showing the SAR pod of FIG. 27 during a scan;

FIG. 30 is a schematic top plan view showing the SAR pod during a scan having an undesired positional variance;

FIG. 31 is a schematic top plan view showing the SAR pod during a scan in which periodic interruptions of imaging data occur;

FIG. 32 is a schematic top plan view showing the SAR pod during a scan in which multiple possible pod positions are obtained;

FIG. 33 is a front elevation of an SAR pod of a fifth embodiment and a fragmentary portion of a boom on which the SAR pod is mounted;

FIG. 34 is a left side elevation thereof;

FIG. 35 is a schematic top plan view showing the SAR pod of FIG. 33 during a scan and illustrating pod aiming;

FIG. 36 is a front elevation of an SAR pod of a sixth embodiment and a fragmentary portion of a boom on which the SAR pod is mounted;

FIG. 37 is a front elevation of an SAR pod of a seventh embodiment and a fragmentary portion of a boom on which the SAR pod is mounted;

FIG. 38 is a schematic top plan view of the SAR pod of FIG. 37 during a laser radar scan to obtain an image of the topography of the scan area;

FIG. 39 is a schematic illustration of the combination of topographic and subsurface scans for the scan area;

FIG. 40 is a front elevation of an SAR pod of a eighth embodiment and a fragmentary portion of a boom on which the SAR pod is mounted;

FIG. 41 is a left side elevation thereof;

FIG. 42 is a front elevation of an SAR pod of a ninth embodiment and a fragmentary portion of a boom on which the SAR pod is mounted;

FIG. 43 is a block diagram showing components of a radar device of the SAR pod of FIG. 42;

FIG. 44 is a block diagram showing components of a radar device of an SAR system of a tenth embodiment;

FIG. 45 is a perspective of an eleventh embodiment of a radar system incorporating a utility truck;

FIG. 46 is an elevation showing a twelfth embodiment of a radar system supported by an excavator;

FIG. 47 is an elevation showing the radar system and excavator of FIG. 46 being used to dig;

FIG. 48 is a side elevation of a thirteenth embodiment of a radar system supported away from a bucket of an excavator;

FIG. 49 is a side elevation of a fourteenth embodiment of a radar system supported on a bucket of an excavator;

FIG. 50 is an enlarged perspective of a bucket of the excavator and an SAR pod of the radar system of FIG. 49;

FIG. 51 is the enlarged perspective of FIG. 50, but with the SAR pod removed from the bucket but with a mounting bracket remaining on the bucket;

FIG. 52 is the enlarged perspective of FIG. 51 showing the mounting bracket exploded off of the bucket;

FIG. 53 is a perspective of a radar system and excavator of a fifteenth embodiment;

FIG. 54 is a side elevation of a radar system and lift of a sixteenth embodiment;

FIG. 55 is a perspective of the radar system and vehicle of a seventeenth embodiment;

FIG. 56 is a perspective view of a radar system of a seventeenth embodiment supported on an extendable ladder of a fire truck;

FIG. 57 is a diagrammatic illustration of a radar system of an eighteenth embodiment employing a remote computer;

FIG. 58 is a top plan view of a backhoe guided by information from a radar system of the present invention to avoid underground pipes;

FIG. 59 is a fragmentary side elevation of FIG. 58;

FIG. 60 is an elevation of a field computer showing planned, overlapping scans of an area on an aerial view;

FIG. 61 is the field computer of FIG. 60, but showing more proposed scan areas;

FIG. 62 is a hand held device showing planned overlapping scans of an area on an aerial view;

FIG. 63 is a diagrammatic plan view illustrating common reference points between adjacent scan areas;

FIG. 64 is an elevation of a field computer showing a street level view of an area to be scanned;

FIG. 65 is the elevation of FIG. 64, but showing certain objects in the view “lassoed”;

FIG. 66 is a diagrammatic plan view of a scan in which scan locations and movements are limited by the environment;

FIG. 67 is a diagrammatic elevation of different configurations for controlling movement of a boom supporting a radar system of the present invention;

FIG. 68 is an elevation of a mechanical stop attached to a control lever for controlling movement of a boom with the control lever in a neutral position;

FIG. 69 is the elevation of FIG. 68, but showing an end of motion position of the mechanical stop and control lever; and

FIG. 70 is an elevation of an automatically actuated stop attached to a control lever for controlling movement of a boom.

Corresponding reference characters indicate corresponding parts throughout the drawings.

### DETAILED DESCRIPTION OF THE DRAWINGS

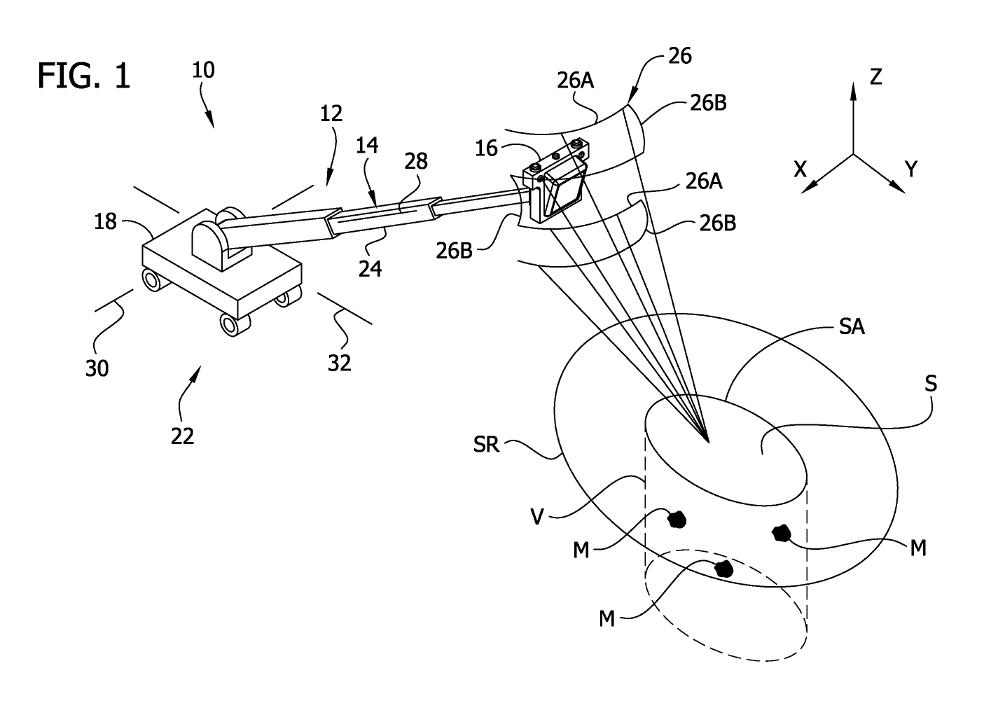

Referring to FIG. 1, an embodiment of a synthetic aperture radar (SAR) system of the present invention is designated generally by the reference number 10. The SAR system generally includes a vehicle 12 including a boom 14 and an SAR pod 16 mounted on the boom. The SAR pod 16 uses side-looking, oblique angle radar. As explained in further detail below, the SAR pod 16 may be used for collecting data for imaging of features that are on the same side of a surface S of a volume V as the SAR pod and/or within the volume on the opposite side of the surface from the SAR pod. For example and without limitation, the SAR pod may be used for imaging features below and/or above the surface of the earth (e.g., underground features and/or topography) or for imaging features outside or beneath a surface of a structure (e.g., outside or inside a building). In the illustrated embodiment, the SAR system is performing an SAR scan for generating a three-dimensional image of features above and/or beneath the surface S of a volume V of the earth.

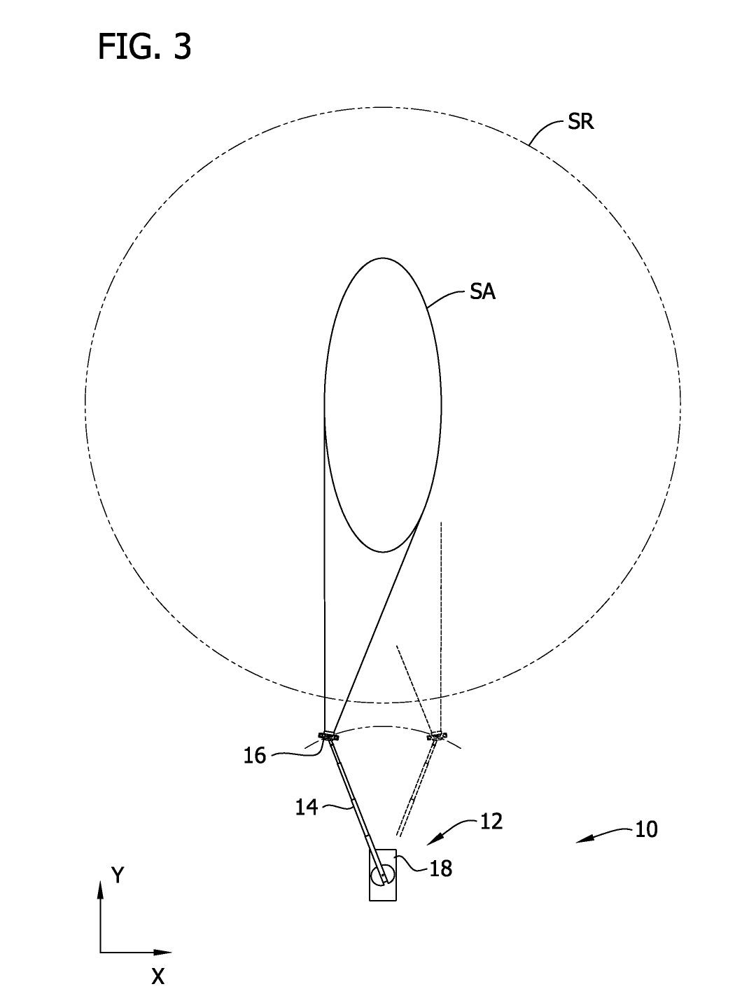

Referring to FIGS. 1 and 3, the vehicle 12 is positioned beside a scan region SR which includes a scan area SA. The vehicle 12 includes a base 18 supporting the boom 14. The boom 14 includes a proximal end connected to the base 18 and a distal free end on which the SAR pod 16 is mounted. The vehicle 12 may comprise any movable or stationary base adapted for supporting the boom 2014 and for moving the boom with respect to the scan region SR. The base 18 may include a drive system that moves the boom 16 with respect to the scan region SR. The drive system can move the boom 16 in at least one of any direction suitable for performing a scan. The vehicle 12 may include a ground-engaging movement system 22 such as driving or non-driving wheels or tracks. For example and without limitation, the vehicle 12 may comprise a truck, excavation vehicle, skid, or trailer, as will be explained in further detail below. The vehicle 12 may be dedicated for SAR scans, or the vehicle may used for several purposes (e.g., excavation, construction, utility line service).

The boom 14 includes an arm 24 which is movable for moving the SAR pod 16 along a raster pattern 26 for transmitting radar signals toward the scan area SA and receiving radar signals reflected from the scan area. The arm 24 includes a longitudinal axis 28 which extends upwardly and laterally away from the base 18, typically toward the scan area SA. The end of the boom 14 mounting the SAR pod 16 extends downwardly at an angle away from the SAR pod. This orientation of the boom 14 with respect to the SAR pod 16 assists in preventing false reflections due to multipath, which is explained in greater detail below. The boom 14 is rotatable about a generally horizontal axis 30 for moving the SAR pod 16 vertically (in a Z-direction) with respect to the scan area SA, and the boom is rotatable about a generally vertical axis 32 for moving the SAR pod horizontally (in X- and Y-directions) with respect to the scan area. Radar signals may be transmitted and received while the SAR pod 16 is moved along the raster pattern 26. Desirably, radar signals may be transmitted and received periodically or continuously while the SAR pod 16 is moved along the raster pattern 26.

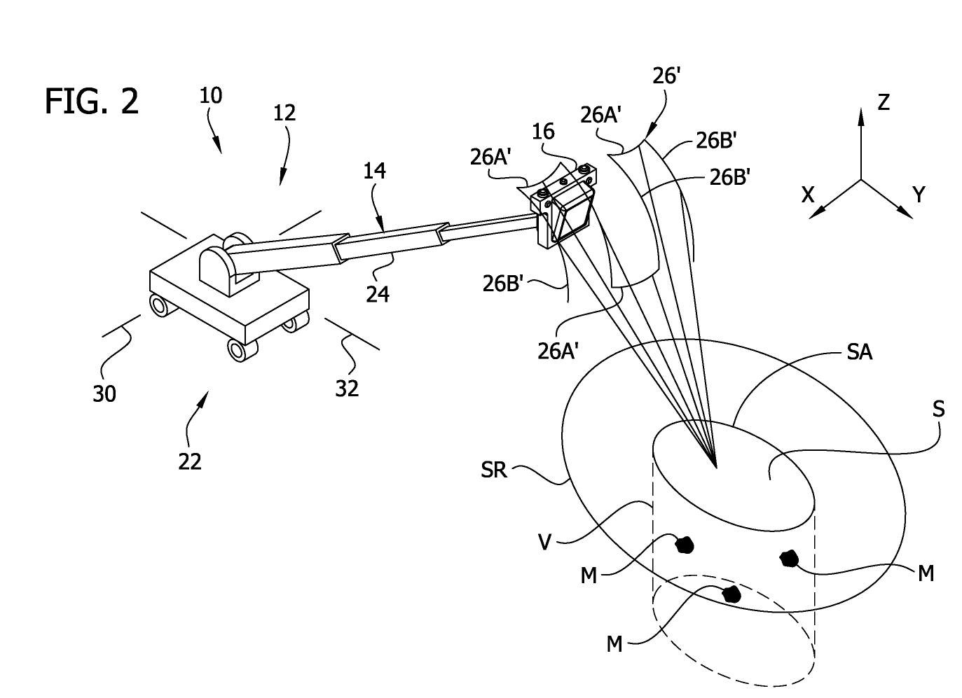

It may be desirable to transmit radar signals and receive reflected radar signals along a generally uniform raster pattern including various vertical and horizontal positions with respect to the scan area SA to reliably collect sufficient image data for generating the three-dimensional image and for providing desired image resolution. The illustrated raster pattern 26 includes multiple scan paths 26A, 26B arranged in a serpentine pattern. Primary scan paths 26A are oriented generally horizontally, and secondary scan paths 26B are oriented generally vertically. Radar signals may be transmitted and received along both the primary and secondary scan paths 26A, 26B, or only along one of the scan paths (usually the primary). Other patterns may be used without departing from the scope of the present invention. In general, a path that varies the position of the SAR pod both horizontally and vertically will be employed, which may or may not be properly characterized as a “raster”. Moreover, a single path (e.g., single scan path 26A or 26B) extending substantially along a single arc, in a single plane or substantially a straight line may be used without departing from the scope of the present invention. In one embodiment, the scan might be performed by changing the length of the boom. In other embodiments, a random raster pattern, a less-uniform serpentine raster pattern, or a non-serpentine raster pattern may be used. Moreover, raster patterns having other numbers of primary and secondary scan paths may be used without departing from the scope of the present invention. FIG. 2 illustrates an alternative raster pattern 26′ having primary scan paths 26A′ extending generally vertically and secondary scan paths 26B′ extending generally horizontally.

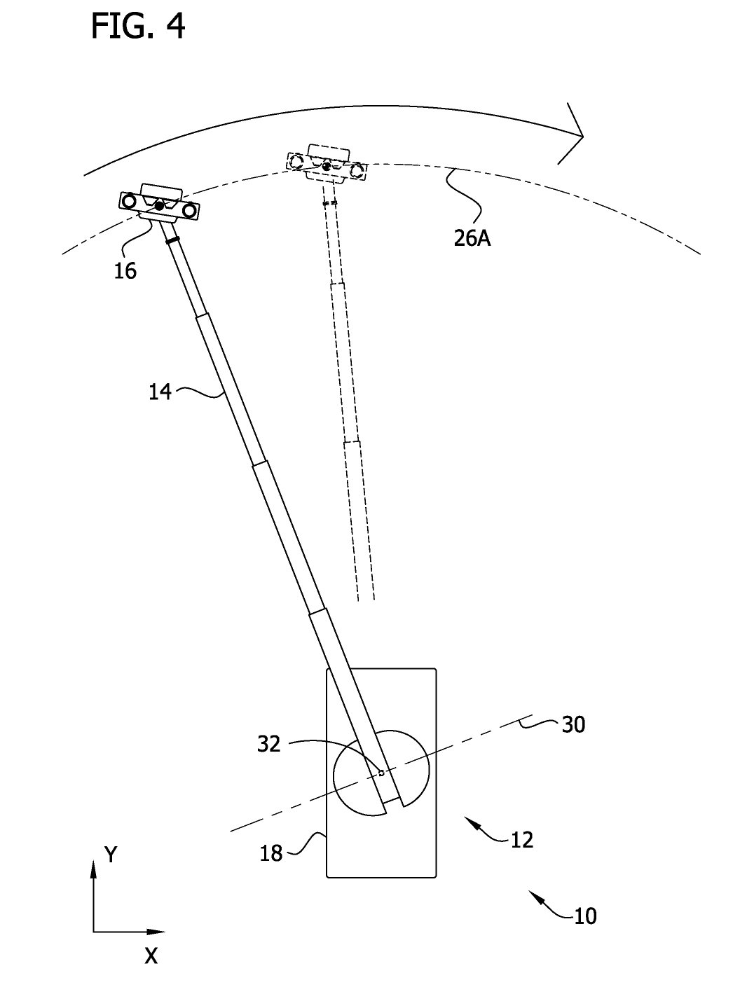

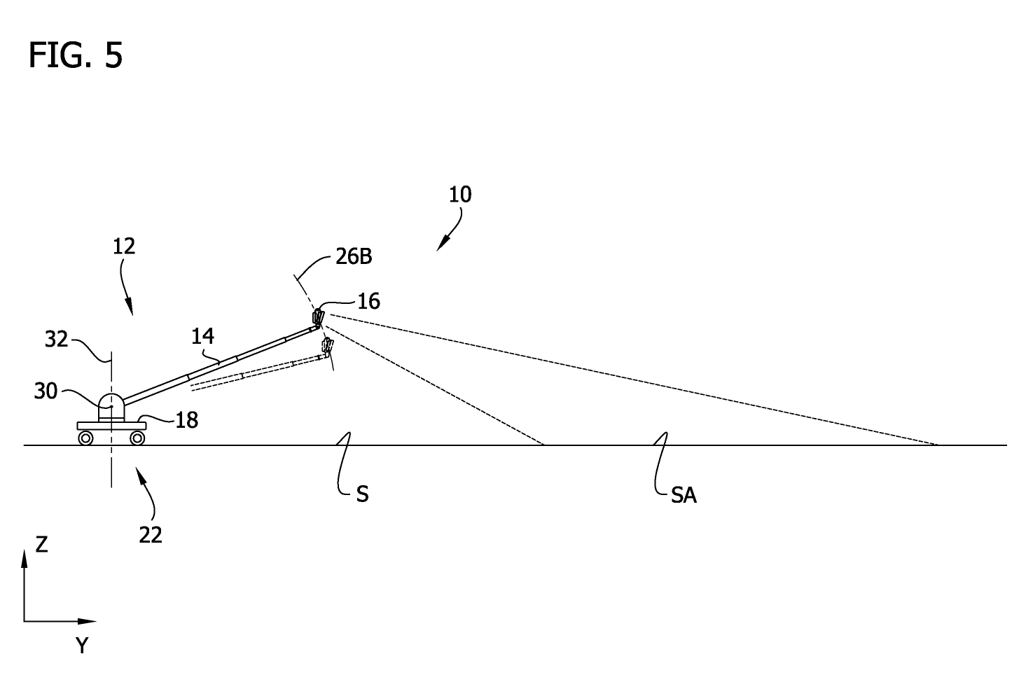

Referring again to FIG. 1, the illustrated scan paths 26A, 26B are arcuate. Rotation of the boom 14 about the axes 30, 32 while maintaining a generally constant length of the boom causes the SAR pod 16 to move along an arcuate path. For example and without limitation, FIG. 4 illustrates the boom 14 rotating about the generally vertical axis 32, producing a generally horizontal arcuate scan path 26A. FIG. 5 illustrates the boom 14 rotating about the generally horizontal axis 30, producing a generally vertical arcuate scan path 26B. As shown in FIGS. 4 and 5, the arcuate scan paths 26A, 26B have a concave side facing the vehicle 12 or respective axis of rotation 30, 32 of the boom 14, and the arcuate scan paths have a convex side facing away from the vehicle or respective axis of rotation of the boom. The scan area SA is positioned on the convex side of each scan path 26A, 26B. The SAR pod 16 transmits radar signals and received reflected radar signals on the convex sides of the scan paths. Use of radar in this way may be referred to as “convex axial radar.” In some embodiments, as a result of the arcuate primary and secondary scan paths 26A, 26B, the raster pattern 26 lies in a raster window approximating a segment of a surface of a sphere.

Other scan paths may be used without departing from the scope of the present invention. For example and without limitation, one or more of the scan paths of the raster pattern may not be arcuate. As described in further detail below, the SAR pod 16 may be mounted on a wide variety of vehicles having booms, which may move the SAR pod in raster patterns having scan paths of various shapes. Moreover, the length of the boom 14 may be changed while moving the SAR pod 16 along a scan path, which may alter the shape of the scan path.

Referring to FIGS. 1 and 5, the orientation of the boom 14 angling downward and away from the SAR pod 16 assists in preventing false radar reflections due to multipath. With this orientation, radar signals are less likely to reflect off the boom 14 and be received as reflected signals by the SAR pod 16. In particular, reflected radar signals traveling toward the SAR pod but which encounter the boom will likely be reflected off the boom downward toward the ground rather than upward toward the SAR pod. Multipath propagation interference is a phenomenon that results in radio signals reaching a radar receiving antenna by two or more paths. In radar signal processing, multipath causes ghost targets to appear, deceiving the radar receiver. Such ghost target echoes are problematic because they tend to behave like the normal targets of which they echo, creating difficulty in isolation of valid targets. There are many causes of multipath, however minimization of undesired multipath reflectivity of the boom 14 and vehicle 12 is preferred.

The SAR pod 16 is designed to focus majority of radar signal propagation in the direction of the scan area SA. However, while directionally focused antenna structures tend to propagate a majority of signal in an intended direction, propagation fields and propagation lobes tend to exist in all directions of antenna structures. While propagation fields exist in all directions, they are generally of reduced intensity outside of the main focused field, tending to have reduced propagation reception about the sides, and even further reduced propagation reception in the rear of the directional antenna structure of the SAR pod 16. Multipath reflectivity of the mounting structure (e.g., vehicle 12, boom 14) is directly related to the radar cross section (RCS) of the mounting structure, and its range, positional relationship and structural orientation, to the directional antenna structure of the SAR pod 16. Thus minimization of structural support multipath interference is accomplished by minimizing the RCS of the structural support.

According to one aspect of the present invention, structural support RCS may be minimized in several ways. The first is by positioning the mounting structure (e.g., vehicle 12, boom 14) behind the antenna structure of the SAR pod 16, and in the lower intensity propagation fields of the antenna structure. And also by utilization of angulation in the support boom 14 with respect to the scan area SA and antenna structure of the SAR pod 16, resulting in reflecting most of the undesired multipath target reflections away from the antenna structure.

As the SAR pod 16 is moved along the raster pattern 26, the transmitted radar signal desirably “illuminates” the entire scan area SA at each point of the raster pattern 26 where it is desired to transmit radar signals and receive reflected radar signals. This type of SAR scan may be referred to as a “spotlight” SAR scan. The transmitted and reflected signals received along the raster pattern 26 are used to generate a three-dimensional image of material M below and/or above the surface S at the scan area SA.

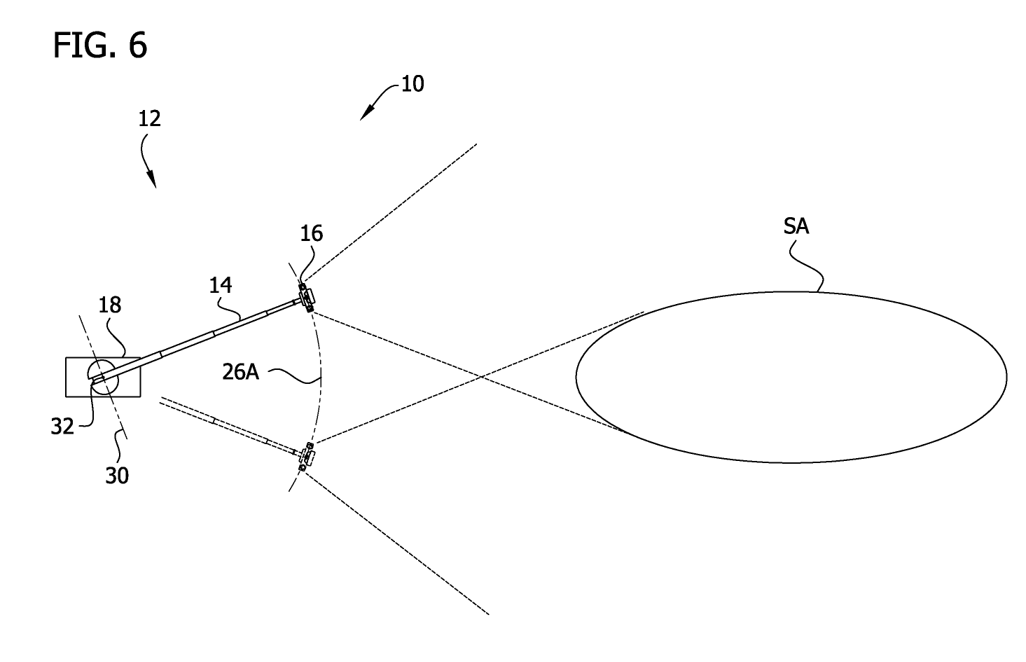

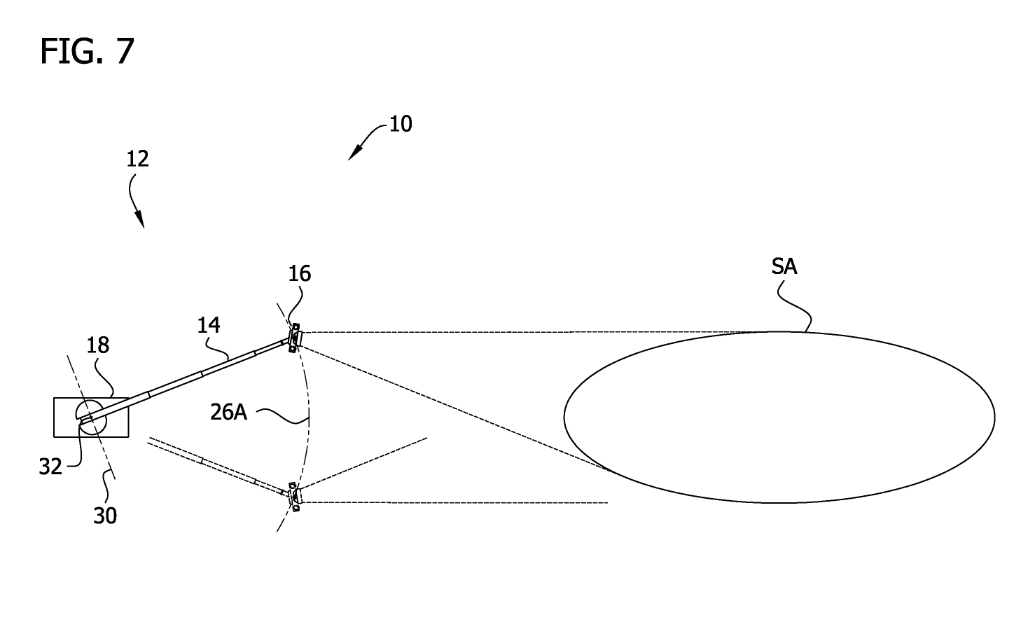

Referring to FIG. 6, the beam width of the transmitted radar signal may be sufficiently wide to illuminate the scan area SA at each point along the raster pattern 26. In FIG. 6, radar signals are shown transmitted from opposite ends of an arcuate scan path 26A, and the transmitted radar signals have beam widths sufficiently wide such that they overlap at the scan area SA. Referring to FIG. 7, the aim of the SAR pod 16 may be maintained in the direction of the scan area SA. By maintaining the radar signal aimed to a particular location, the scan area SA can be of maximum size. In some embodiments, the orientation of the transmitted radar signal may be rotated with respect to the boom 14 as the SAR pod 16 moves along the scan path to maintain the transmitted radar signals aimed toward the scan area SA. Various systems for maintaining aim of the transmitted signals will be described in further detail below. Desirably, as the SAR pod 16 is moved along the raster pattern 26, the transmitted radar signals are directed at a Brewster angle with respect to the surface S (e.g., from 10 to 35 degrees) at which the transmitted radar signals have best coupling with the surface. Radar signal transmission at the Brewster angle is explained in further detail in U.S. Pat. No. 6,094,157.

After completing an SAR scan of the scan area, it may be necessary to move the vehicle 12 or to move the boom 14 with respect to the vehicle to complete subsequent SAR scans having corresponding scan areas adjacent to the first scan area SA for covering the entire scan region SR, if desired. Adjacent scan areas may overlap each other to provide continuity between the scans (e.g., common above or below ground reference points are included in each of the respective sets of image data). Reference points included in adjacent scans may assist in generation of a combined image including the image data collected in each of the scans because the common reference points indicate position of the image data of one scan with respect the image data of overlapping scans.

The SAR pod 16 illustrated in FIG. 1 may be releasably or fixedly mounted on the boom 14. An aspect of the present invention is directed to a self-contained SAR pod 16 which includes essential features for collecting radar image data for generating a three-dimensional image. Such an SAR pod 16 is capable of convenient, efficient, and economical detachable mounting on and use with a wide variety of available boom type platforms, such as bucket trucks and man lift booms. In many cases, the re-purposing or multi-purposing of these boom platforms for SAR scanning may require little to no modification other than mounting the SAR pod 16 on the boom. However, in some embodiments, a radar system which is not part of an SAR pod may be used on a boom without departing from the scope of the present invention.

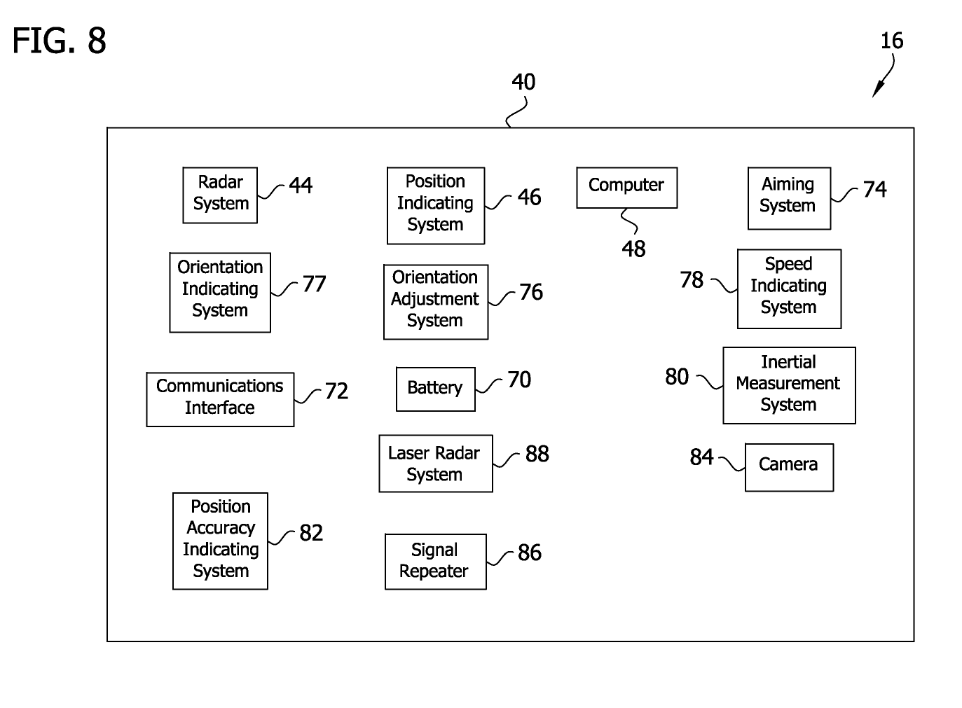

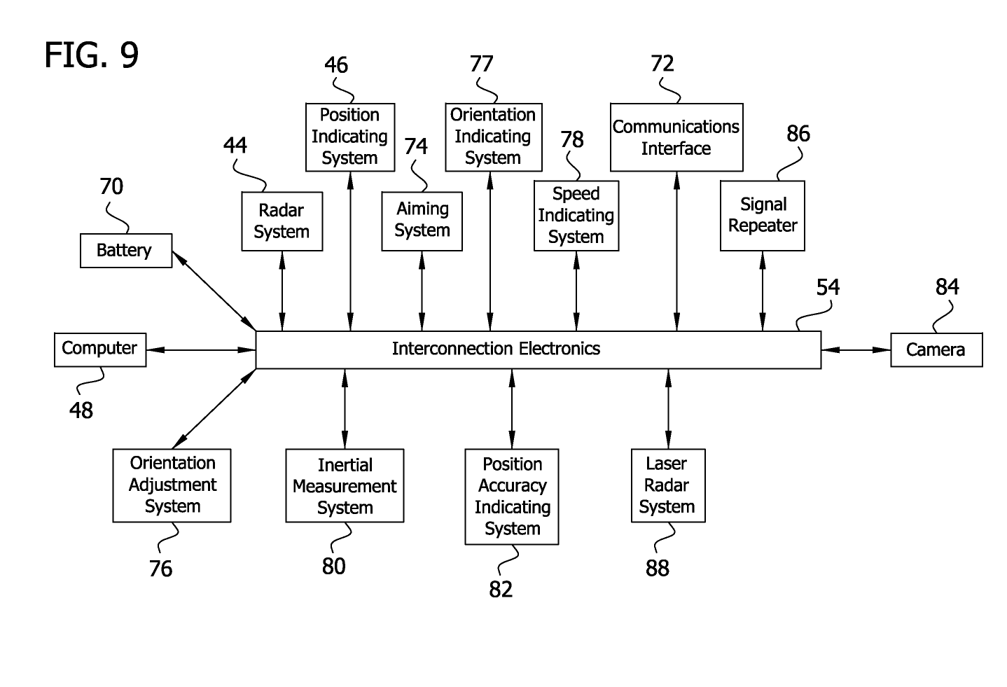

As shown schematically in FIGS. 8 and 9, an embodiment of an SAR pod 16 according to the present invention may include several components. The components may be in operative communication with each other via communication electronics including wireless or wired connections known in the art. The SAR pod 16 may include a support structure 40 on which the various components are mounted. The support structure may be a frame, housing, shell or other structure within which or on which the components of the SAR pod are housed or mounted. All of the components of the SAR pod 16 being mounted on the support structure 40 makes the pod self-contained and adapted for movement of all of the components together as a unit and separately from any other structure that is used to support the SAR pod in use.

The SAR pod 16 may include as basic components a radar system 44 and a position indicating system 46. The radar system 44 is adapted for transmitting radar signals and receiving reflected radar signals. The position indicating system 46 is adapted for generating information indicative of a position of the radar system 44 corresponding to transmitted and received radar signals. The position information is correlated to the radar signal image data for use in building a three-dimensional image. In one preferred embodiment, the position indicating system 46 is able to determine the position of the SAR pod 16 without requiring the pod to be moved along a predetermined path. For example and without limitation, the position indicating system 46 may be able to detect the position of the SAR pod 16 by an external (to the SAR pod) reference, such as a global positioning system or a target proximate to the SAR pod. Still further, the position indicating system 46 may be able to detect movement of the SAR pod 16 using internal sensors so that position relative to a starting point is always known. The SAR pod 16 may also include a computer 48 adapted for controlling the radar system 44 and position indicating system 46. The computer 48 may be adapted for processing the radar signals and position information for generating the three-dimensional image.

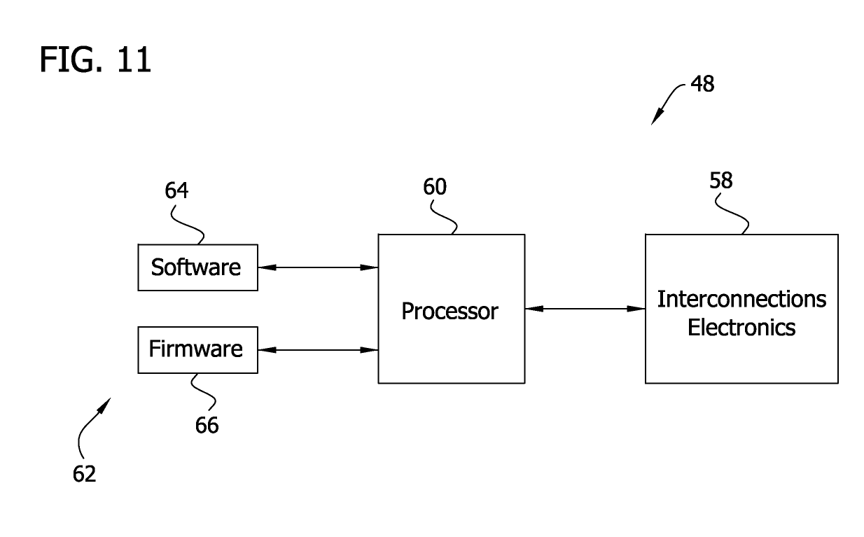

As shown schematically in FIG. 11, the radar system 44 may include a radar transmitter 50, a radar receiver 52, and antenna structure 54. The radar transmitter 50 is adapted for providing an electromagnetic wave signal. The antenna structure 54 is operatively connected to the radar transmitter 50 for receiving the electromagnetic wave signal from the radar transmitter and producing a radar signal in response to the receiving the electromagnetic wave signal. Desirably, the antenna structure 54 is oriented toward the scan area SA at a Brewster angle. The radar signal propagates toward the scan area SA. Radar signals may reflect from the scan area SA (above or below the surface S of the volume V) and return to the antenna structure 54. The antenna structure 54 is operatively connected to the radar receiver 52 for transmitting these reflected radar signals to the radar receiver. The reflected radar signals indicate distance from the antenna structure 54 to the material from which the radar signals reflected in time delay from production of the radar signals to reception of the reflected signals. The radar system 44 includes a mixer 56 for mixing the received reflected radar signals with the transmitted radar signals. The radar transmitter 50 may be adapted for continuously providing the electromagnetic wave signal to the antenna structure 54, and the radar receiver 52 may be adapted for continuously receiving reflected radar signals, such that the radar system 44 may transmit and receive radar signals continuously as for an entire scan path or for segments of a scan path. The movement of the SAR pod 16 along a scan path need not be stopped for transmitting and receiving the radar signals. The radar system 44 is shown in operative communication with the computer 48 via interconnection electronics 58, which may include wireless and/or wired connections known in the art.

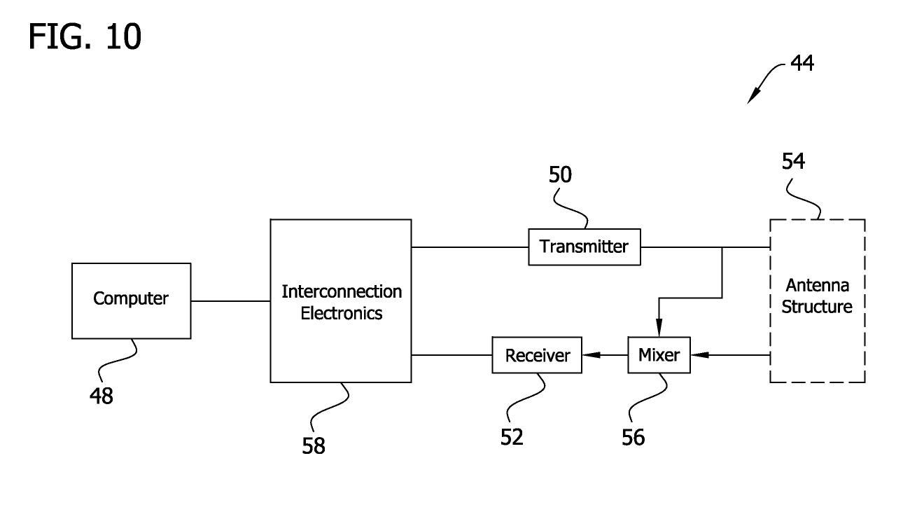

As shown schematically in FIG. 10, the computer 48 may include a processor 60 and a tangible computer readable storage medium 62 (data storage unit), which may include forms of readable and/or writable storage including software 64 and firmware 66. The processor is adapted for reading and executing instructions stored on the storage medium 62 and for storing data on the storage medium. As described in further detail below, the storage medium 62 may include various instructions for operating components of the SAR radar system 10, such as the SAR pod 16 and/or the boom 14. Although the computer 48 is illustrated in FIGS. 8 and 9 as being part of the SAR pod 16, it will be understood that the SAR pod computer 48 may be omitted and its functions carried out by a different computer in operative communication with the SAR pod, as will become apparent.

The position indicating system 46 may include various components, as described below with respect to different embodiments of the SAR pod 16. The position information is used by the computer 48 to build the three-dimensional image using the image data generated from the radar signals. The position indicating system 46 may be adapted for continuously indicating the position of the radar system 44 as the SAR pod 16 is moved along a scan path. Accordingly, the movement of the SAR pod 16 need not be stopped for measuring of the position of the radar system 44, and the SAR pod need not be stopped at predetermined intervals where the SAR pod has known positions. Desirably, the position indicating system 46 is adapted for indicating an X-position, a Y-position, and a Z-position of the radar system along respective X-, Y-, and Z-axes of a three-dimensional Cartesian coordinate system. For example and without limitation, the position indicating system 46 may include a GPS antenna, a total station, a prism for use with a total station, a positional encoder, and/or an inertial measurement device, as described in further detail below.

Desirably, the SAR pod 16 includes additional components which permit the SAR pod to be self-contained and usable without wired connections to components or devices not mounted on the support structure 40. For example and without limitation, referring again to FIG. 8, the SAR pod 16 may include a battery 70 for providing electrical power to the radar system 44, the position indicating system 46, the computer 48, and the other components of the SAR pod. The battery 70 enables the SAR pod 16 to be free from any wired connection to any external power source (i.e., a power source not mounted on the support structure). In addition, the SAR pod 16 may include a communications interface 72 which includes a wireless communication device such as a wireless modem, Bluetooth antenna, or other wireless communication device. This enables the SAR pod 16 to be free from any wired communication connection to any device not mounted on the support structure 40.

The SAR pod 16 may also include other components which enhance the SAR scan capabilities and/or complement the image data generated by the SAR scanning. For example and without limitation, referring again to FIG. 8, the SAR pod 16 may include an aiming system 74, an orientation adjustment system 76, an orientation indicating system 77, a speed indicating system 78, an inertial measurement system 80, a position accuracy indicating system 82, a camera 84, a signal repeater 86, and/or a laser radar system 88. Some of the listed systems may share components, such as a GPS antenna or the computer. Some of the systems such as the aiming system 74, orientation adjustment system 76, and position accuracy indicating system 82 enhance the SAR scan capabilities of the SAR pod 16. Other systems and components such as the laser radar system 88 and signal repeater 86 complement the image data generated by the SAR scanning. These systems and components will be described in further detail with respect to different embodiments outlined below.

It will be understood that the SAR pod 16 may not include all of the systems and components indicated above without departing from the scope of the present invention. For example and without limitation, some of the systems and components may not be required for all SAR pod applications. In another example, some of the systems and components or parts of the systems or components may be provided on devices separate from but used with the SAR pod 16, such as a separate computer which may be used for processing the radar and position data, etc. It will also be understood that various ones of the systems and components described above may be combined in different embodiments of SAR pods according to the present invention, notwithstanding the particular combinations or lack of combinations described below.

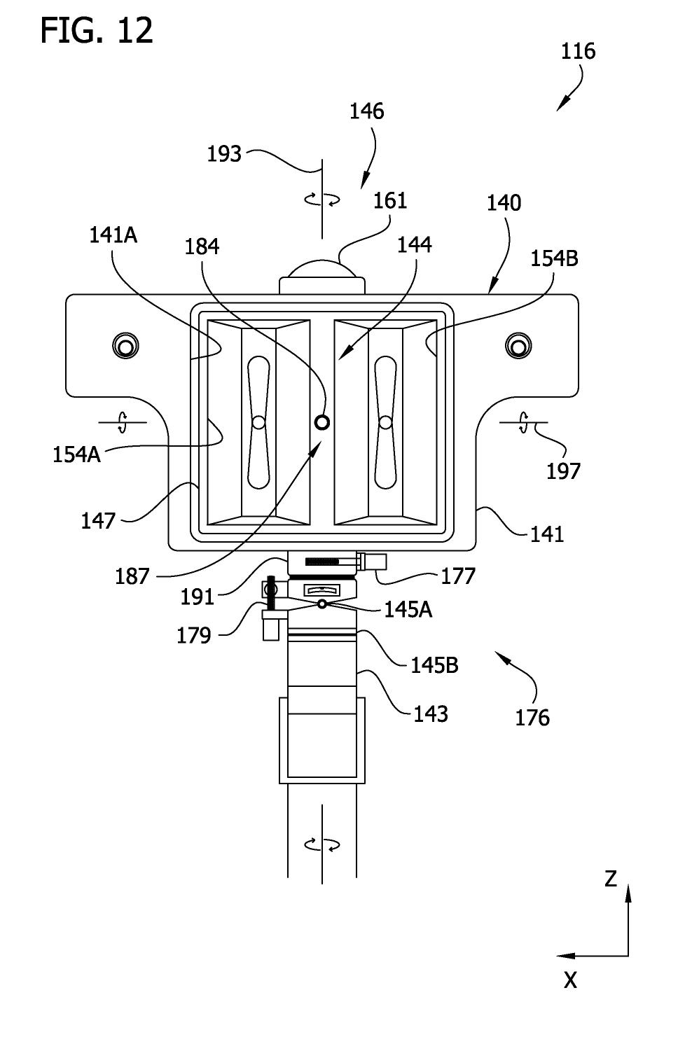

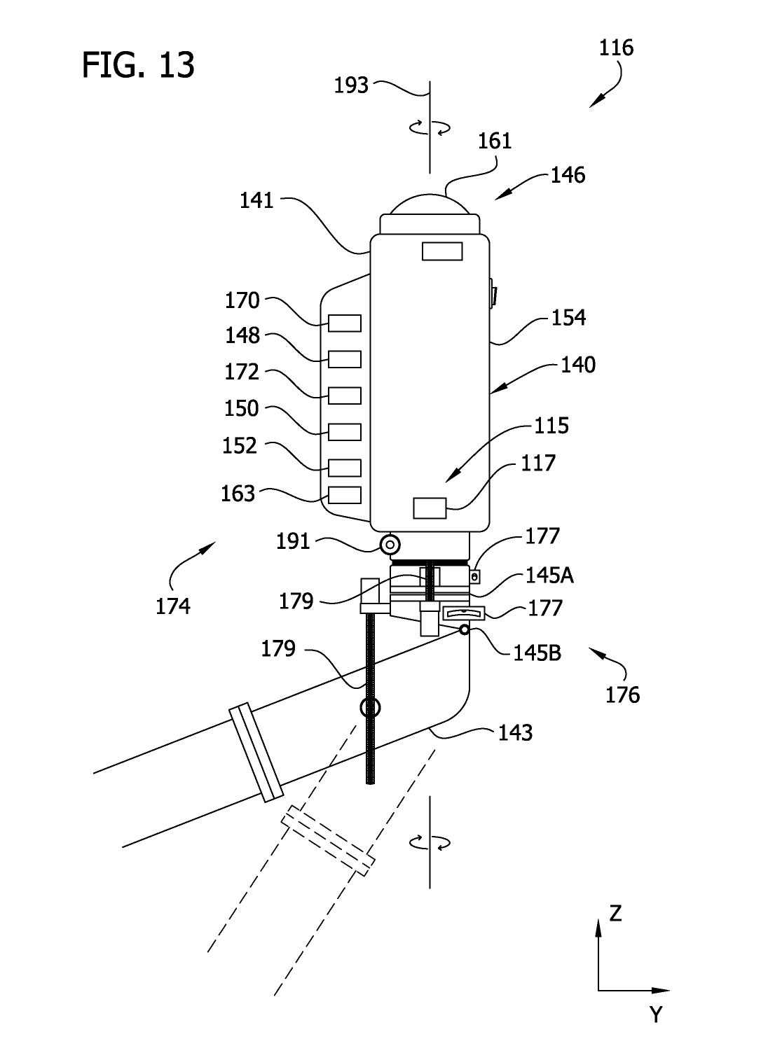

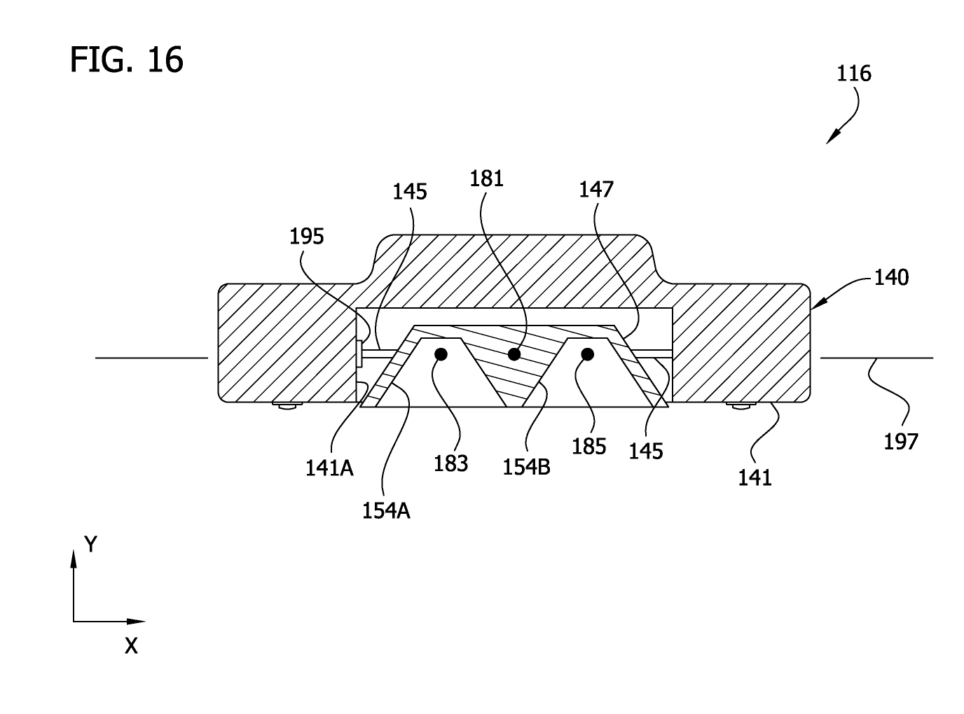

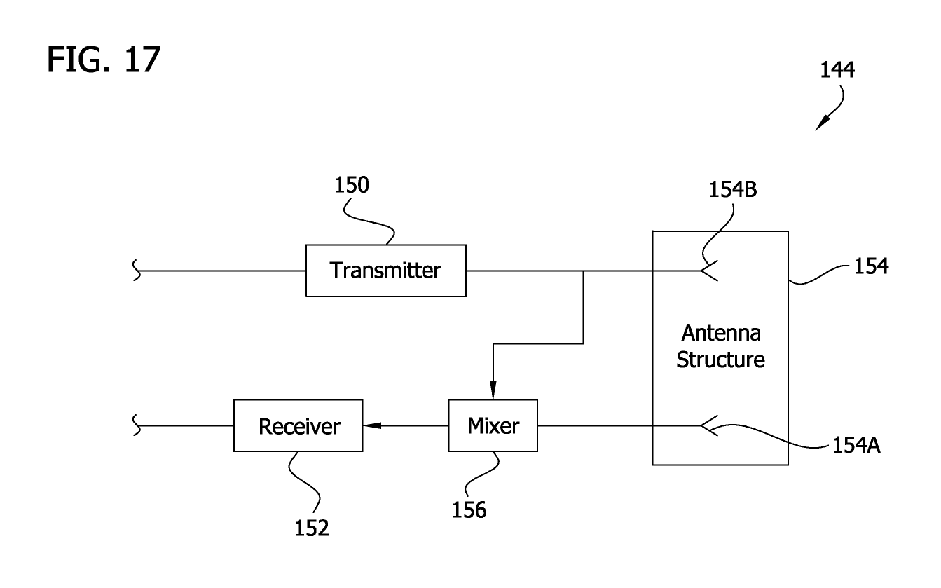

A second embodiment of an SAR pod of the present invention, generally indicated by the reference number 116, will now be described with reference to FIGS. 12-26. In this embodiment, the SAR pod 116 includes a support structure 140, a radar system 144, a position indicating system 146, a wireless communication device 172, and a battery 170. The support structure 140 includes a main body or housing 141, a mounting structure 143 below the main body, and a pivot connections 145A, 145B between the main body and mounting structure. As shown in FIGS. 12 and 16, a cavity 141A is provided in the front of the main body 141 in which an antenna head 147 is pivotally mounted by a pin connection 145. As illustrated in FIGS. 12, 16, and 17, the radar system 144 comprises antenna structure 154 including a first antenna 154A and a second antenna 154B. The first antenna 154A is operatively connected to the radar transmitter 150, and the second antenna 154B is operatively connected to the mixer 156 and radar receiver 152. The first and second antennas 154A, 154B are mounted on the antenna head 147. The mount 143 is provided on a side of the antenna structure 154 that is opposite the side from which reflected radar signals are received. Referring to FIGS. 12 and 13, the position indicating system 146 includes a position signal receiver in the form of a GPS antenna 161 and GPS receiver 163 operatively connected to the GPS antenna. The GPS antenna 161 is adapted for receiving a signal indicative of the global position of the radar system (i.e., from satellites), and the GPS receiver 163 is adapted for communicating the global position to the computer 148. Accordingly, the GPS antenna 161 and receiver 163 may be referred to as parts of a global position indicating system.

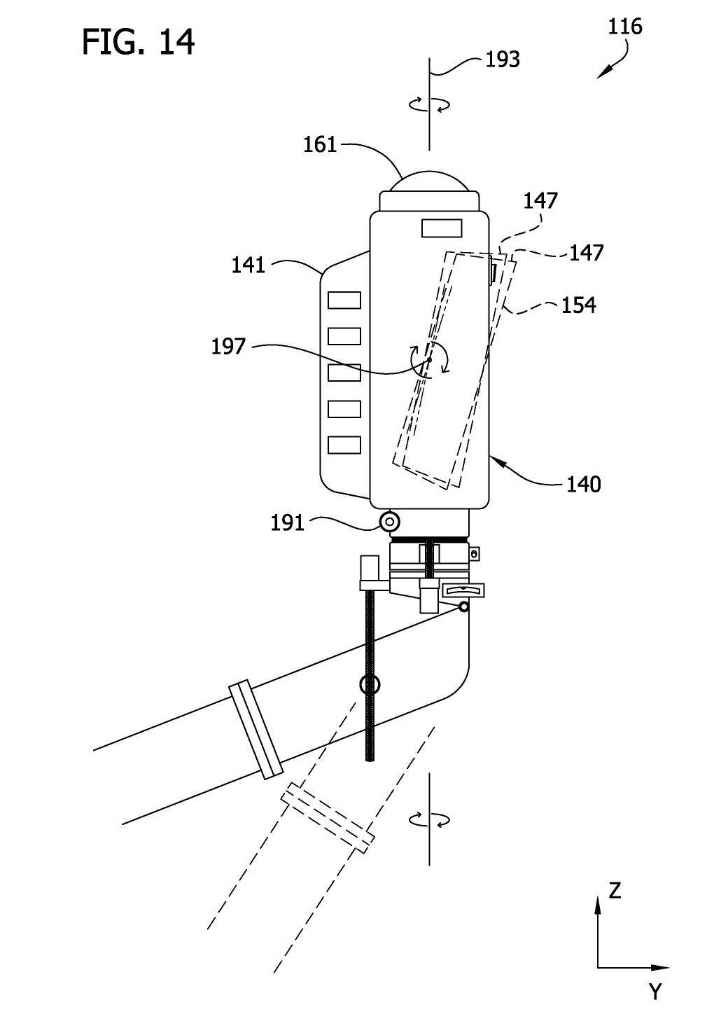

The SAR pod 116 includes an orientation adjustment system 176 for maintaining the main body 141 in a generally upright position. As may be seen in FIGS. 13 and 14, the orientation adjustment system 176 includes first and second electronic levels 177 positioned adjacent the pivot connections 145A, 145B. The orientation adjustment system 176 also includes actuation devices 179 adapted for adjusting the pitch of the main body. The first electronic level 177 is provided on a side of the support structure 140 for sensing when the main body 141 is out of level in the Y-direction, and the second electronic level 177 is provided on a front of the support structure for sensing when the main body is out of level in the X-direction. The actuation devices 179 extend or contract based on feedback from the electronic levels 177 to maintain the main body 141 in a generally upright orientation regardless of the orientation of the mounting structure 143.

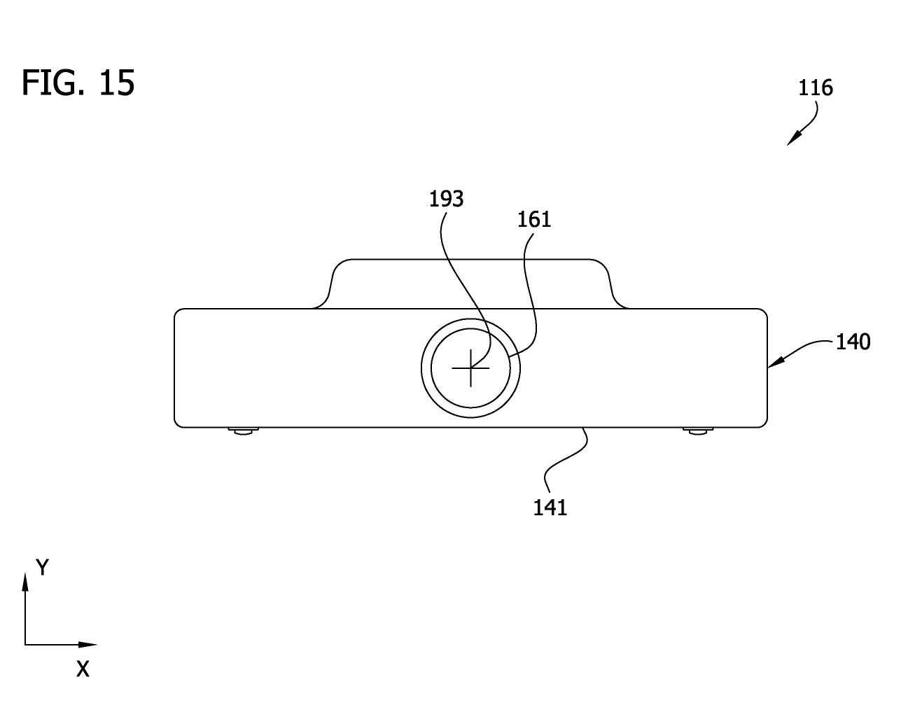

As shown in FIGS. 12 and 15, the GPS antenna 161 is positioned on the top of the main body 141, above the antenna head 147 and directly above a simulated phase center 181 (FIG. 16) of the antenna structure. Referring to FIG. 16, each antenna 154A, 154B includes an apparent phase center 183, 185. The apparent phase center 183 of the first antenna 154A is the location at which the transmitted radar signal appears to originate. The apparent phase center 185 of the second radar antenna 154B is the location at which the received reflected radar signals appear to be the strongest. The antenna structure 154 as a whole includes a simulated phase center 181 positioned midway between the phase centers 183, 185 of the first and second antennas 154A, 154B. In other words, the phase center 181 of the antenna structure 154 as a whole may be approximated as the location between the individual phase centers 183, 185 of the first and second antennas 154A, 154B. The GPS antenna 161 is positioned directly above the simulated phase center 181. Position of the simulated phase center 181 may be determined by receiving signals from the GPS receiver 163 indicative of the position of the GPS antenna 161, routing the GPS signals to the computer 148, and having the computer determine the position of the simulated phase center 181 of the antenna structure 154 by accommodating for the predetermined difference in position of the GPS antenna 161 with respect to the simulated phase center. Positioning the GPS antenna 161 directly above the phase center 181 rather than offset to the side of the phase center simplifies the determination of the position of the phase center. However, the GPS antenna 161 may be provided at other locations without departing from the scope of the present invention.

The SAR pod 116 includes an aiming system 174 operable for aiming the antenna structure 154, such as explained above with respect to FIG. 7. In this embodiment, the aiming system 174 includes a machine vision system 187 (FIG. 12) including a vision device in the form of a camera 184 capable of generating video and/or photographic images. The camera 184 is positioned on the antenna head 147 between the first and second antennas 154A, 154B. The aiming system 174 also includes as part of the orientation adjustment system 176 a vertical axis actuation mechanism 191 (FIG. 14) adapted for rotating the main body 141 (and thus the antenna head 147) about a generally vertical axis of rotation 193 and a horizontal axis actuation mechanism 195 (FIG. 16) adapted for rotating the antenna head about a generally horizontal axis of rotation 197 (FIG. 14) for maintaining the antenna structure 154 aimed in the direction of the scan area SA. Rotation about the horizontal axis 197 may be independent from rotation abut the vertical axis 193 and may be used to set or maintain incident grazing angles at or near the Brewster angle. The vertical axis actuation mechanism 191 is adapted for rotating the main body 141 with respect to the mounting structure 143 to various positions, such as shown in FIG. 7, to maintain the antenna structure 154 oriented in the XY-plane toward the scan area SA. The horizontal axis actuation mechanism 195 is adapted for rotating the antenna head 147 with respect to the main body 141 to various positions, such as shown in FIG. 14, to maintain the antenna structure 154 oriented in the YZ-plane toward the scan area SA. The camera 184 is mounted on the antenna head 147 to be aimed in generally the same direction as the antenna structure 154.

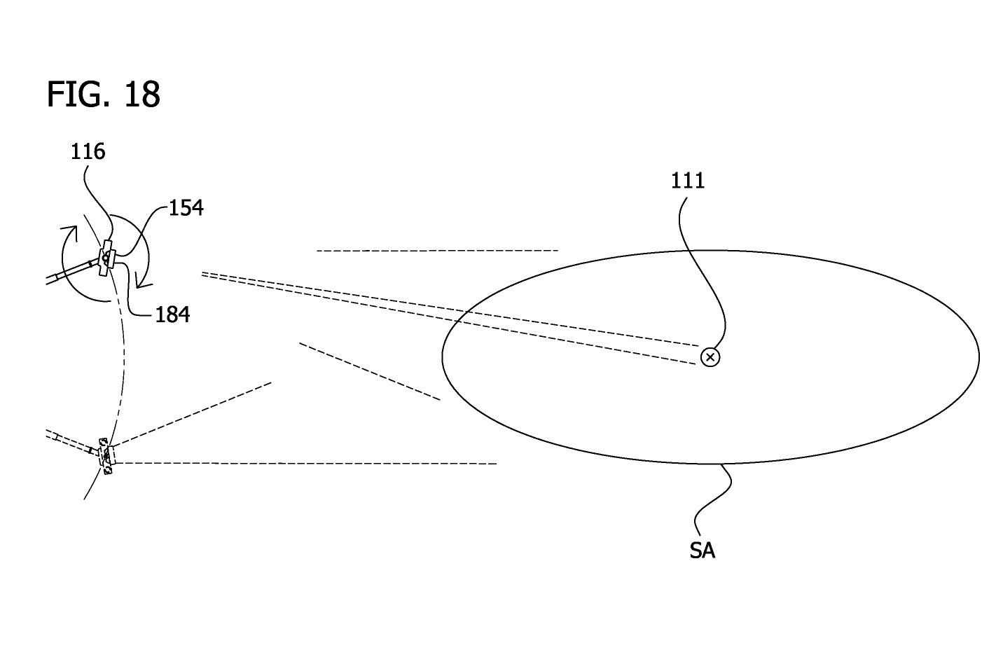

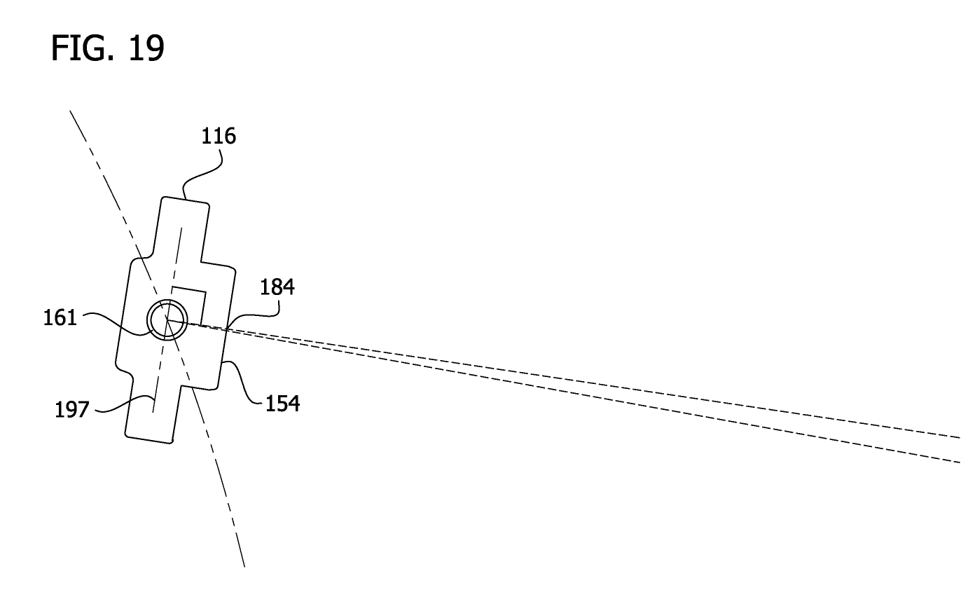

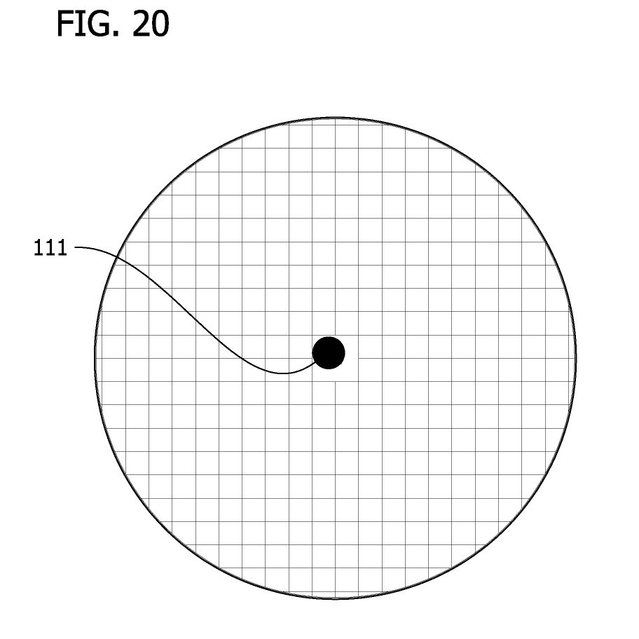

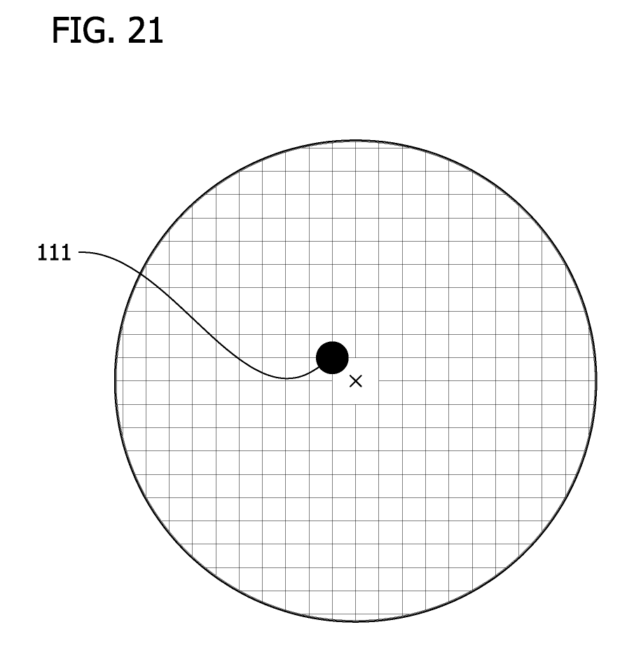

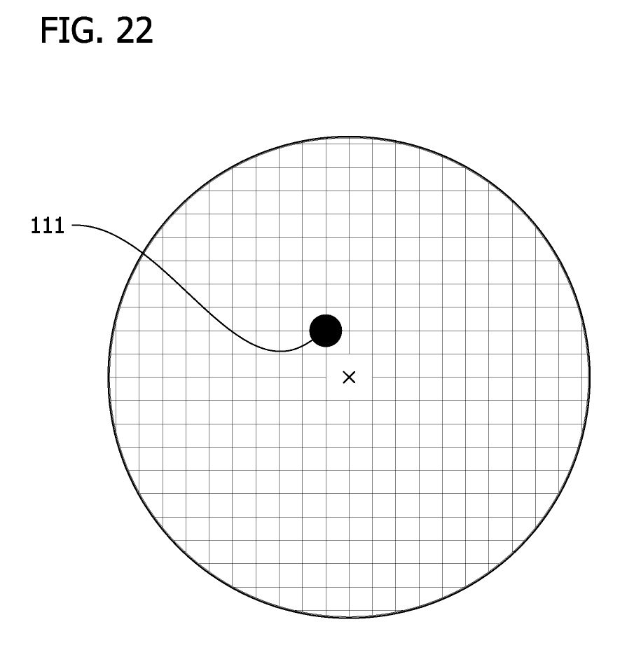

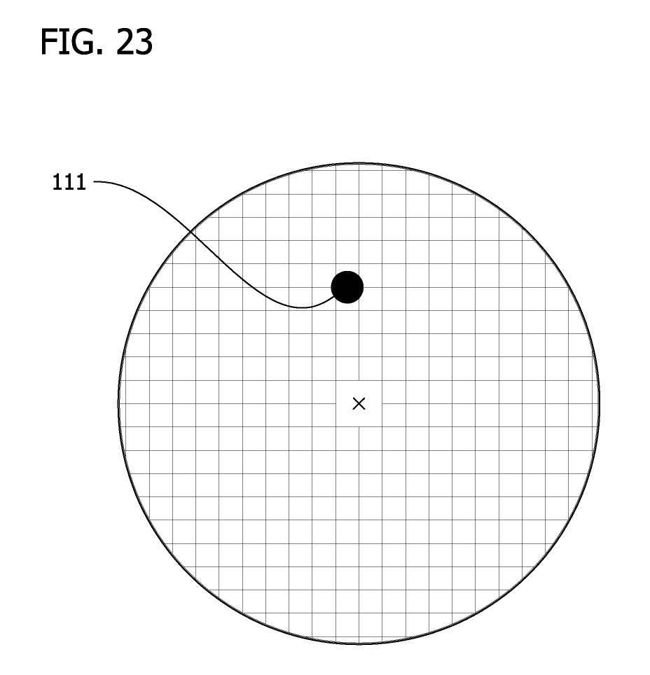

The camera 184 may be used as a vision device in a machine vision technique to maintain the antenna structure 154 aimed toward the scan area SA. A first machine vision technique referred to as target-based machine vision is illustrated in FIGS. 18 and 19. A dedicated target 111 is positioned at a certain location in the scan area SA, such as the center of the scan area. The machine vision system 187 via the camera 184 acquires and tracks the target 111, measures deviations of aim of the camera 184 with respect to the target, and guides the actuation mechanisms 191, 195 to rotate the main body 141 and antenna head 147 about the axes 193, 197 to maintain the camera 184 oriented toward the target 111 and thus the antenna structure 154 aimed toward the scan area SA. FIG. 20 depicts a computer vision camera view of a dedicated target 111 placed in the target area of interest for scanning. The depiction indicates that the antenna structure is pointed toward the target 111. As may be seen, the target 111 is in the center of the field of vision. FIG. 21 depicts a computer vision camera view of the dedicated target 111 which would cause the machine vision system 187 to signal to the computer 148 for relatively slow speed horizontal and vertical axis rotation. FIG. 22 depicts a computer vision camera view of the dedicated target 111 which would cause the machine vision system 187 to signal to the computer 148 for relatively higher speed horizontal axis rotation and for relatively slow vertical axis rotation. FIG. 23 depicts a computer vision camera view of the dedicated target 111 which would cause the machine vision system 187 to signal for even higher speed horizontal axis rotation and for relatively slow vertical axis rotation. The axis rotation called for the machine vision system 187 causes the camera 184 to remain aimed at the dedicated target 111 and thus maintains the aim of the antenna structure 154 at the scan area SA. The machine vision system 187 may also be used to determine whether or not to permit SAR scan data to be collected (e.g., whether or not to transmit, receive, and/or record transmitted/received radar signals). For example and without limitation, in the conditions indicated in FIGS. 20-22, the aim of the antenna structure 154 would be within suitable range, and collection of SAR scan data would be permitted. However, in the condition indicated in FIG. 23, the aim of the antenna structure 154 may be deemed out of suitable range and collection of SAR scan data may not be permitted until the aim is corrected.

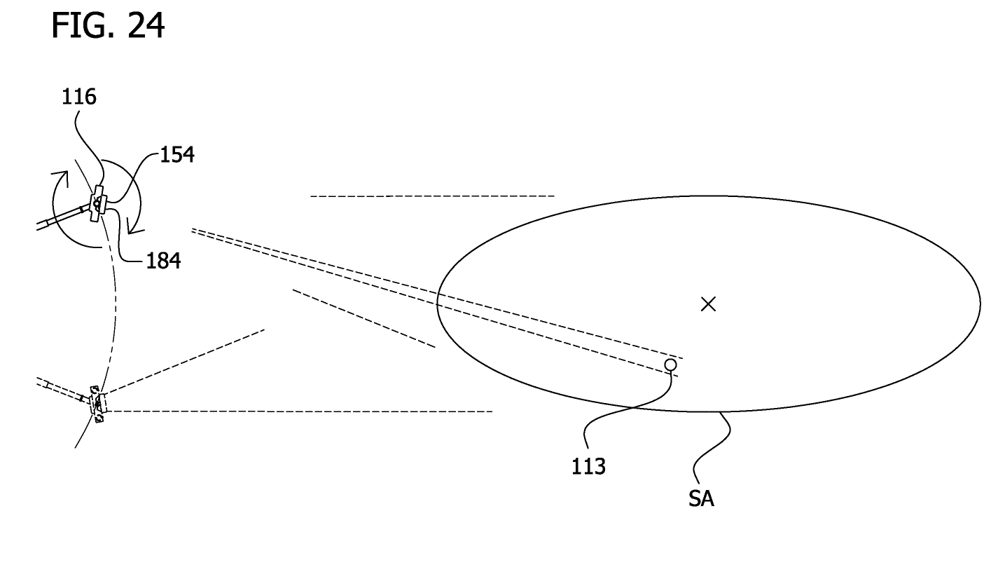

A different machine vision technique referred to as “edge detection” is illustrated in FIG. 24. An existing reference point (e.g., utility pole) or artificial reference point 113 in the scan area SA as viewed by the camera 184 is selected. As the SAR pod 116 moves, pixel color change with respect to the reference point is detected in the view of the camera 184, and the actuation mechanisms 191, 195 automatically adjust the orientation of the antenna structure 154 about the horizontal and vertical axes 193, 197 to maintain the reference point 113 in relatively the same position in the view of the camera 184. Accordingly, the camera 184 remains aimed at the reference point 113 and thus the antenna structure 154 automatically remains aimed at the scan area SA.

As shown in FIG. 13, the SAR pod 116 may include a communication system 115 including a signal generator 117 adapted for generating an audio and/or visual signal for communicating aim of the antenna structure 154 to a person using the SAR pod. For example without limitation, the signal generator 117 may be a sound emitting device (e.g., speaker) which generates a “chirp” or other audio signal which indicates to the person that the antenna structure 154 is aimed toward the scan area SA. As another example, the signal generator 117 may be a light or series of lights on the SAR pod 116 which when emitting light or not emitting light, or emitting light in a certain fashion, indicate to the person that the antenna structure 154 is aimed toward the scan area SA. The communication system 115 may be adapted for communicating the angle of the aim of the antenna structure 154 with respect to the surface S. In other words, the communication system 115 may be adapted for transmitting signals (e.g., electromagnetic, audible, and/or visual signals) to a computer or a person indicative of whether the antenna structure 154 is oriented at the Brewster angle, which may be indicated by a system including an encoder, inclinometer, or other device. In one embodiment, the communication system 115 is adapted for indicating whether the antenna structure 154 is aimed at the scan area SA within a range of movement of the orientation adjustment system 176 for permitting the orientation adjustment system to automatically orient the antenna structure 154 at the Brewster angle. The computer or person may know based on signals from the communication system 115 whether the vehicle and/or the boom needs to be repositioned or oriented for accomplishing the Brewster angle and/or aim toward the scan area SA. The communication system 115 may communicate aim of the antenna structure 154 continuously or periodically during movement along the raster pattern and/or during initial set-up of the SAR pod 116 for a scan.

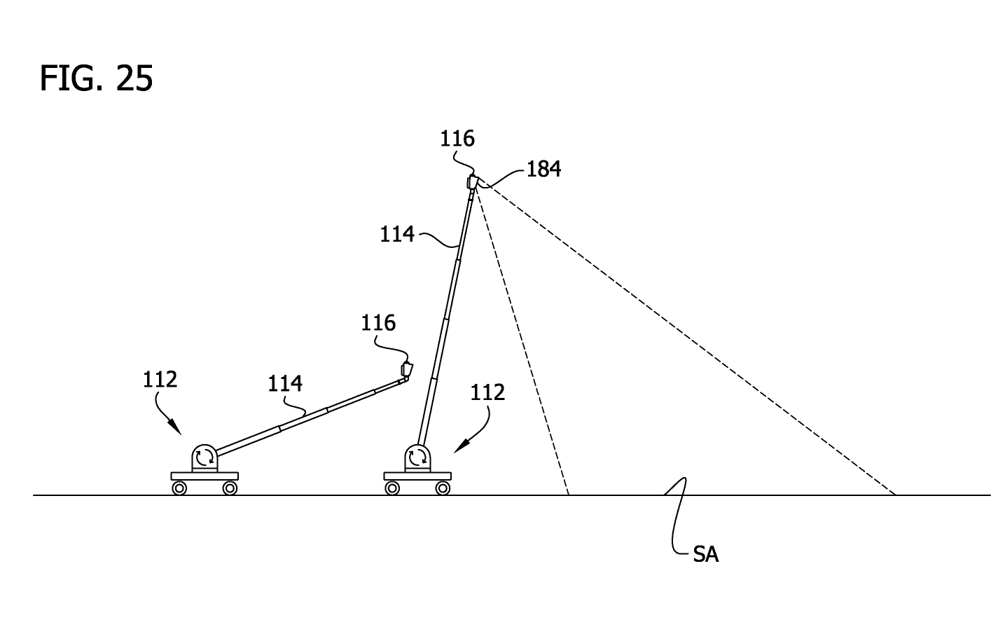

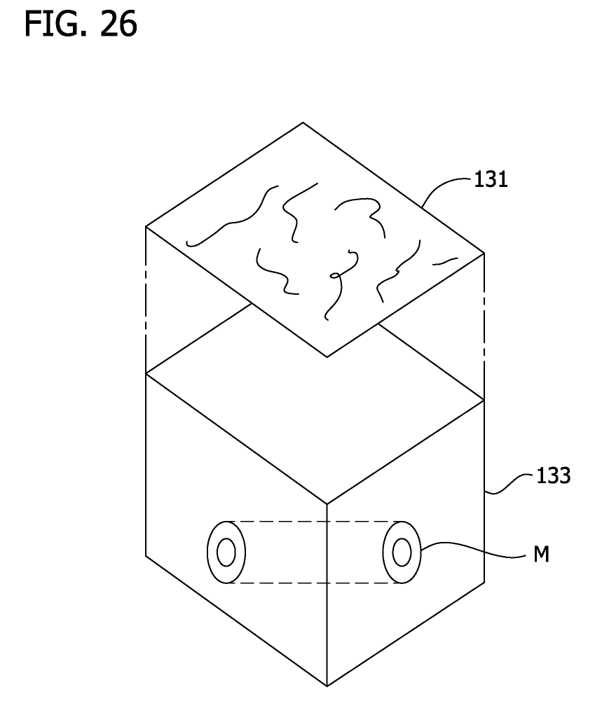

The SAR pod camera 184 may be used for purposes other than the aiming system 174. For example and without limitation, the camera 184 may be used to take pictures or video periodically or continuously in the direction in which the antenna structure 154 is aimed during movement of the SAR pod 116 along a raster pattern. Such images may be used to manually aim the antenna structure 154 in preparation for an SAR scan or even during an SAR scan. The antenna structure 154 may be manually aimed or aim of the antenna structure may be remotely controlled based on images produced by the camera 184. Moreover, the camera 184 may be used to capture video or photographic images from a higher vantage point than used for the SAR scan. This is illustrated by the two positions shown in FIG. 25. Before or after an SAR scan, the SAR pod 116 may be raised by the boom 114 to a relatively high vantage point with respect to the surface S of the earth and used to capture video and/or photographic images of the scan region SR, scan area SA, and/or other portions of the surface S of the earth, including vegetation and/or man-made structures. For example and without limitation, the camera 184 may be used to photograph the scan region SR for use in planning positioning of the vehicle 112 and/or boom 114 for performing SAR scans. The camera 184 may be adapted for capturing thermographic images (i.e., images of thermal variations on a surface indicative of subsurface structures). Images captured by the camera 184 may be correlated with the SAR scan data. For example and without limitation, image data representing material beneath the surface of the earth collected during an SAR scan at a scan area SA may be correlated with collected image data representing the topography of the surface S of the earth (e.g., photograph) at the scan area to provide correlated subsurface and topographic images of the scan area. FIG. 26 illustrates an example of how such images representing the topography 131 and subsurface 133 may be correlated in which a subsurface pipe is indicated by the reference M. The location of the surface allows more accurate determination of the depth of the pipe M.

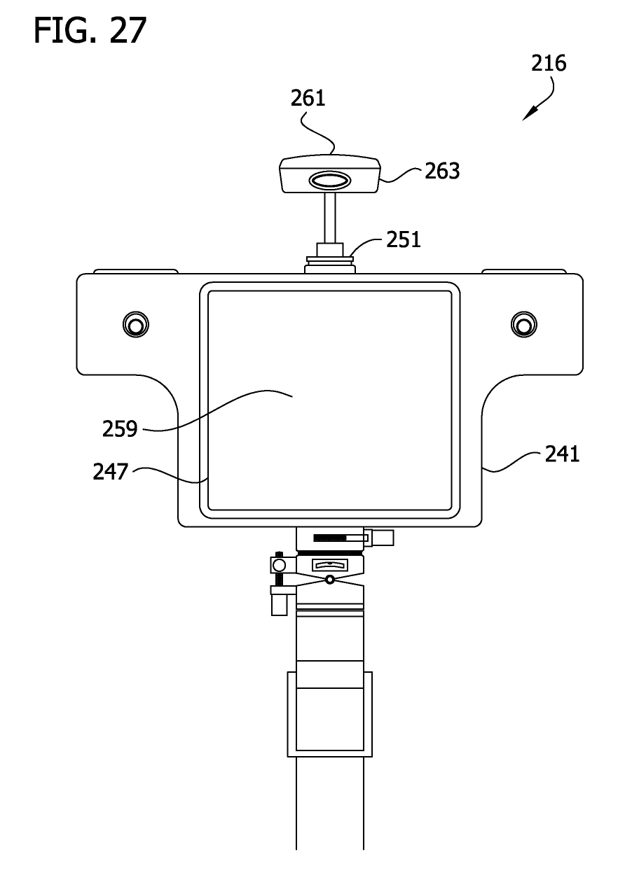

Referring now to FIG. 27, another embodiment of an SAR pod of the present invention is indicated generally by the reference number 216. This embodiment of the SAR pod is substantially similar to the embodiment illustrated in FIGS. 12-16. In this embodiment, the SAR pod 216 includes a cover 259 which covers the antenna head 247. Also, in this embodiment, a universal mount 251 (e.g., a tribrach universal geomatics mount) is provided on the top of the main body 241. A GPS unit including a GPS antenna 261 and receiver 263 is mounted on the universal mount 251. The GPS antenna 261 may be used in a similar fashion as described above with respect to the GPS antenna 161. The universal mount 251 permits removal of the GPS unit and installation of other components in its place, if desired. This embodiment of the SAR pod 216 is not illustrated as having an aiming system for maintaining the antenna structure aimed at the scan area, although one could be provided. In this embodiment, as in any other embodiment of the SAR pod, the antenna structure 154 may be manually aimed by observing the orientation of the SAR pod 216 with respect to the scan area SA and adjusting the orientation of the SAR pod to maintain the antenna structure aimed in the general direction of the scan area SA.

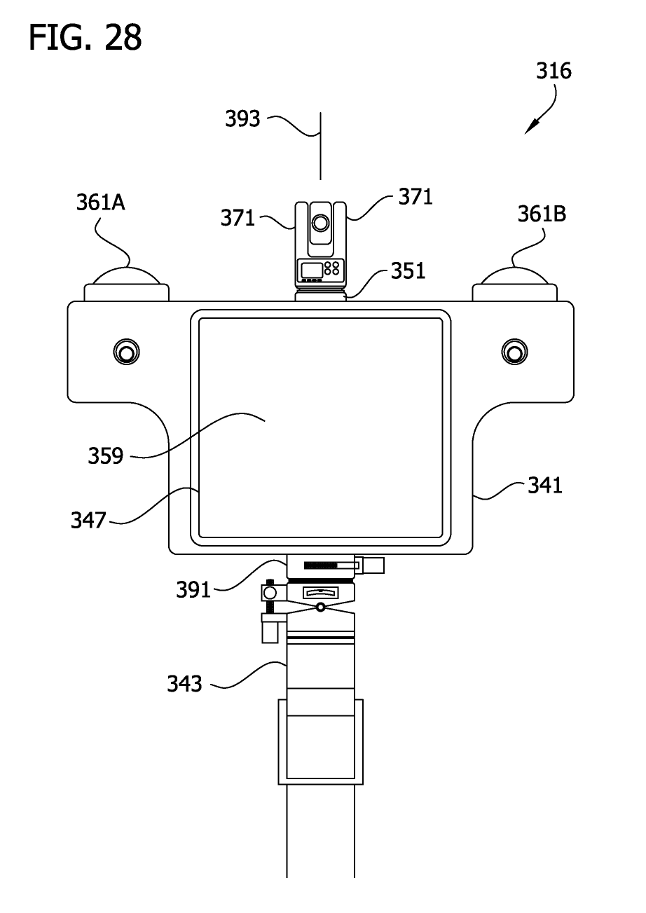

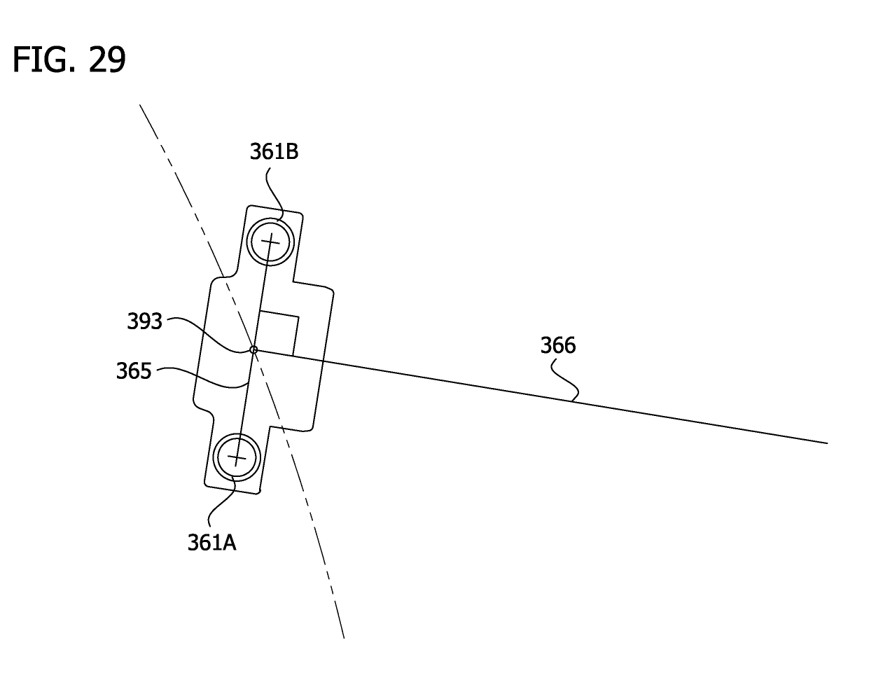

Referring to FIG. 28, another embodiment of an SAR pod is indicated generally by the reference number 316. In this embodiment, the SAR pod 316 is substantially similar to the embodiment illustrated in FIG. 27. For example and without limitation, the SAR pod 316 includes a cover 359 covering the antenna head 347 and includes a universal mount 351. In this embodiment, the SAR pod 316 includes a first GPS antenna 361A mounted on a left side of the main body 341 and a second GPS antenna 361B mounted on a right side of the main body 341. The GPS antennas 361A, 361B are mounted at equidistant positions from the vertical axis of rotation 393 of the main body 341. One or both of the GPS antennas 361A, 361B may be used as part of the position indicating system as described above with respect to the GPS antenna 161 shown in FIG. 12. In this embodiment, the two GPS antennas 361A, 361B may be used as part of the aiming system. As shown in FIG. 29, the pair of GPS antennas 361A, 361B may be used to constantly calculate the rotational position of the main body 341 about the vertical axis of rotation 393. An imaginary line 365 extending between the GPS antennas 361A, 361B remains in a constant orientation with respect to a line 366 extending from a target 9 e.g., the center of the scan area) to the axis 393. The line 366 can be determined by the position indicating system if the target position is known. In the illustrated embodiment, as shown in FIG. 29, the line 365 is generally perpendicular to the aim of the antenna head 341. The actuation mechanism 391 may be used to automatically rotate the main body 341 with respect to the mounting structure 351 for maintaining the line 365 between the GPS antennas 361A, 361B generally perpendicular to the direction of aim of the antenna head 347 for maintaining the antenna head aimed toward the scan area SA throughout movement of the SAR pod 316.

In this embodiment, a robotic total station 371 is mounted on the universal mount 351. The robotic total station 371 may function as a machine vision component of the aiming system by locking on a target such as a retro reflective prism located in the scan area and remaining locked on the target as the SAR pod is moved along the raster pattern. The robotic total station may cause the antenna head to maintain aim toward the scan area much like described above for the machine vision camera with respect to FIGS. 18-23. In GNSS denied environments, where use of GPS is not possible, the robotic total station 371 instead of the GPS antennas 361A, 361B may be used for the aiming system and/or position indicating system. The total station 371 may be referred to broadly as a position signal receiver. The total station 371 may also be referred to as a component of a local position indicating system for indicating local position of the SAR pod 316 with respect to a benchmark (e.g., the target). The global position of the target may be known or subsequently determined for determining the global positions of the total station 371 corresponding to the indicated local positions.

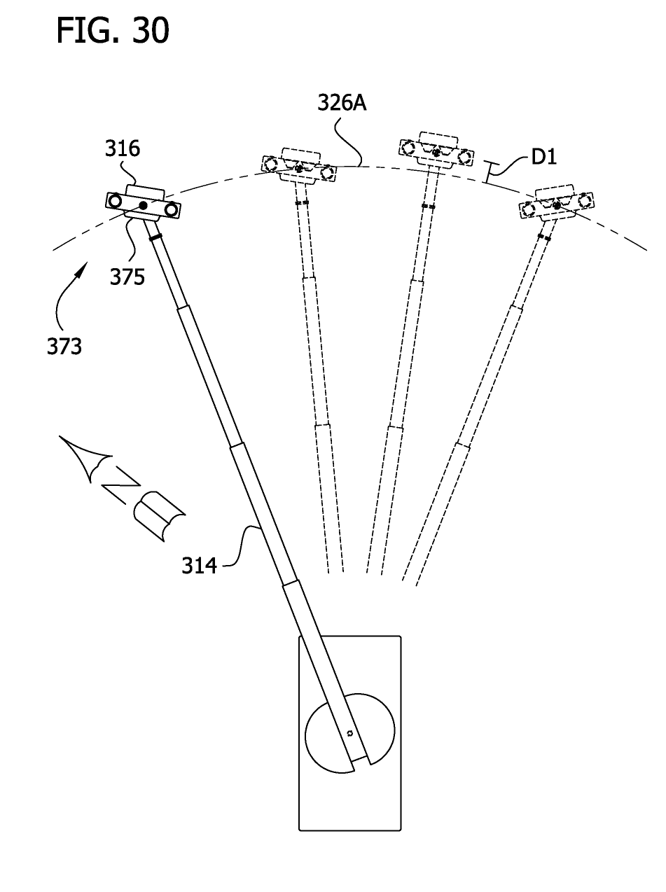

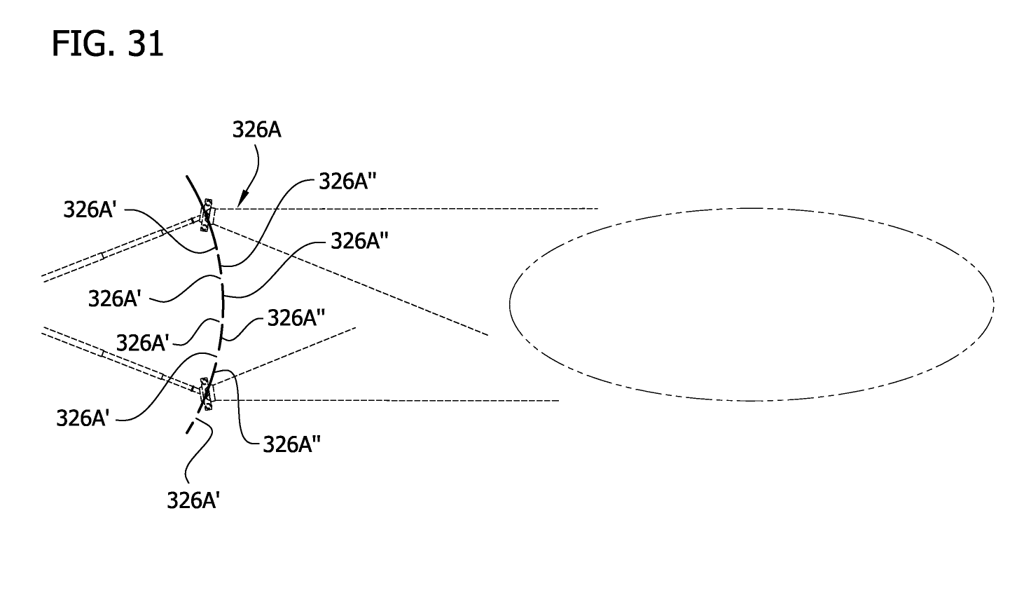

The SAR pod 316 of this embodiment also includes an inertial measurement system 373 including an inertial measurement device 375 as part of a position accuracy indicating system. The inertial measurement device 375 may be used to detect deviations in scan paths of the SAR pod 316. For example and without limitation, as shown in FIG. 30, the inertial measurement device 375 may indicate when the SAR pod deviates from an arcuate scan path 326A. A deviation from the scan path 326A is indicated by the reference D1 in FIG. 30. The SAR pod 316 may deviate from the arcuate scan path 326A because of user error in moving the boom 314, because of a wind gust causing boom movement, or for other reasons. Deviations from the expected path 326A detected by the inertial measurement device 375 may be used to correct data on the pod position or to determine whether to include SAR data collected at that position in the data used to generate the three-dimensional image. For example and without limitation, if the deviation D1 is less than a predetermined threshold value, the collected SAR data may be used. However, if the deviation D1 is greater than a predetermined threshold value, the collected SAR data may be omitted. The scan path 326A illustrated in FIG. 31 represents a “sparse array” data scan path including segments 326A′ in which a deviation of the scan path was not indicated and thus SAR data collected was used and including segments 326A″ in which a deviation was indicated and thus the SAR data was omitted. Processing techniques may be employed to provide a useful image based on the sparse array information.

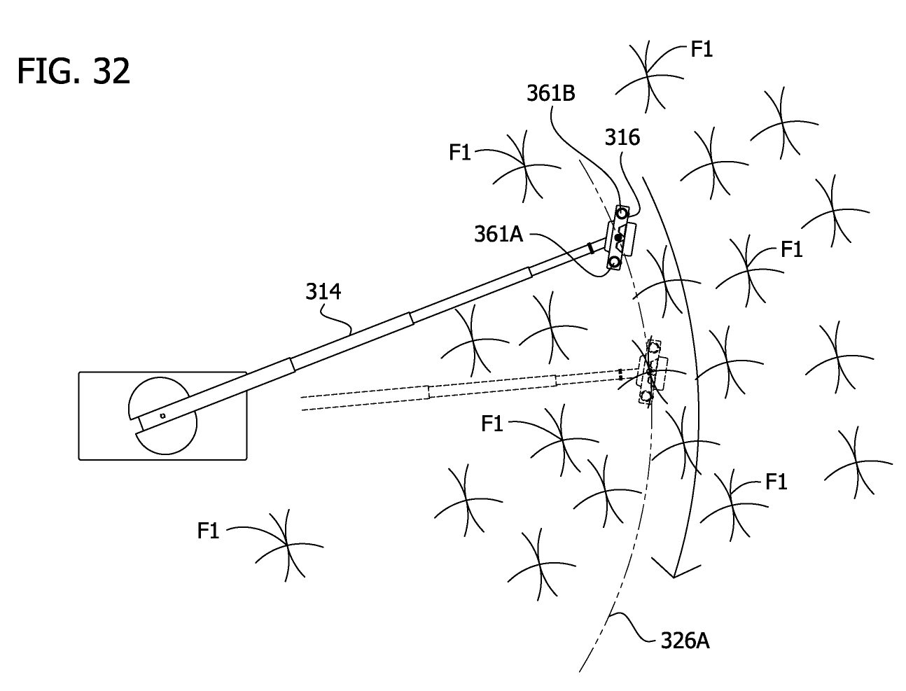

It is also possible to use known information about the path of the SAR pod 316 in a scan to eliminate certain errors. In this embodiment, a predetermined arcuate scan path 326A may be used to select among differing position data indicated by the GPS antennas 361A, 361B of the position indicating system. FIG. 32 illustrates the SAR pod 316 being moved in a horizontal scan path 326A. The GPS antennas 361A, 361B may falsely indicate the position of the SAR pod 316 as it is moved along the scan path 326A by the boom 314. Several false positive position indications are indicated by the reference number F1. The false positives F1 are indicated by intersecting arcs representing intersections of GPS satellite positional data. The false positives F1 may result from multi-path reflected data and other signal deformations. The false positives would indicate non-true to arc path false positions. Reference to the predetermined arcuate shape of the scan path 326A can be used to eliminate the false positives or to correct the positional data associated with SAR data collected at positions along the scan path at which the GPS antennas 361A, 361B indicated a false position of the SAR pod 316. Although this filtering or correction of positional data is described with respect to GPS technology, position indicating systems of various kinds (e.g., including inertial, total station, and computer image terrain referencing) may be corrected in a similar fashion by reference to the predetermined arcuate shape of the scan path 326A. The scan path may be determined before hand or learned by traversing the path before scanning begins or during scanning.

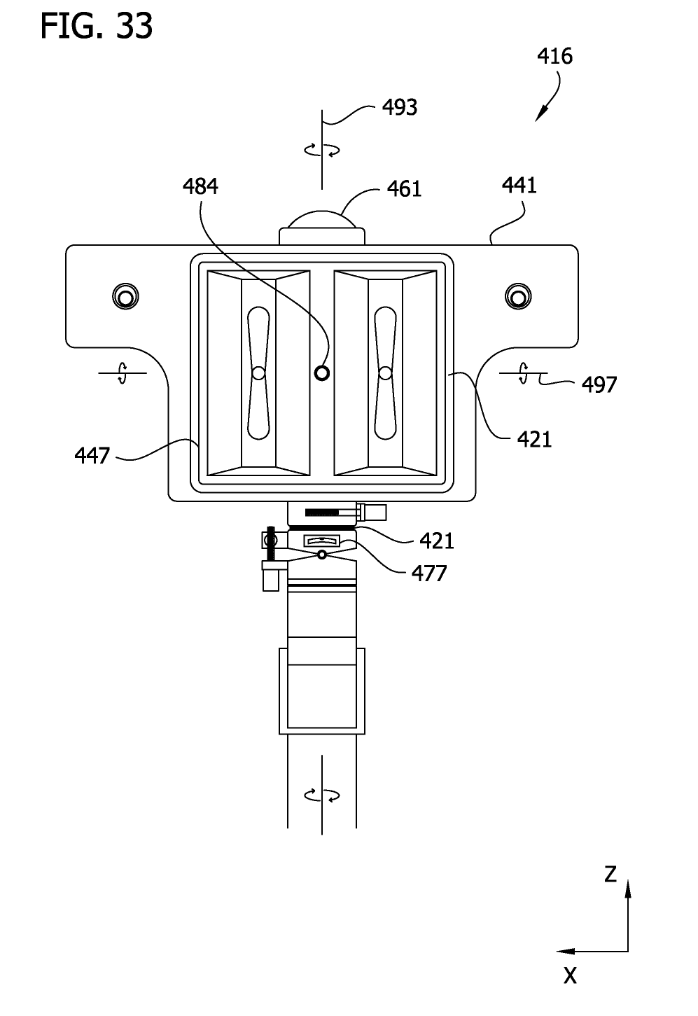

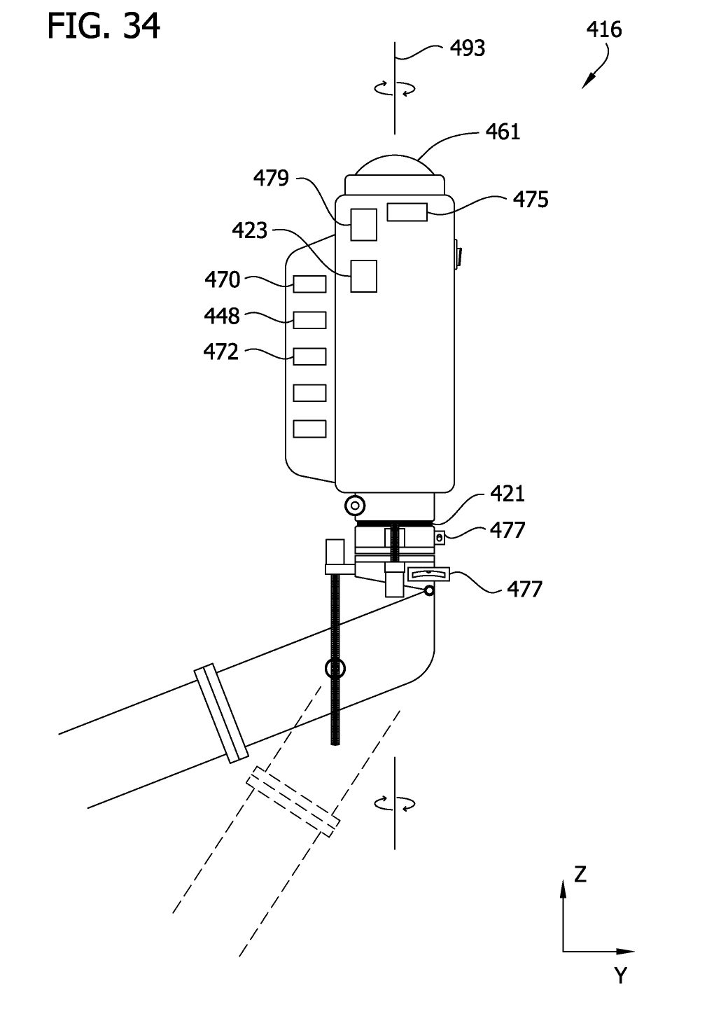

Another embodiment of an SAR pod according to the present invention is illustrated in FIGS. 33-35 and indicated generally by the reference number 416. In this embodiment, the SAR pod 416 includes accurate digital circular angle encoding sensors 421 on both the vertical and horizontal rotation axes 493, 497. The SAR pod 416 also includes an electronic distance measuring instrument or an “EDM” 479. In effect, the SAR pod 416 has incorporated the essential features of a robotic total station. In a “total station mode,” the pod 416 collects multiple distance and angular data and analyzes the data in exactly the same way as a conventional robotic total station. In an “SAR scanning mode,” the SAR pod 416 scans target areas of interest in exactly the same way as other pods described herein. The integrated device 416 is capable of interactive operation as a robotic total station locking on a SAR target area retro reflective target located in the scan area SA, as discussed above with respect to the total station 371 and FIG. 28. In this mode, the total station features of the SAR pod 416 are able to precisely determine pod position in real time during an SAR scan. This mode may be used for collecting position data during SAR scans in GPS satellite ephemeris denied environments. The integrated SAR and robotic total station components share data from and use of the GPS antenna 461, inertial measurement device 475, camera 484, horizontal and vertical digital circular angle encoding sensors 421, battery power supply 470, computer/data storage 448, communications interface 472, tilt sensors 477, and remote display/controls.

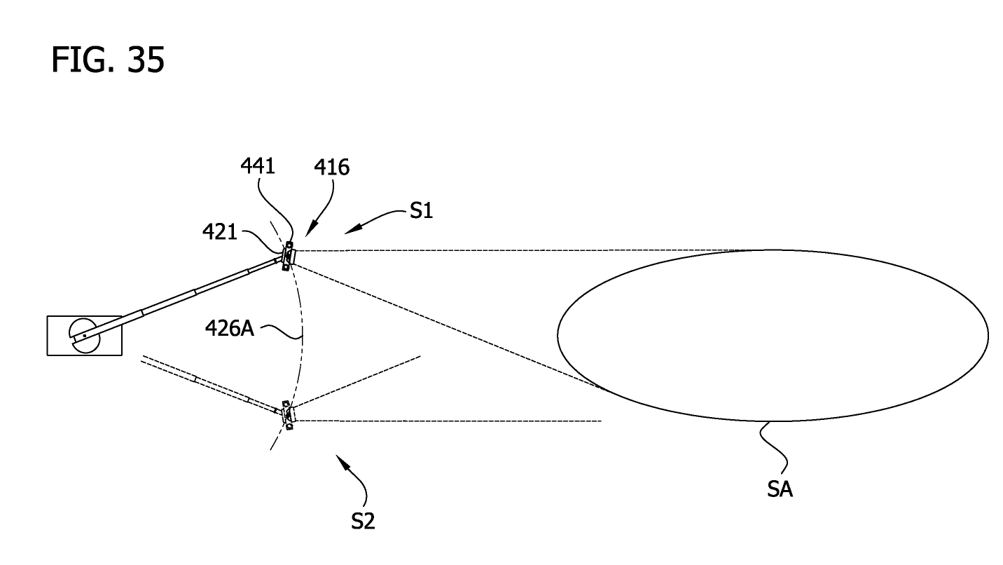

The encoders 421 may be used as part of the aiming system if desired. An example use of the vertical rotation axis digital encoder 421 as part of the aiming system is illustrated in FIG. 35. Rotation of the main body 441 may be controlled based on signals received from the encoder 421. For example and without limitation, the encoder 421 may be “zeroed” at a starting position S1 of the SAR pod 416 at the beginning of a scan path 426A. The required reading of the encoder 421 for the SAR pod 416 to be aimed toward the scan area SA at an ending position S2 of the SAR pod on the scan path 426A is determined and programmed. Accordingly, as the SAR pod 416 moves along the scan path 426A, the encoder 421 provides signals causing the main body 441 to rotate about the vertical rotation axis 493 incrementally between the starting radial position S1 of the main body and the ending radial position S2 of the main body according to the corresponding incremental position of the SAR pod 416 along the scan path 426A. The horizontal axis digital encoder 421 may be used in a similar way but to control aim of the antenna head 447 by rotation about the horizontal axis of rotation 497.

The SAR pod 416 may also include a compass 423 which may be used as a part of the aiming system in a similar way as the vertical axis encoder 421. Referring again to FIG. 35, the compass headings required for aiming the antenna structure toward the scan area SA at the start position S1 and end position S2 of the scan path 426A may be determined, and the main body 441 may be rotated incrementally between the start and end compass headings according to the corresponding incremental position of the SAR pod 416 along the scan path.

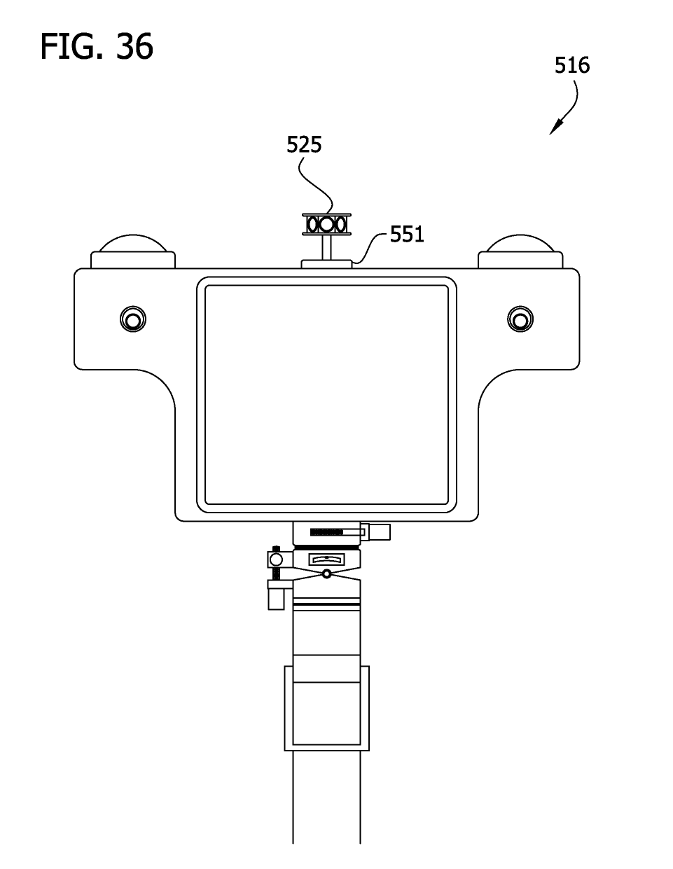

FIG. 36 illustrates another embodiment of an SAR pod according to the present invention generally indicated by the reference number 516. The SAR pod is similar to the pod 316 described above with respect to FIG. 28. In this embodiment, a retro reflective prism 525 instead of a total station is mounted on the universal mount 551. The prism may be used as part of the position indicating system to monitor the position of the SAR pod 516 as it travels along a raster pattern. For example and without limitation, a robotic total station may be positioned in or near the scan area SA for engaging and tracking the prism 525 throughout movement of the SAR pod 516. The positional information gathered by the robotic total station can be correlated with the data generated by the SAR pod 516 during the scan, permitting a three-dimensional image to be built with the scan data.

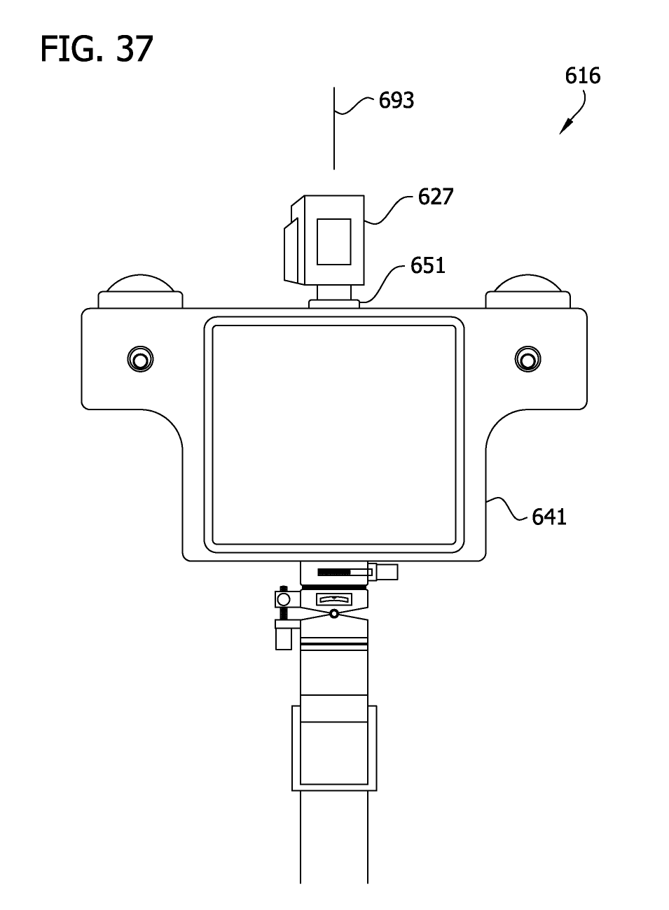

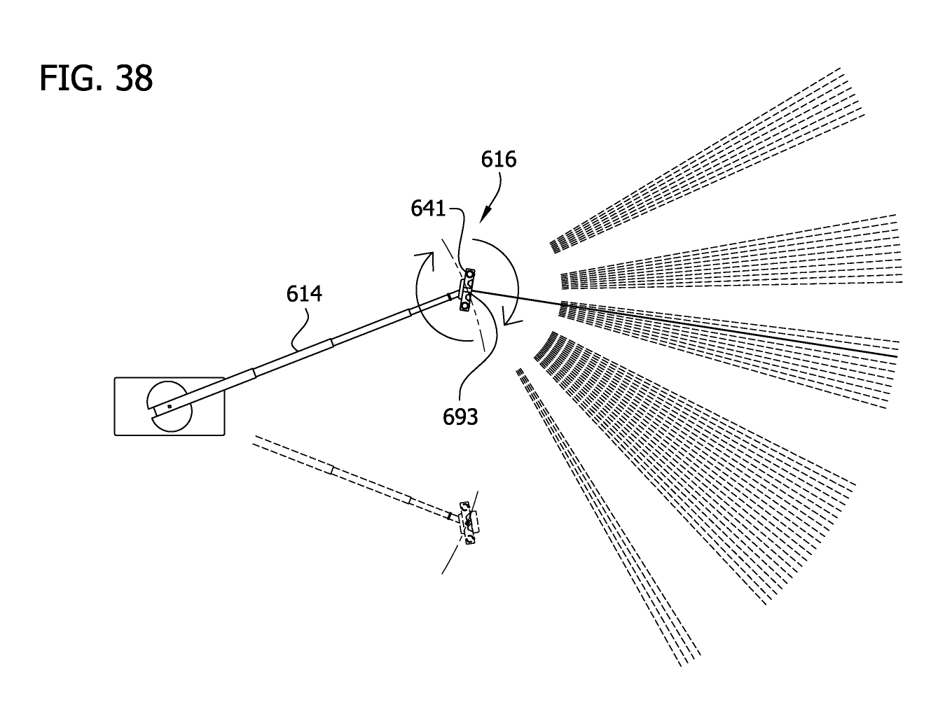

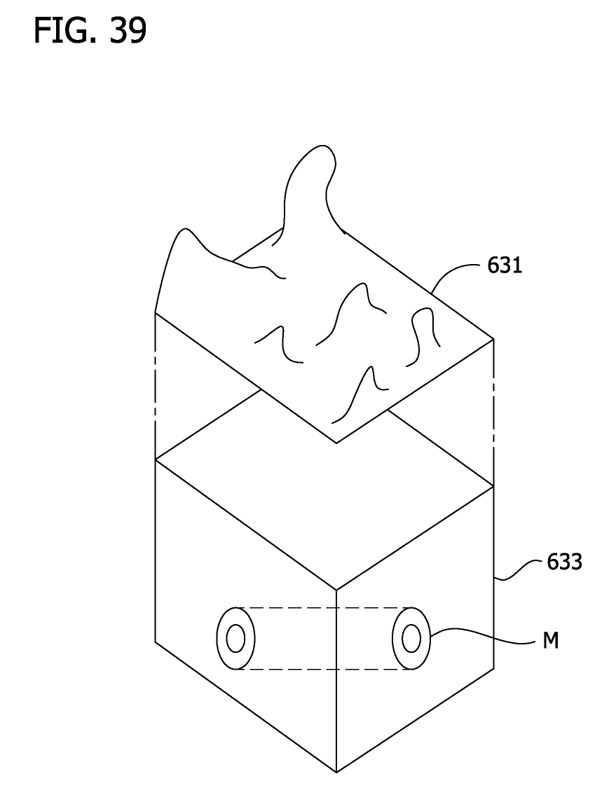

Another embodiment of an SAR pod according to the present invention is illustrated in FIG. 37 and generally indicated by the reference number 616. The SAR pod of this embodiment is substantially similar to the embodiment described above with respect to FIG. 28. In this embodiment, a laser radar scanner 627 instead of a total station is mounted on the universal mount 651. In the industry, a particular type of laser radar scanner 627 is referred to as a LiDAR scanner. The laser radar scanner 627 is adapted for generating a three-dimensional image of a topography of a surface S of the earth. The SAR pod 616 may be moved along a scan path for performing an SAR scan, as illustrated by comparison of the solid line and broken line SAR pods shown in FIG. 38. In a laser radar scan, as illustrated in FIG. 38, the boom 614 supporting the SAR pod 616 remains stationary, and the main body 641 pivots about the generally vertical axis of rotation 693 for the laser scan raster. As shown by example in FIG. 39, the collected laser scan data representing the topography of the surface 631 may be correlated with the SAR scan data 633 to allow a precise location of an object M under the earth's surface with respect to the actual rather than an assumed surface.

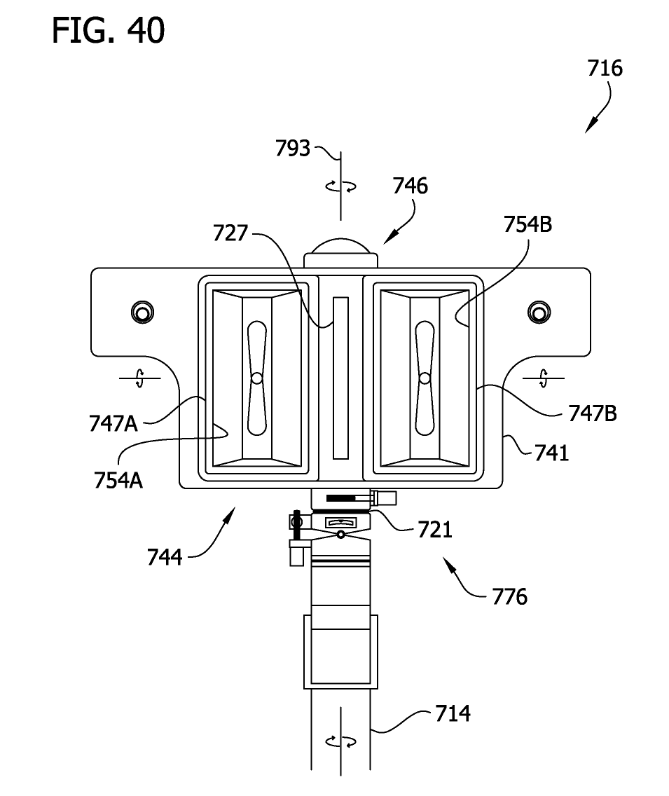

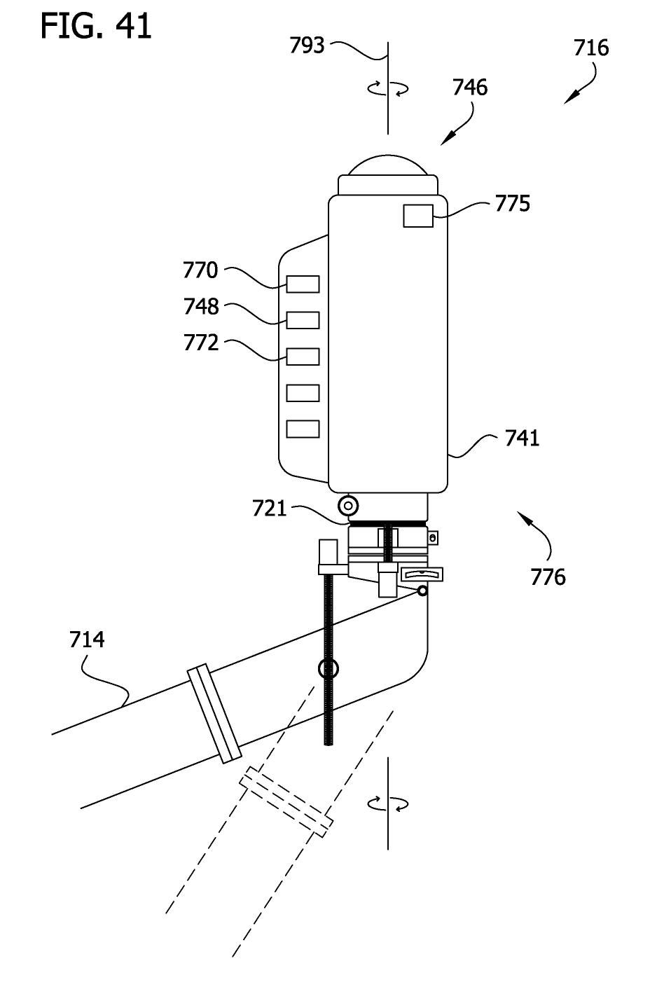

FIGS. 40 and 41 illustrate another embodiment of an SAR pod according to the present invention generally indicated by the reference number 716. In this embodiment, the SAR pod includes a laser radar scanner 727 as an integral part of the pod 716 rather than as an add-on mounted to the pod such as illustrated in FIG. 37. In this embodiment, the laser radar scanner 727 is mounted on the main body 741 between the first and second antennas 754A, 754B. The laser radar scanner 727 is fixed with respect to the main body 741. On the other hand, the SAR antennas 754A, 754B are provided on respective antenna heads 747A, 747B on opposite sides of the laser radar scanner 727. The antenna heads 747A, 747B rotate with respect to the main body 741, as described above with respect to the antenna head 147 illustrated in FIGS. 12 and 16. The laser radar scanner 727 is positioned on a centerline of the main body 741 and extends along the generally vertical axis of rotation 793 of the main body. As with the embodiment illustrated in FIG. 38, during a laser radar scan, the boom 714 supporting the SAR pod 716 remains stationary, and the main body 741 pivots about the generally vertical axis of rotation 793 for the laser scan raster. The laser scan data may be correlated with the SAR scan data, such as illustrated by example in FIG. 39. In this embodiment, components of the SAR pod 716 may be shared between the laser scanner 727 and the radar system 744. For example and without limitation, the laser scanner 727 and radar system 744 may share data from and use of the position indicating system 746, the orientation adjustment system 776, inertial measurement device 775, battery power supply 770, computer/data storage 748, communications interface 772, and remote display/control. In this embodiment, the SAR pod 716 includes a digital encoder 721 as part of the aiming system adapted for monitoring radial orientation of the main body 741 with respect to the generally vertical axis of rotation 793, as described above with respect to the digital encoder 421 and FIG. 35. The encoder may also be used in precisely rotating the main body while performing a laser radar scan.

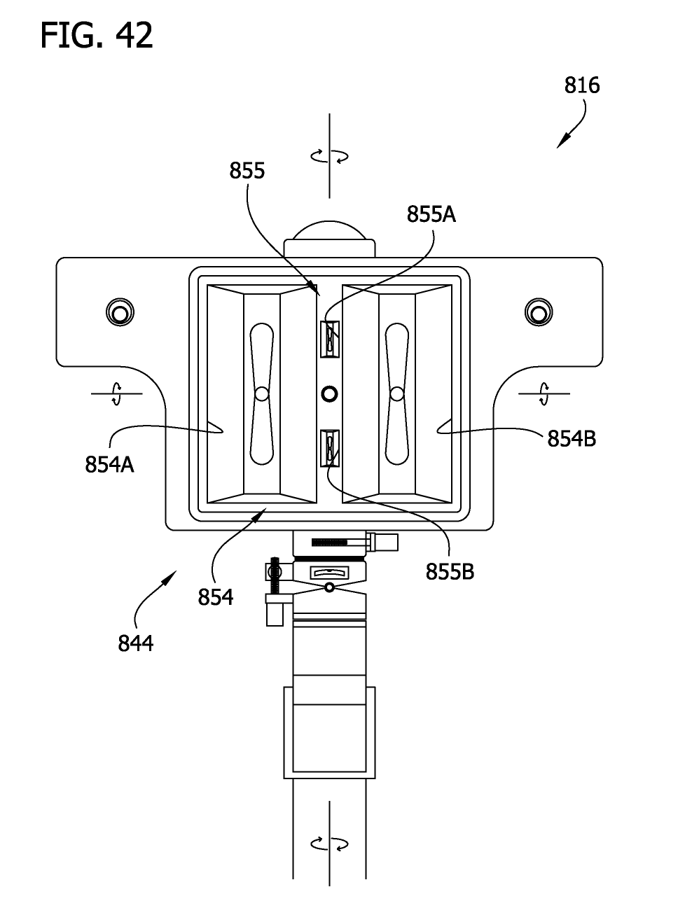

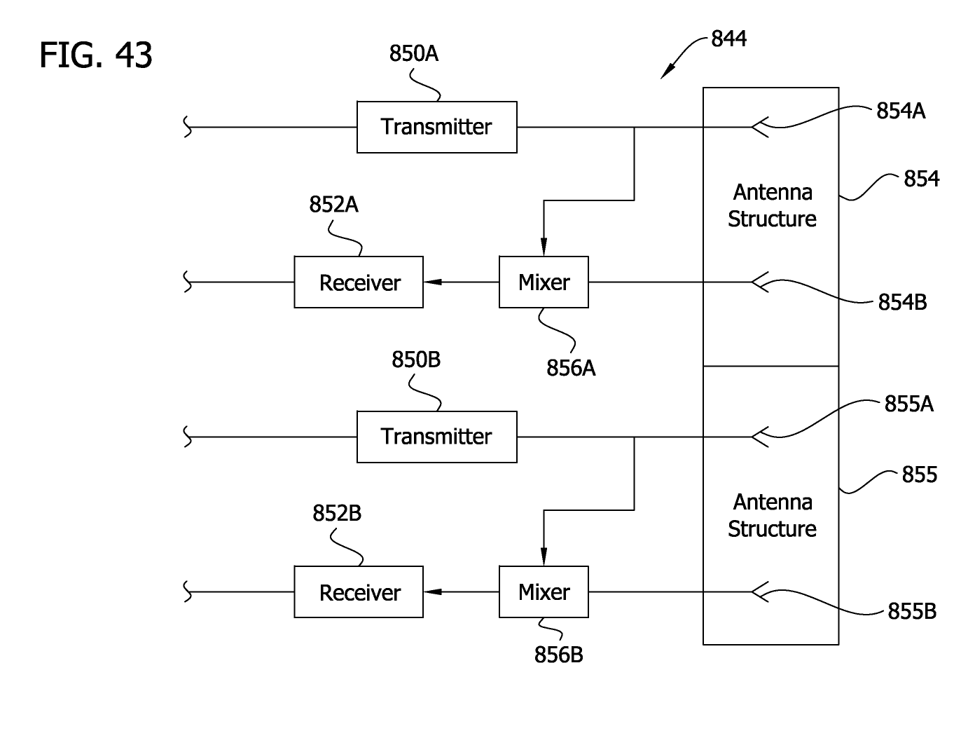

FIGS. 42 and 43 illustrate yet another embodiment of an SAR pod 816 according to the present invention. In this embodiment, the radar system 844 comprises first and second antenna structures 854, 855 each including a pair of antennas. The first antenna structure 854 includes a first antenna 854A and a second antenna 854B. The first antenna is provided in operative connection with a transmitter 850A, and the second antenna is provided in operative connection with a mixer 856A and receiver 852A. The second antenna structure 855 includes a third antenna 855A and a fourth antenna 855B. The third antenna 855A is provided in operative connection with another transmitter 850B. The fourth antenna is provided in operative connection with another mixer 856B and receiver 852B. Using this SAR pod 816, multiple radio frequency band radar signals may be used in a common scan to separately obtain distinct reflections. For example and without limitation, the first transmitter 850A and first antenna structure 154 may be adapted for transmitting lower band frequency radar signals, and the second transmitter 850B and second antenna structure 155 may be adapted for transmitting higher frequency band radar signals. When applied at or near the Brewster angle, the lower band radar tends to couple with the ground surface and refract to illuminate subterranean objects, and the higher band radar tends to scatter and not penetrate the ground surface and reflectively illuminate the surface topography. Accordingly, the SAR pod 816 may be used to perform a single scan which provides both surface and subsurface three-dimensional surveys. The two antenna structure systems 854, 855 can act in phased array and stepped frequency modality during scans. It will be understood that the first and second antenna structures 854, 855 may have other configurations (e.g., may each comprise a single antenna instead of a pair of antennas) without departing from the scope of the present invention.

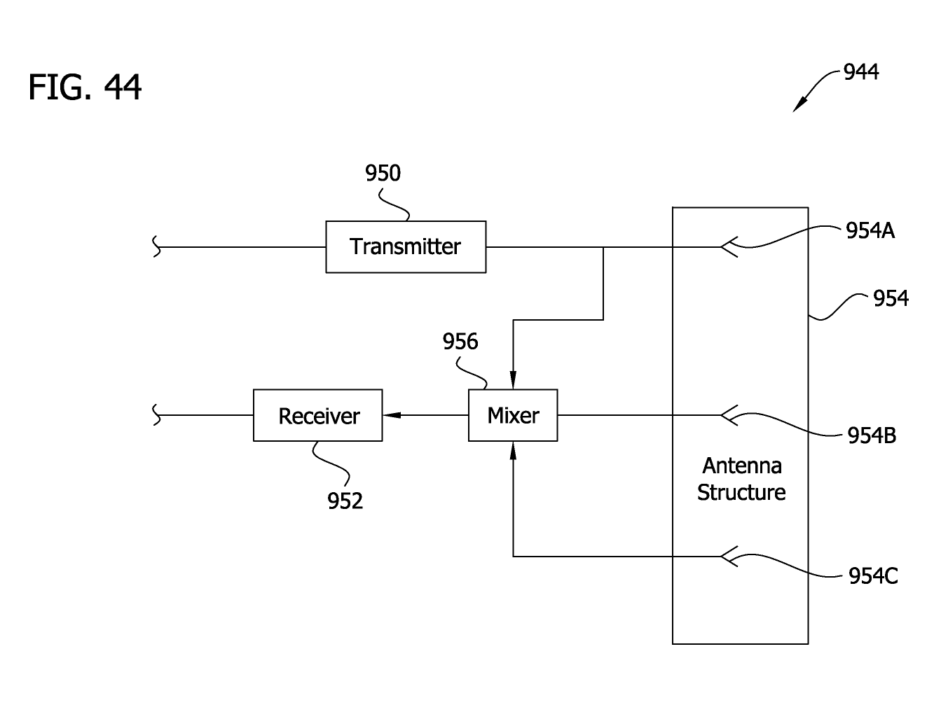

FIG. 44 illustrates another embodiment of a radar system 944 of the present invention. In this embodiment, the antenna structure 954 includes three antennas 954A, 954B, 954C. One of the antennas 954A is operatively connected to the transmitter 950, and two of the antennas 954B, 954C are operatively connected to the mixer 956 and receiver 952. It will be understood that this embodiment of the antenna structure 954, and other embodiments of the antenna structure, including other numbers of antennas, may be used in a radar system without departing from the scope of the present invention.

As explained above, SAR pods according to the present invention may be mountable on booms of various types of vehicles. Several additional embodiments of SAR systems including pods mounted to booms of various vehicles are described below. In general, the vehicle and/or the boom of the vehicle to which the SAR pods are mounted are on a side of the SAR pod opposite the side from which the SAR pod receives reflected radar signals. It will be appreciated that the SAR systems described herein could be mounted on other vehicles than described which may be movable or may not be movable (e.g., stationary support with movable boom) without departing from the scope of the present invention.

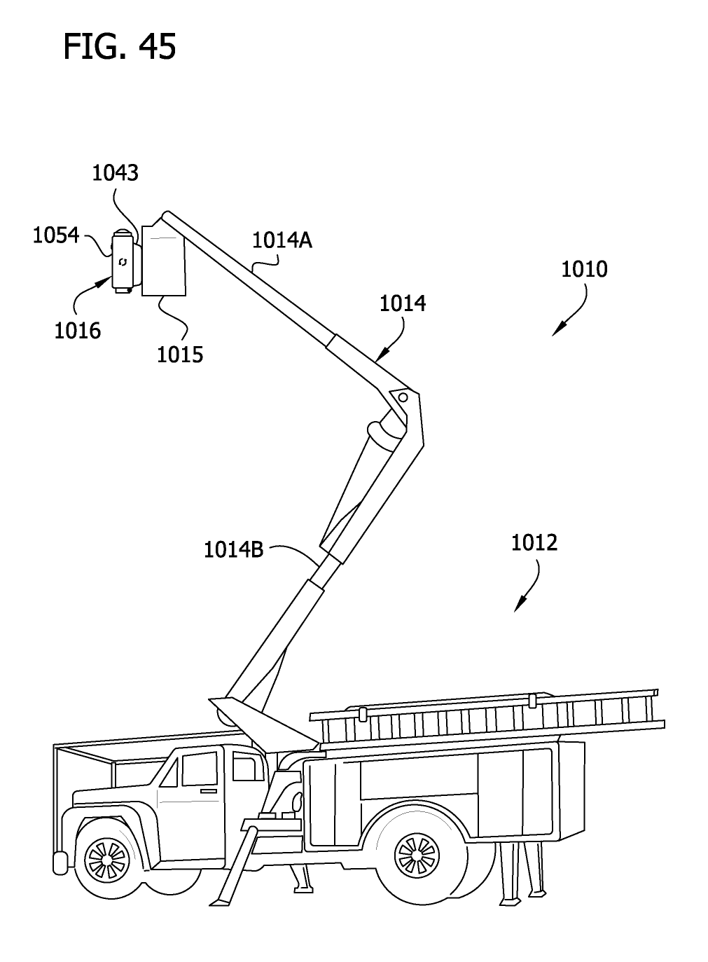

Another embodiment of an SAR system of the present invention is illustrated in FIG. 45 and generally indicated by the reference number 1010. The SAR system includes a vehicle in the form of a utility truck 1012 having a boom 1014 including a bucket 1015 sized for receiving a person (i.e., a utility bucket truck). Overhead electrical lines are frequently present in path of surface and subsurface SAR raster scan patterns, as utility right-of-ways commonly contain both overhead and underground public utility service conduits and lines. Electrical voltages present in typical overhead electrical distribution lines are commonly more than 100 times greater than voltages present in consumer services to residences and others. The risk of ground fault accidental contact and fatal or seriously injurious electrical shock is significant. Tall structures such as booms employed for SAR scanning also can attract natural lightning, which may endanger equipment users. Accordingly, the present SAR system 1010 includes an SAR pod 1016 mountable and operable on an electrically isolated (insulated) boom 1014. The SAR pod 1016 includes a mount 1043 provided on a side of the antenna structure 1054 that is opposite the side from which reflected radar signals are received. The boom 1014 includes electrically insulated boom segments 1014A, 1014B isolating the bucket 1015 and the SAR pod 1016 from ground. The self-contained SAR pod 1016 is connected to remote control and display devices by non-conductive wave communications. The SAR pod 1016 may be releasably or fixedly mounted on the bucket 1015. The mounting of the SAR pod 1016 on the electrically insulated boom 1014 permits SAR scanning adjacent to and in close proximity to energized power lines.

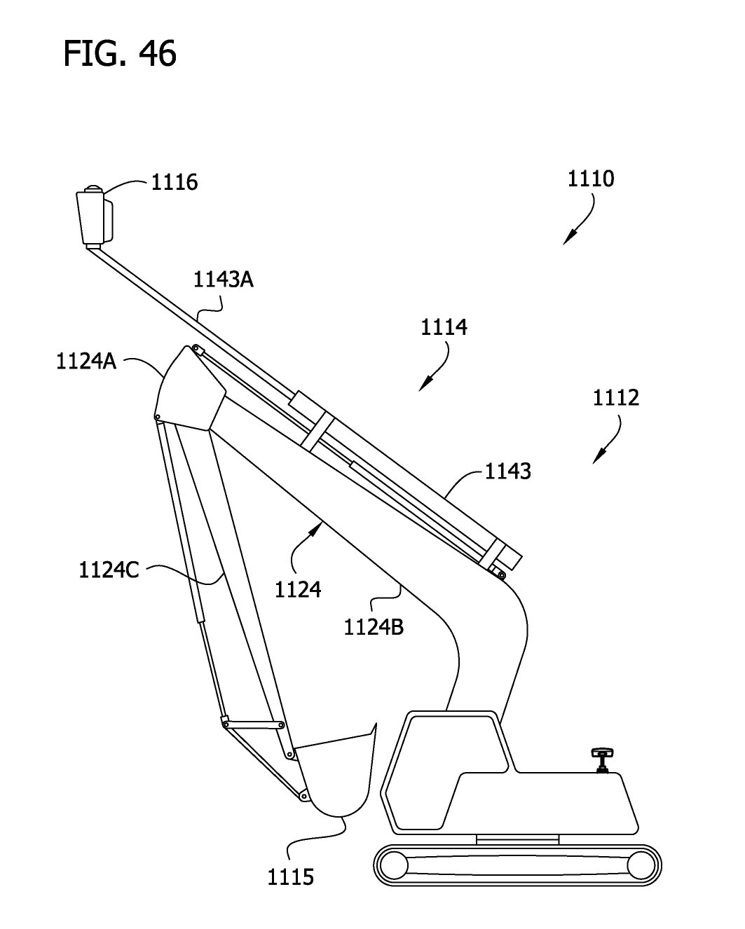

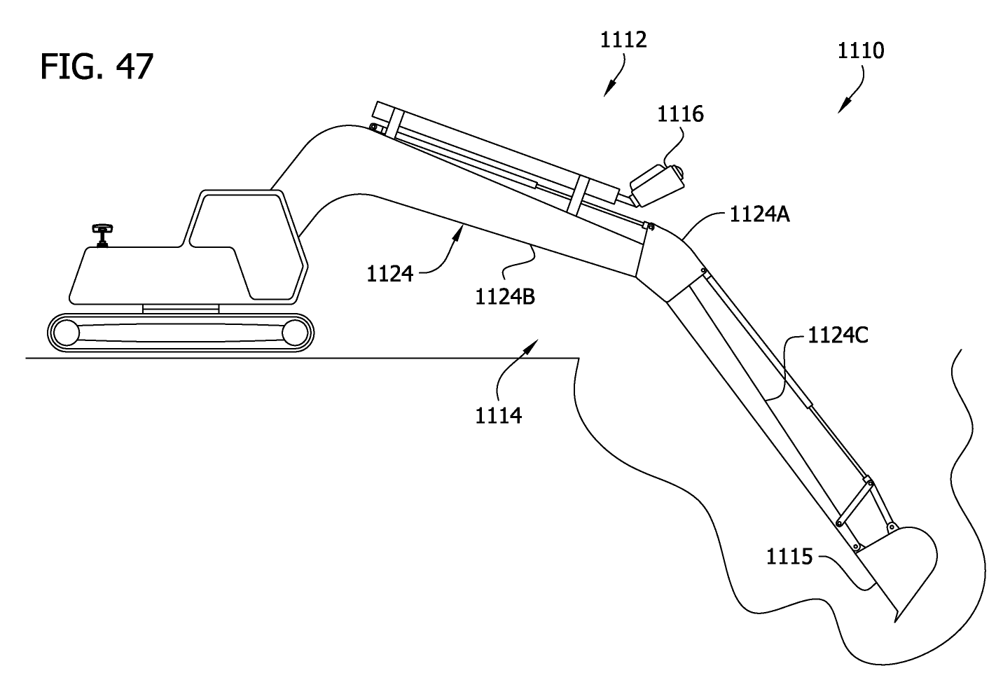

Another embodiment of an SAR system of the present invention is illustrated in FIGS. 46 and 47 and generally indicated by the reference number 1110. The SAR system includes a vehicle in the form of an excavator 1112 commonly known as a track hoe having a boom 1114 including an arm 1124 and an excavator tool or bucket 1115 mounted on the arm. The arm 1124 includes an elbow 1124A between first and second segments 1124B, 1124C of the arm at which the arm bends. In this embodiment, the SAR pod 1116 is mounted on the boom 1114 by mounting structure 1143 which is movable for moving the SAR pod with respect to the boom 1114 while the SAR pod 1116 remains mounted on the boom. More specifically, the mounting structure 1143 includes a telescoping piston 1143A, which is movable between a retracted position and an extended position. In the extended position (FIG. 46), the SAR pod 1116 is positioned at a vantage point with respect to the boom 1114 to transmit radar signals and receive reflected radar signals without the boom interfering. In particular, the SAR pod 1116 is positioned laterally beyond the first arm segment 1124B and elbow 1124A. Desirably, as illustrated, the second arm segment 1124C is rotated about the arm joint 1124A such that the arm segment 1124C and bucket 1115 are moved beneath the first arm segment 1124B to decrease the possibility they would interfere with the SAR scan. The first arm segment 1124B extends downwardly and away from the SAR pod 1116. In the retracted position (FIG. 47), the SAR pod 1116 is positioned adjacent the first arm segment proximally from the elbow. In this position, the SAR pod 1116 is more secure, and the excavator tool 1115 may be used for excavation with less concern that the SAR pod would be vulnerable to damage.

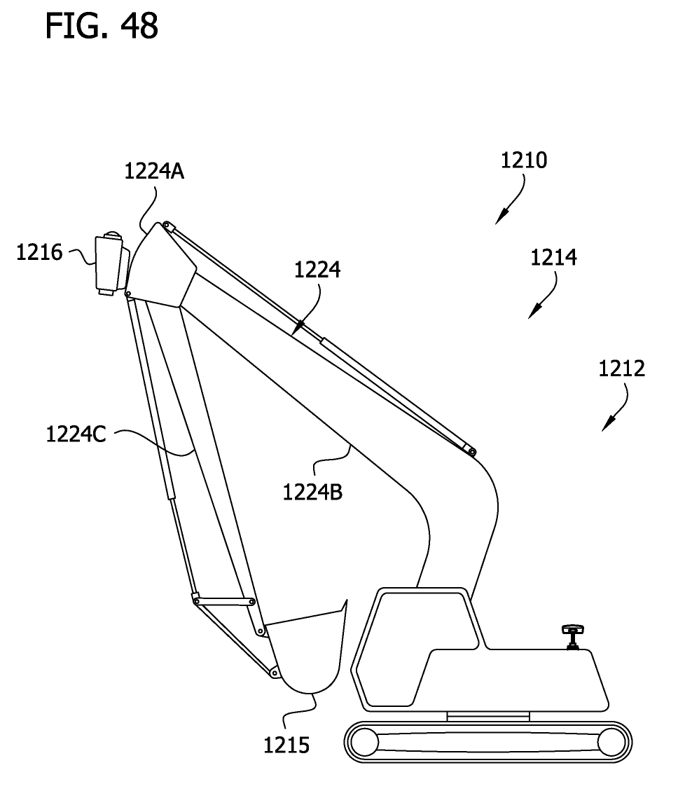

Another embodiment of an SAR system 1210 of the present invention is illustrated in FIG. 48. This embodiment is similar to the embodiment described above and illustrated in FIG. 46. For example and without limitation, the system 1210 includes a track hoe 1212 comprising a boom 1214 including first and second arm segments 1224B, 1224C joined by an elbow 1224A. In this embodiment, the SAR pod 1216 is mounted on the boom 1214 adjacent the elbow 1224A. More particularly, the SAR pod 1216 is mounted to joint structure forming the elbow 1224A of the arm 1224. As shown in FIG. 48, when the second arm segment 1224C is rotated about the joint structure 1224A to bring the second arm segment and excavation tool 1215 under the first arm segment 1224B, the SAR pod 1216 is positioned for performing an SAR scan without interference from the boom 1214. The SAR pod 1216 may be releasably or fixedly mounted on the elbow structure 1224A. For example and without limitation, the SAR pod 1216 may be releasably mounted on a conventional track hoe 1212 for performing an SAR scan and then removed from the track hoe before excavation is continued to prevent potential damage to the SAR pod due to the excavation motion of the boom.

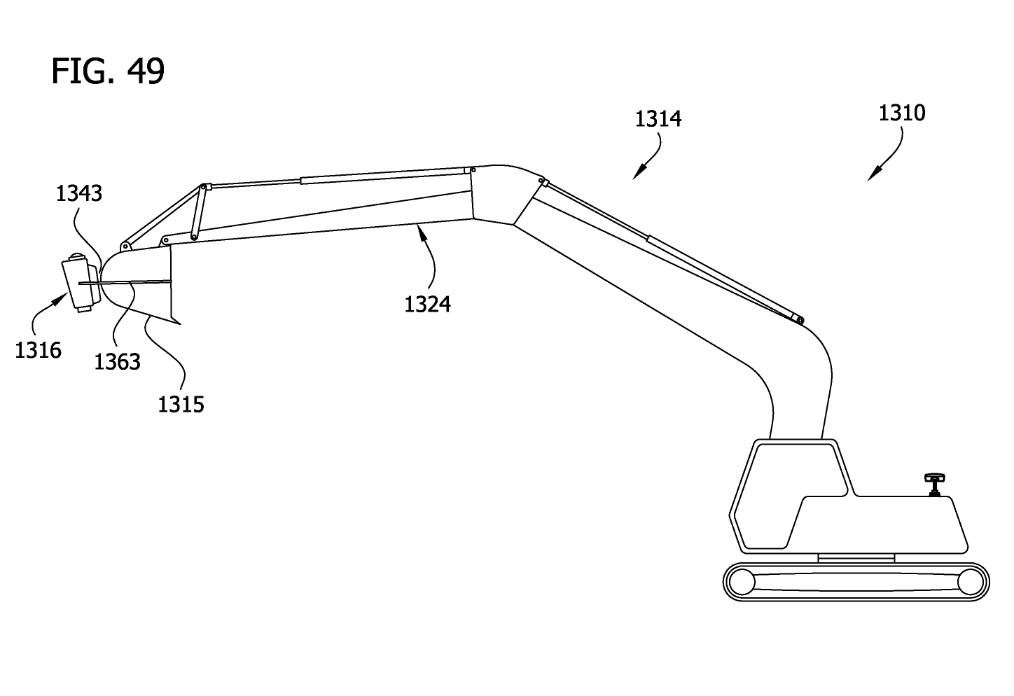

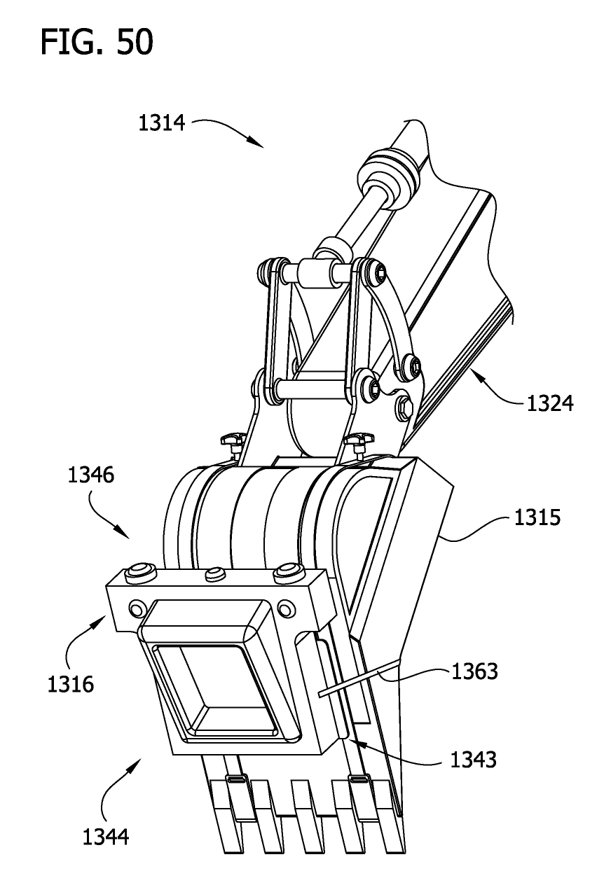

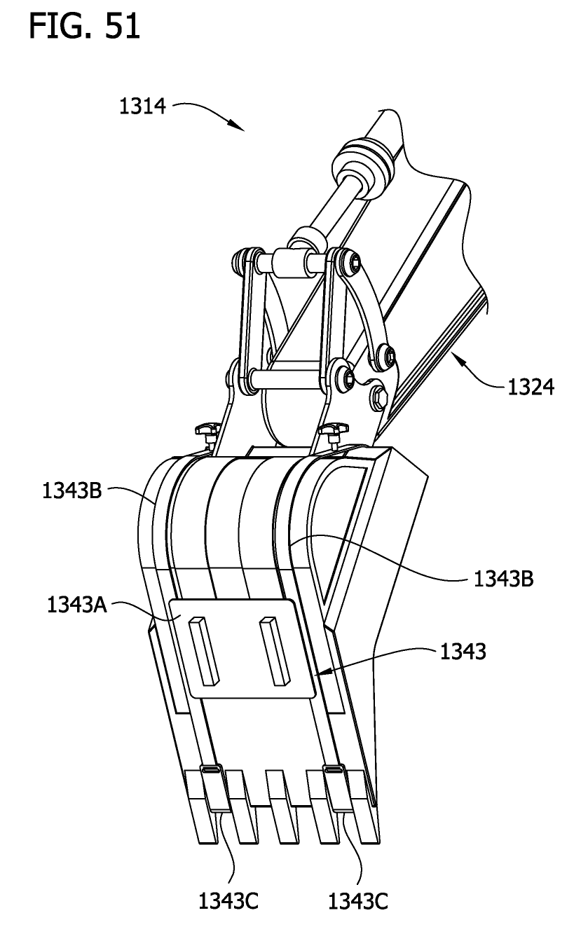

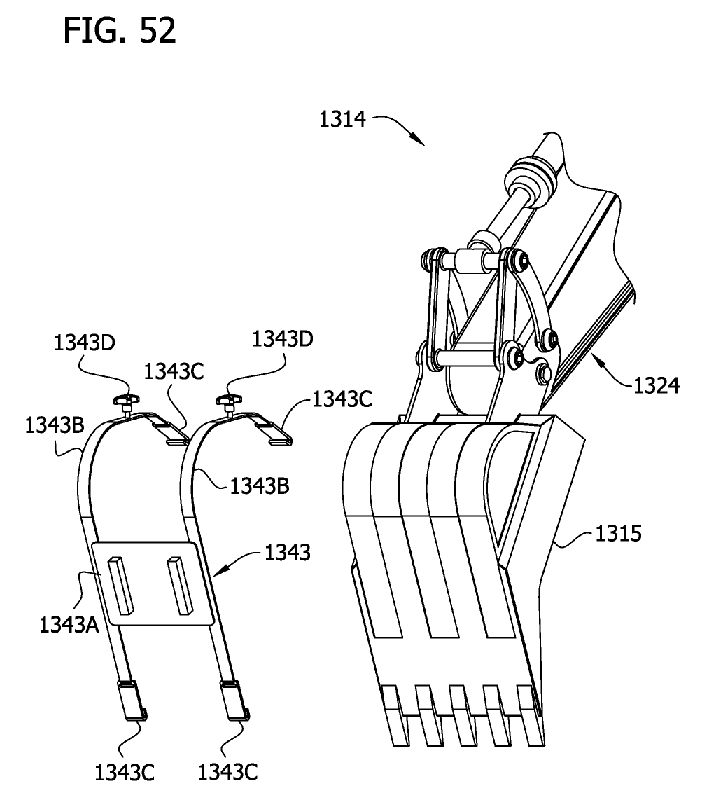

Another embodiment of an SAR system 1310 of the present invention is illustrated in FIGS. 49-52. This embodiment is similar to the embodiment described above and illustrated in FIG. 48. In this embodiment, the SAR pod 1316 is releasably mounted on the bucket 1315. More specifically, the SAR pod 1316 is releasably mounted on a rear side of the bucket 1315 opposite the excavating cavity of the bucket. The arm 1324 of the boom 1314 may be oriented (e.g., as shown in FIG. 49) such that the SAR pod 1316 is positioned at a suitable vantage point with respect to the surface of the earth for performing an SAR scan. As shown in FIGS. 50-52, the SAR system 1310 includes a mounting bracket 1343 adapted for mounting the SAR pod on the excavator bucket 1315. The mounting bracket 1343 includes a plate 1343A for mounting of the SAR pod 1316 on the bracket 1343. The mounting bracket 1343 also includes adjustable retention straps 1343B and bucket engaging hooks 1343C at ends of the straps. Strap tightening mechanisms 1343D are provided on the straps 1343B for shortening the straps to maintain the hooks 1343C in secure engagement with the bucket 1315. Accordingly, the SAR pod 1316 may be mounted on the bucket 1315 for performing an SAR scan and then removed from the bucket for using the bucket for excavating. The SAR system 1310 also includes a modular failsafe connection comprising a safety connector 1363 (FIG. 50). The safety connector 1363 is configured for connecting to the boom 1314 as a backup to the mounting bracket 1343. In the illustrated embodiment, the safety connector 1363 comprises a cable 1365 which extends around the bucket 1315 and has ends which are each connected to the SAR pod 1316. The safety connector 1363 when not connected to the boom 1314 may prevent operation of the SAR pod 1316, including the radar system 1344 and/or the position indicating system 1346. For example and without limitation, the connection of the ends may close a power circuit which places the battery in operative communication with the radar system and/or position indicating system.

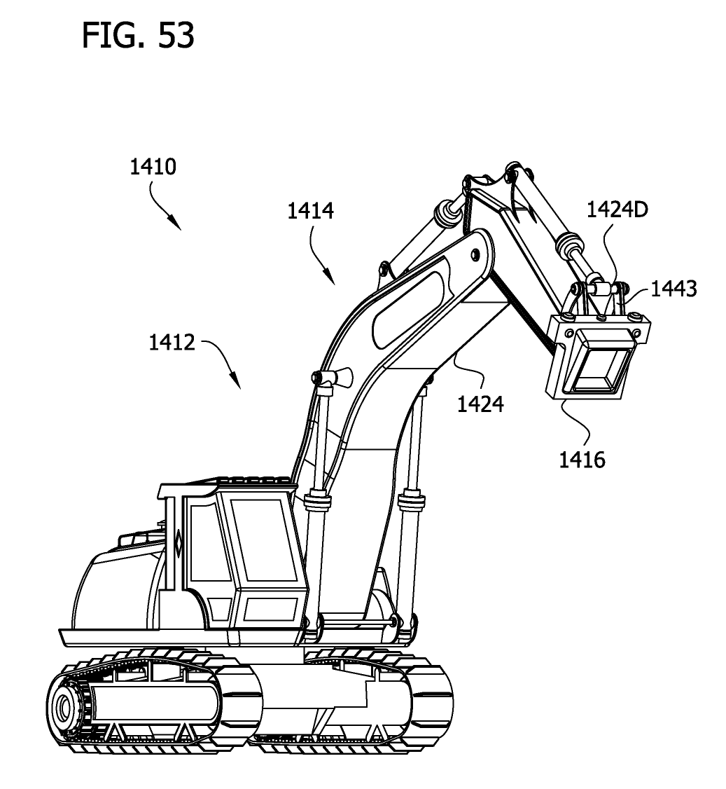

FIG. 53 illustrates another embodiment of an SAR system 1410 of the present invention. In this embodiment, the vehicle 1412 comprises a boom 1414 including an arm 1424 and mounting structure 1424D for mounting an excavator tool (not shown) on the arm. The SAR pod 1416 is shown mounted on the arm 1424 in place of the excavator tool. The SAR pod 1416 includes mounting structure 1443 which interfaces with the mounting structure 1424D of the boom 1414 also used to mount the excavator tool, for mounting the SAR pod on the boom. Accordingly, the vehicle 1412 may be used for performing an SAR scan, and then the SAR pod 1416 may be removed and replaced with the excavator tool for excavating.

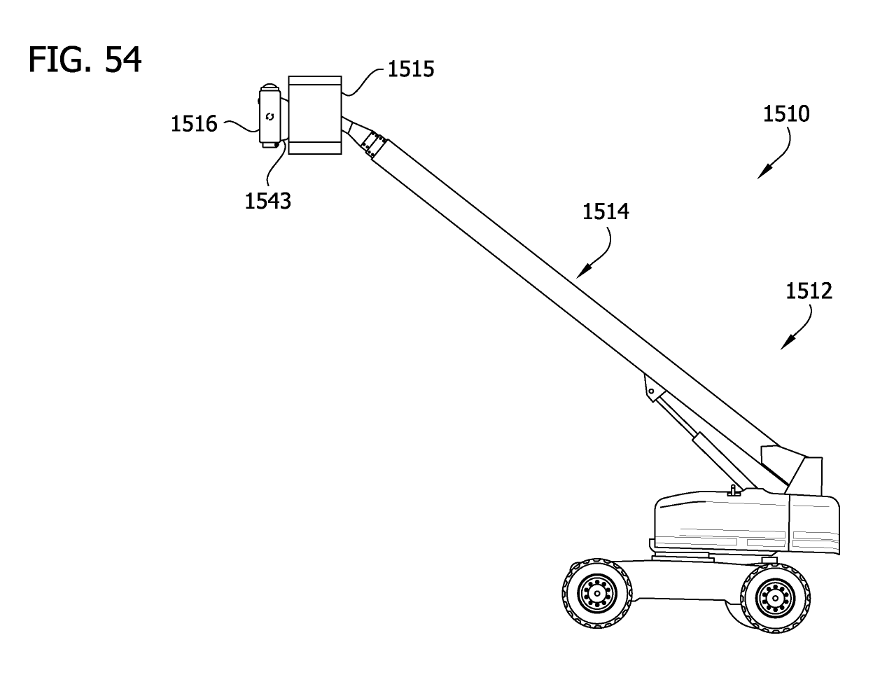

FIG. 54 illustrates another embodiment of an SAR system 1510 of the present invention. In this embodiment, the vehicle is provided in the form of a man lift 1512 comprising a boom 1514 including a basket 1515. The SAR pod 1516 includes a mount 1543 adapted for releasably mounting on the basket 1515.

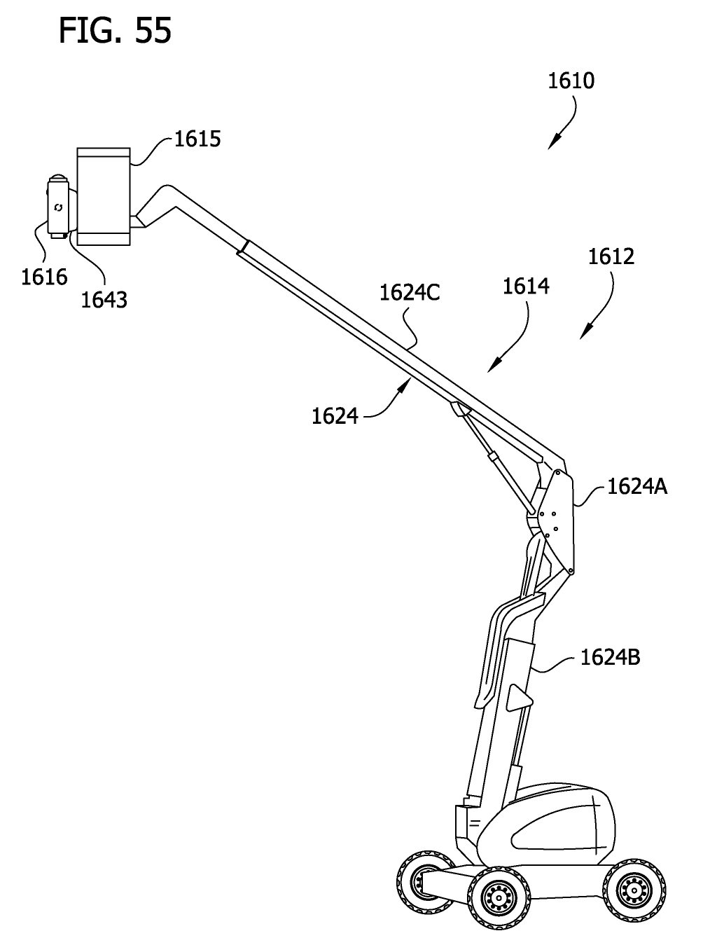

FIG. 55 illustrates another embodiment of an SAR system 1610 of the present invention. This embodiment is similar to the embodiment illustrated in FIG. 54. The SAR pod 1616 includes a mount 1643 adapted for releasably mounting on a basket 1615 of the vehicle 1612. In this embodiment, the boom 1614 comprises an arm 1624 including first and second arm segments 1624B, 1624C connected by an elbow 1624A.

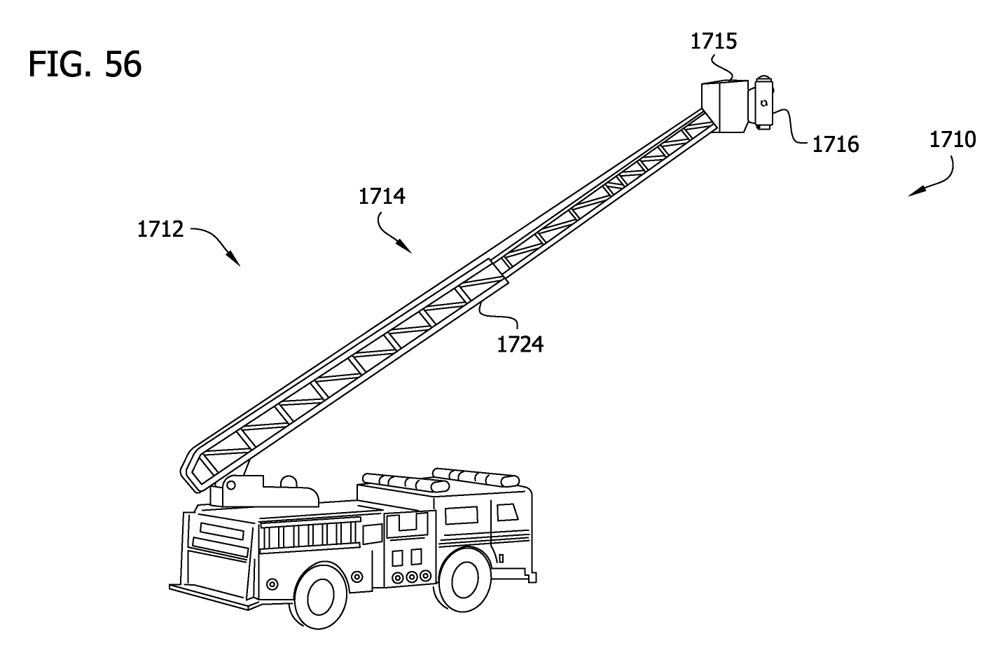

FIG. 56 illustrates another embodiment of an SAR system 1710 of the present invention. In this embodiment the vehicle is provided in the form of a fire truck 1712 having a boom 1714 including an extendable ladder 1724. The SAR pod 1716 is releasably mountable on a bucket 1715 at a distal end of the ladder 1724.

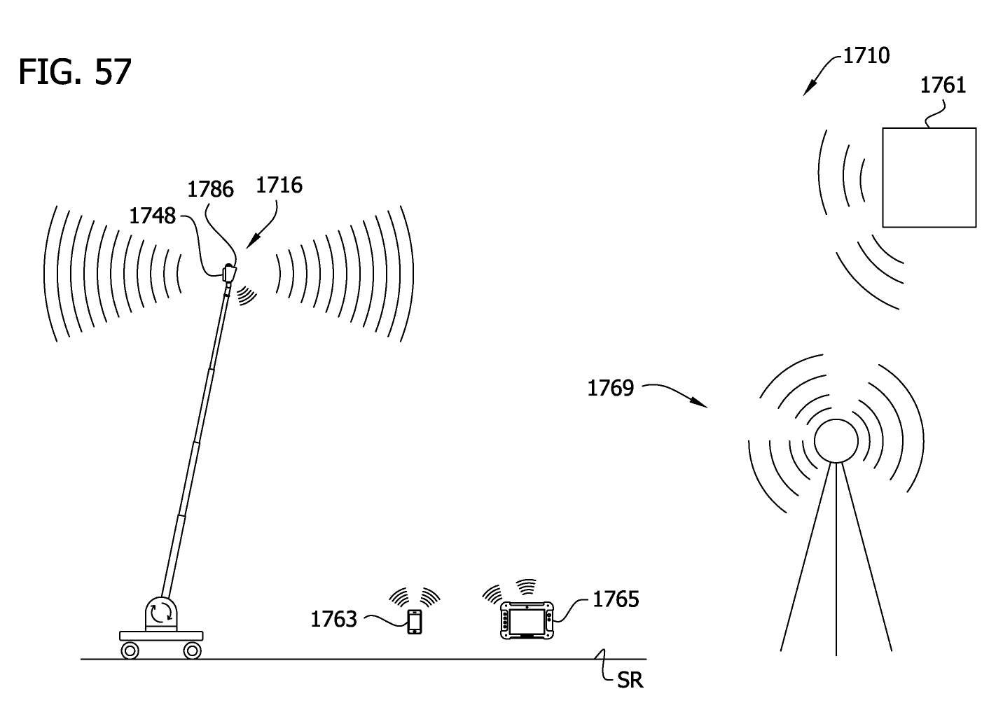

Referring to FIG. 57, in another aspect of the present invention, an SAR pod 1716 is adapted for networked communication to local devices and remote networks. The SAR system 1710 may be used in steps of the process of setting up or planning an SAR scan, initiating an SAR scan, data collection, data processing, and field display and interactive use of the processed data. In these steps, data is collected locally. The data may be processed locally and then immediately or relatively quickly be used locally. Alternatively, the data may be communicated to remote computers such as cloud based computers, and processed in the remote computers. The processed data may then be returned to the site for use in the next steps in scanning, surveying, and/or excavation processes.

Still referring to FIG. 57, in this embodiment, the SAR system 1710 may include a display device 1763 and/or a field computer 1765 for local use with the SAR pod 1716, and the SAR system may include the off-site computer 1761 (e.g. a cloud computer). The SAR pod 1716 may communicate wirelessly with the display device 1763 and the field computer 1765 for enabling a user to remotely control operation of the SAR pod 1716 and send and receive information associated with operation of the SAR pod. Moreover, components and systems or parts of systems previously described as optional components of the SAR pods may be provided as systems and components of the display device 1763, field computer 1765, and/or off-site computer 1761. For example and without limitation, the computer 1748 of the SAR pod 1716 may be omitted and its functions may be performed by the display device 1763, field computer 1765, and/or off-site computer 1761. As shown in FIG. 57, data may be communicated from the SAR pod 1716 directly to the off-site computer 1761 or indirectly to the off-site computer via the display device 1763 or field computer 1765 over a telecommunications system 1769 and/or various other wired or wireless network connections. The SAR pod 1716 may include a signal repeater 1786 for receiving and repeating a signal from the field computer 1765, display device 1763, or other device and transmitting it to the off-site computer 1761 or other device. For repeating a signal, the SAR pod 1761 may be raised to a higher vantage point than used for an SAR scan for optimally positioning the signal repeater. The off-site computer 1761 may receive data from the SAR pod 1716, display device 1763, and/or field computer 1765, process the data, and transmit the processed data back to the SAR pod, display device, and/or field computer for use of the processed data at the scan region SR. For example and without limitation, the scan data generated by the SAR pod 1716 may be built into the three-dimensional image by the off-site computer 1761 and transmitted back to the scan region SR. In other embodiments, the SAR pod 1716, display device 1763, and/or field computer 1765 may be adapted to process the data for use of the data at the scan region SR without requiring the data to be sent off-site for processing. It will be understood that processing of the data to, for example, produce an image may be done in real time or not in real time. Survey data of the type described herein may be collected and then processed in another place at another time and then transmitted in a suitable manner back to the site for use. There can be a substantial interval of time between the collection and processing of the data within the scope of the present invention.

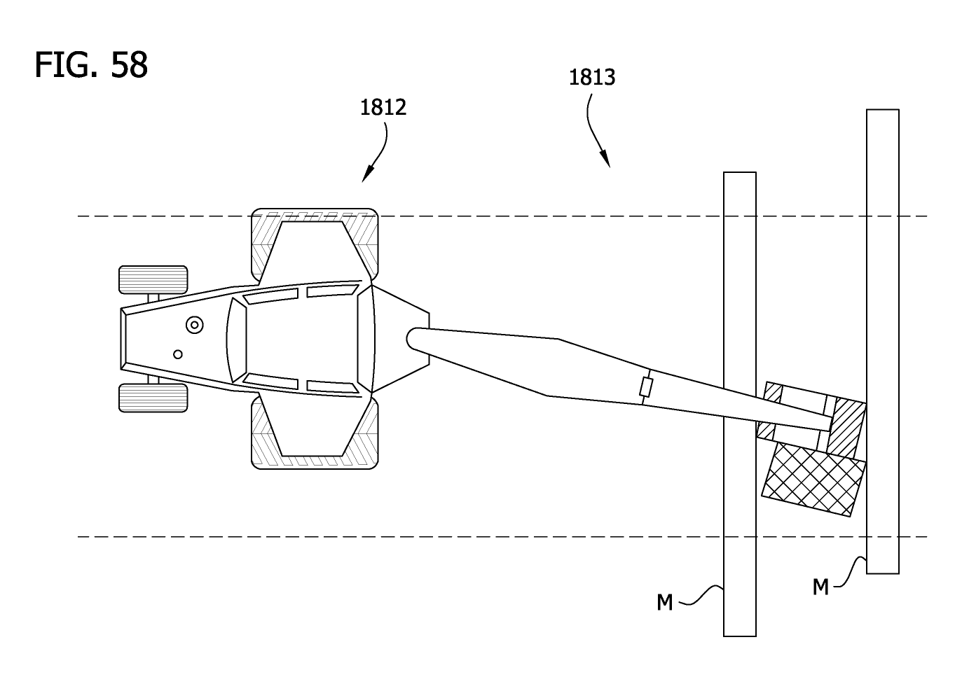

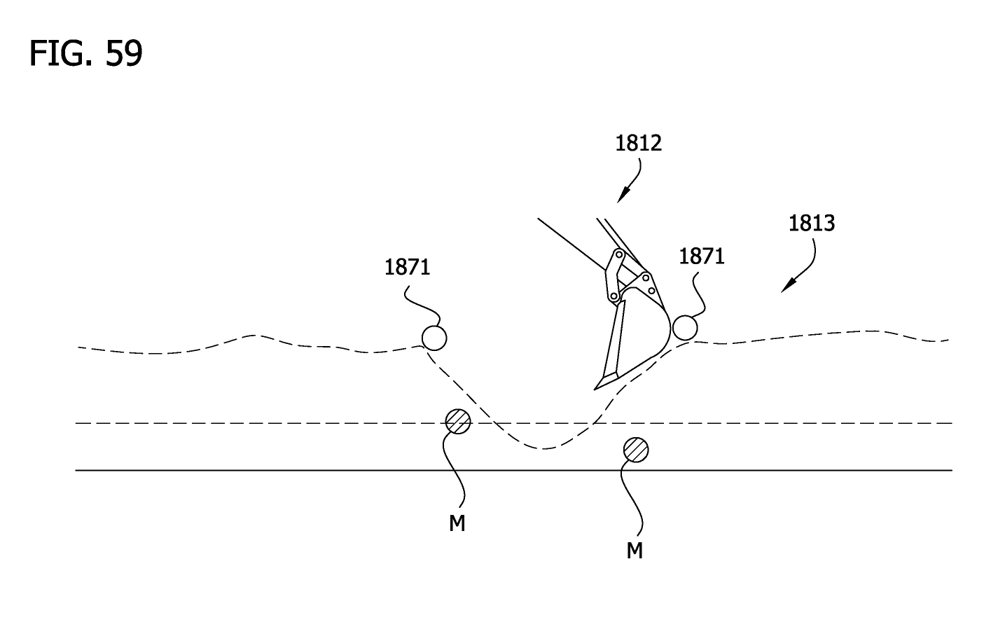

Referring now to FIGS. 58 and 59, an exemplary illustration of one use that can be made from the image data collected as described above is shown. A backhoe 1812 may be able to dig within a confined volume 1813 in which, as illustrated, there are two underground obstructions M (in this case pipes) tightly constraining the dig area. In its most rudimentary form, the data may be used to position markers 1871 (FIG. 59) on the surface that delimit the boundaries of the dig area. The markers 1871 indicate the position of the pipes M out of sight underground. As one possible alternative, the image data collected could be used to modify a guidance system of the backhoe 1812 (or other pertinent machine) so as to constrain digging to the permitted volume, as shown in FIG. 59. Various forms of machine control/guidance may be used, some of which will be described in more detail hereinafter. A display device or field computer, such as the display device 1763 and field computer 1765 of FIG. 57, may be provided in the cabin of the backhoe and could be configured to provide an audible and/or visual warning to the backhoe operator if the bucket moves too close to either of the pipes M. If the backhoe is equipped with a display device or field computer with a display, augmented reality could be used by the operator to guide digging. For example, the dig volume as viewed on the display device or monitor could have lines drawn on the surface of the volume showing the boundaries of the digging volume. The imposed lines could be considered “augmented reality”. This would be similar to using markers 1871 as described above, but the markers would be virtual rather than actual. A somewhat more sophisticated augmented reality approach would be to show on the display device or monitor a representation of the pipes M underground that would provide even more information to the operator about what needs to be avoided when digging.

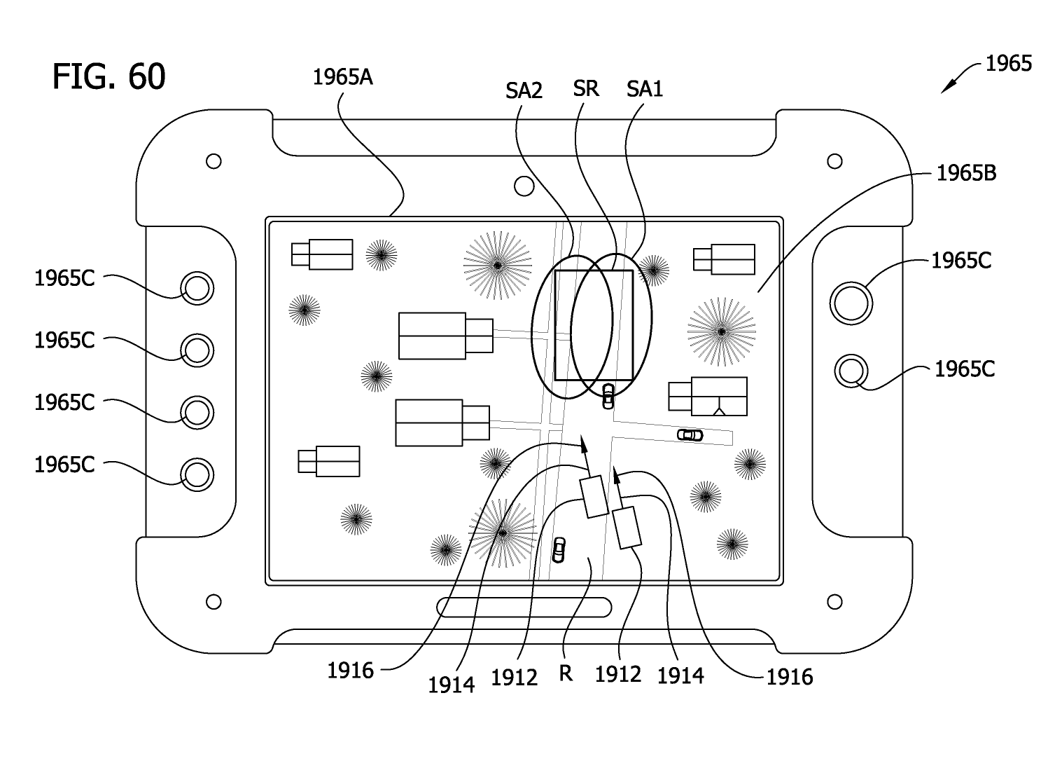

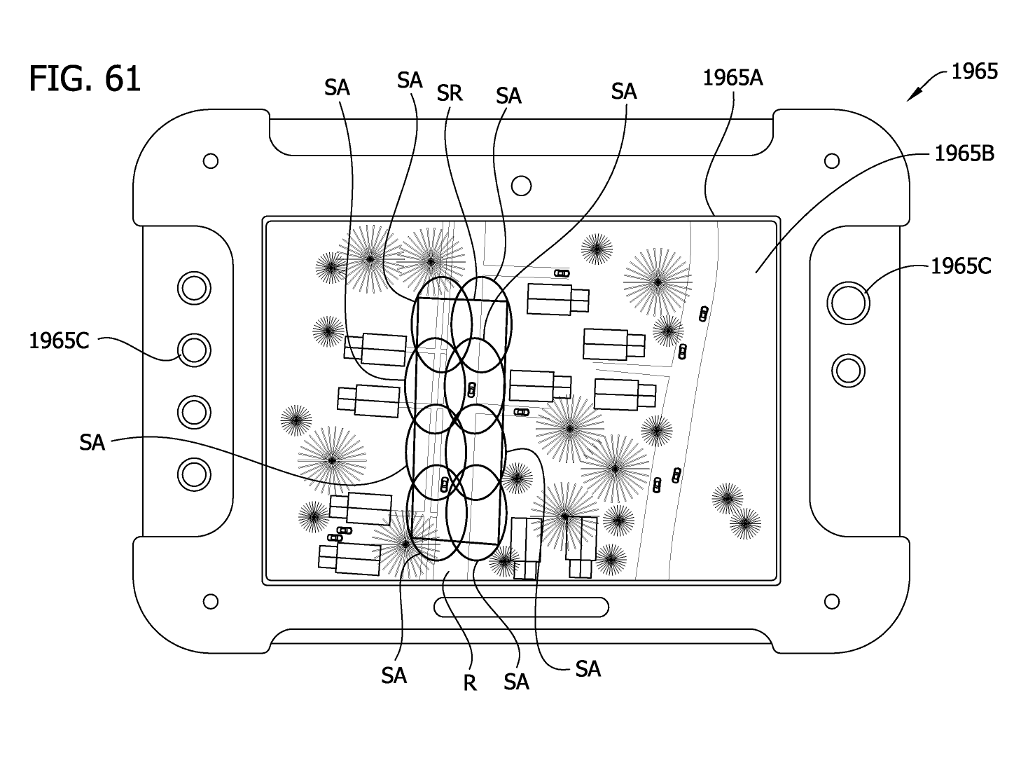

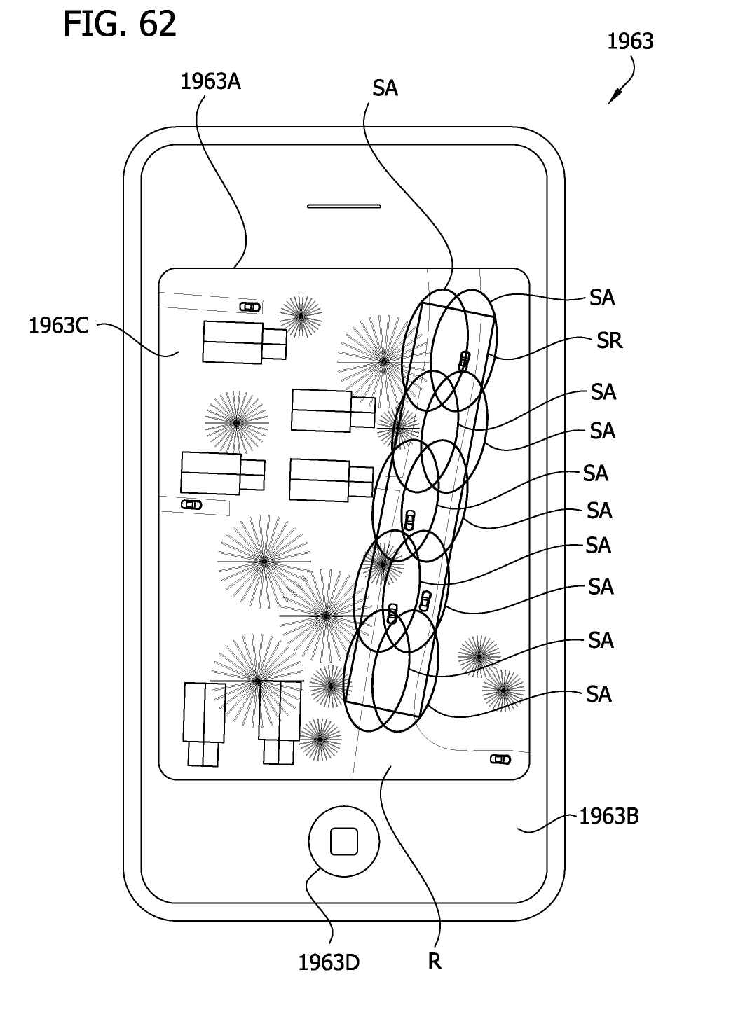

Usually, a scan using the SAR pod of the present invention will require some level of pre-planning before execution. Planning can be done at the site or remotely. FIGS. 60-63 illustrate the use of a field computer 1965 (FIGS. 60 and 61) or display device 1963 (FIG. 62) that can be used to plan the scan. Both the field computer 1965 and display device 1963 are illustrated as wireless, portable hand-held devices. The field computer 1965 and display device 1963 may include a configuration similar to that illustrated in FIG. 11 (including a processor and tangible computer readable storage medium). In the illustrated embodiments, both the field computer 1965 and display device 1963 include a display 1965A, 1963A as part of a communication system. The display device 1963 may or may not include a computer 1963B (i.e., may be provided with an integral or connected computer or may be in wireless or wired communication with a computer providing a signal to the display). The field computer 1965 includes inputs in the form of a touch screen 1965B and buttons 1965C. The display device 1963 also includes inputs in the form of a touch screen 1963C and a button 1963D. Other inputs such as keyboards, microphones, mice, connection ports, etc. may be used without departing from the scope of the present invention.

Referring to FIG. 60, it can be observed that in many instances more than one scan will need to be done to cover the desired area or volume. The ovals superimposed shown in the aerial image of the region in which the scan occurs show that two scans will be needed to cover the desired surface area or scan region SR. Alternatively, the ovals may represent previously completed scan areas SA1, SA2. The ovals represent scan areas SA1, SA2 associated with individual scans each including a scan pattern. The size and number of the scan areas SA1, SA2 can be determined by the computer (e.g., off-site computer, field computer, and/or display device) when the operator enters the relevant information or the computer retrieves the information from a database. That information may include the dielectric constant of the soil, the desired resolution of the three dimensional image, the desired continuity (i.e., overlap and/or adequacy of common correlative positional reference points between adjacent scan areas), the desired scan area, and any environmental limitations on the movement of the SAR pod during scanning (e.g., power lines, trees, roadways, rights of way, and the like).

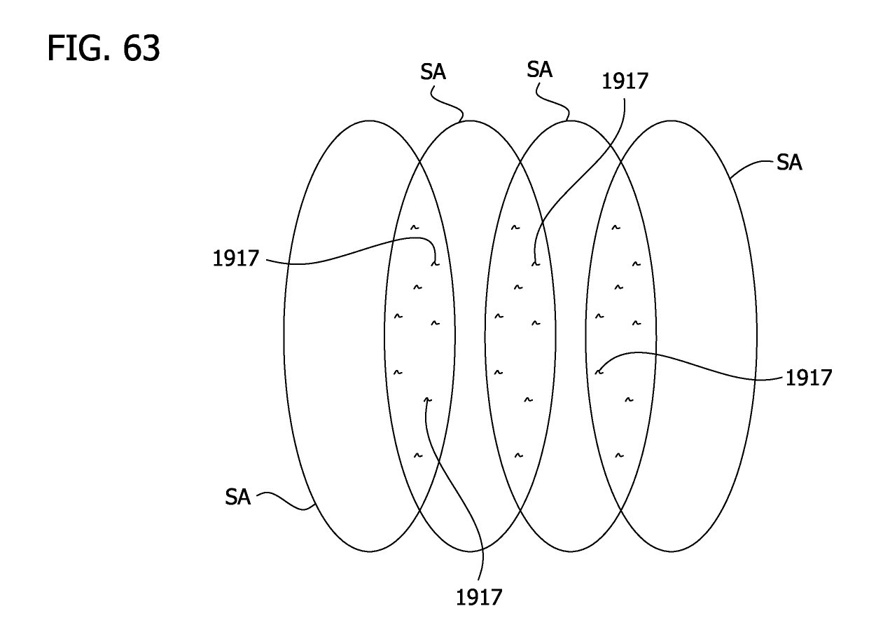

The computer (e.g., off-site computer, field computer, or display device) can determine the number and location of separate scans that will be required to cover the desired scan region SR. Moreover, the computer may determine if a prior scan area or scan areas in combination include an entirety of the scan region, and this may be displayed (e.g., as shown in FIG. 61 for scan areas SA and scan region SR). The scan areas SA are typically overlapped, such as shown in FIGS. 60-63. Referring to FIG. 63, this assures that there are enough common reference points 1917 (whether above or below ground) between adjacent scan areas SA (e.g., utility poles, underground pipes, or other features) so that the images obtained can be integrated into a single effective image.

The computer (e.g., field computer 1965, display device 1963, or off-site computer such as computer 1761 of FIG. 57) can use the above parameters (e.g., soil dielectric, resolution, continuity, etc) in other ways besides planning scan areas SA. The computer may determine suggested positions for the location of the SAR pod 1916 and/or support vehicle 1912. Moreover, the computer may determine a suggested scan pattern along which the boom 1914 will move the SAR pod 1916. For example, resolution of a scan area SA may be increased by using a raster pattern that has wider extents. Moreover, a raster pattern can be planned which avoids obstacles or environmental limitations. The suggested location of the SAR pod 1916, suggested location of the support vehicle 1912 for the SAR pod, suggested position of the boom 1914, and/or the suggested raster pattern can be illustrated on the a display such as on the display device 1963 or field computer 1965. Individual scan areas SA and/or corresponding positions of the vehicle 1912 or boom 1914 can be displayed and indicated as “completed” or “to be completed” on the display (e.g., by color scheme, etc.). The computer may be adapted for determining whether a scan of a desired scan area can be performed from a current position of the SAR pod 1916.

In the case illustrated in FIG. 60, there are two indicated positions for the support vehicle 1912, one position for each of the two scans required. As shown, one of the positions is in the roadway R. This information can be used to plan ahead to do the scan when it is most convenient for the roadway R to be shut down. Also, the field computer 1965, display device 1963, and/or off-site computer 1761 can suggest to the operator that the scan be done from a different vantage in order to avoid having to shut down the roadway R. All of this can be done remotely before any equipment is brought to the site, or it could be done in real time. The scan could be done with the equipment at the site, but in a position not interfering with normal traffic. The image depicted on the field computer 1965 in FIG. 60 may be a photograph, which could be taken with a suitably equipped SAR pod (e.g., SAR pod 116 including camera 184, or other pod embodiments). The boom 1914 of the vehicle may be raised to its highest position to position a camera on the SAR pod 1916 at a vantage point to acquire an aerial view (similar, but perhaps not exactly like the view shown in FIG. 60). In other embodiments, the aerial image may be obtained from other sources, such as an Internet database providing access to such images.

In another aspect, in the case illustrated in FIG. 60, one of the two indicated positions for the vehicle 1914 may be the current position of the vehicle, with the estimated scan area SA1 associated with that position of the vehicle also being indicated. The other indicated vehicle position 1914 may be previously completed or be the next suggested position for the vehicle. The other indicated scan area SA2 may be associated with the previous or next vehicle position.

FIGS. 61 and 62 show planning for scanning a scan region SR that is a much larger portion of the street R shown in FIG. 60. It can be seen that the superimposed scan areas SA (represented by ovals) overlap not only side by side, but also end to end so that all scan areas can be integrated into a coordinated image of the street R and its subsurface volume. FIG. 61 shows the image on the field computer 1965, and FIG. 62 shows the same image on the display device 1963. The field computer 1965, display device 1963, and/or off-site computer 1761 may be used for planning and/or positioning of the SAR system. Common reference points 1917 above and/or below ground between the various scan areas SA (represented by the oval regions) are shown in FIG. 63. The reference points 1917 can be used to integrate the various imaged areas as described previously herein.

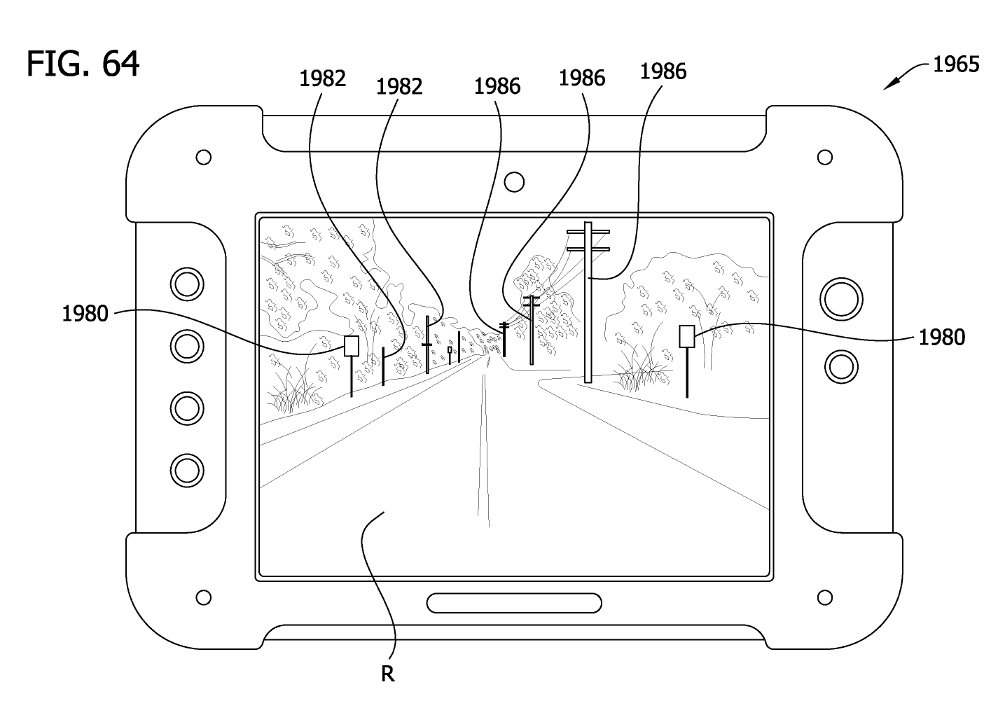

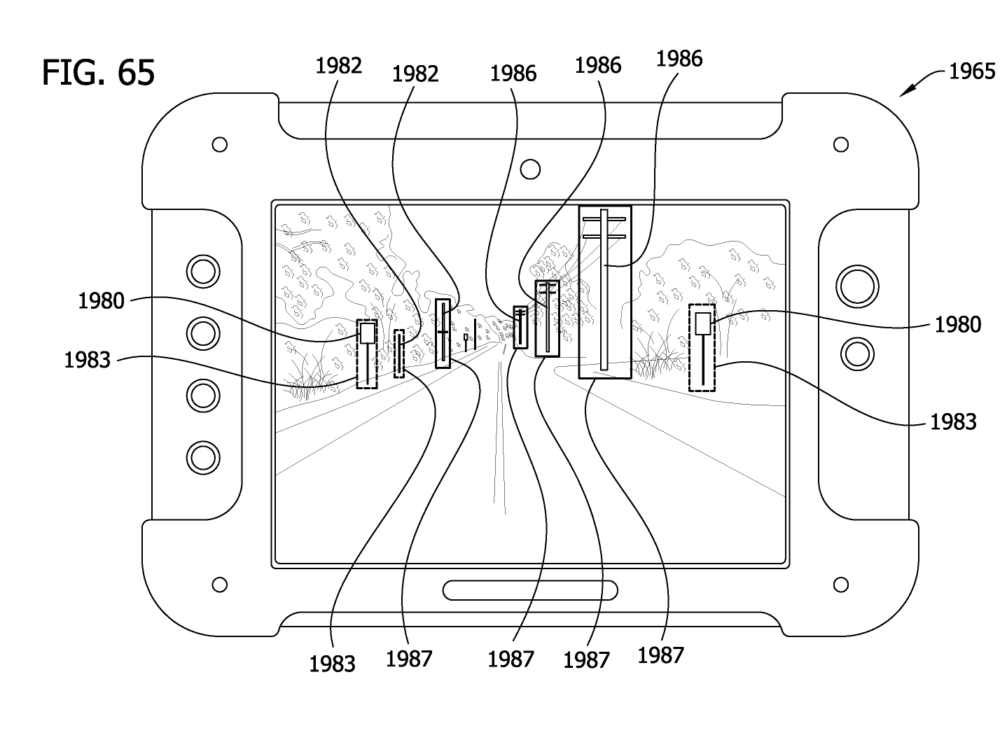

Other planning techniques that can be used separately or in conjunction with those described above are shown in FIGS. 64 and 65. In these views a photographic image is obtained at ground level. In one embodiment, the image is obtained using the field computer 1965. Once the image is obtained, certain features can be identified in the image that can be used in the scanning process (e.g., planning the scan, executing the scan, and/or processing collected scan data). As shown in FIG. 65, features of the image are selected by “lassoing” them such as by drawing a box around them to input into the computer memory 1962. Certain features, such as metal signs 1980 and poles 1982 to the sides of the roadway R are boxed in by dashed lines 1983 (the screen may show the box as a particular color or in some other fashion) to indicate that these are items that may produce undesired radar returns. Knowledge of these can allow the processing software (e.g., of the field computer 1965, display device 1963, and/or off-site computer 1761) to make the proper allowances for the undesired returns and/or help to plan the scan so as to minimize their effect (e.g., plan to position the vehicle 1912, boom 1914, and/or SAR pod 1916 for minimizing effects of interfering environmental objects). Other features of the image (in this case utility poles 1986) are boxed with solid lines 1987 to indicate these as external reference points to be used in orienting and aiming the SAR pod 1916 to guide the radar signal to a desired location or scan area SA. The use of environmental features to provide reference has previously been discussed herein for use in aiming the SAR pod (see discussion in regard to FIG. 24 above).

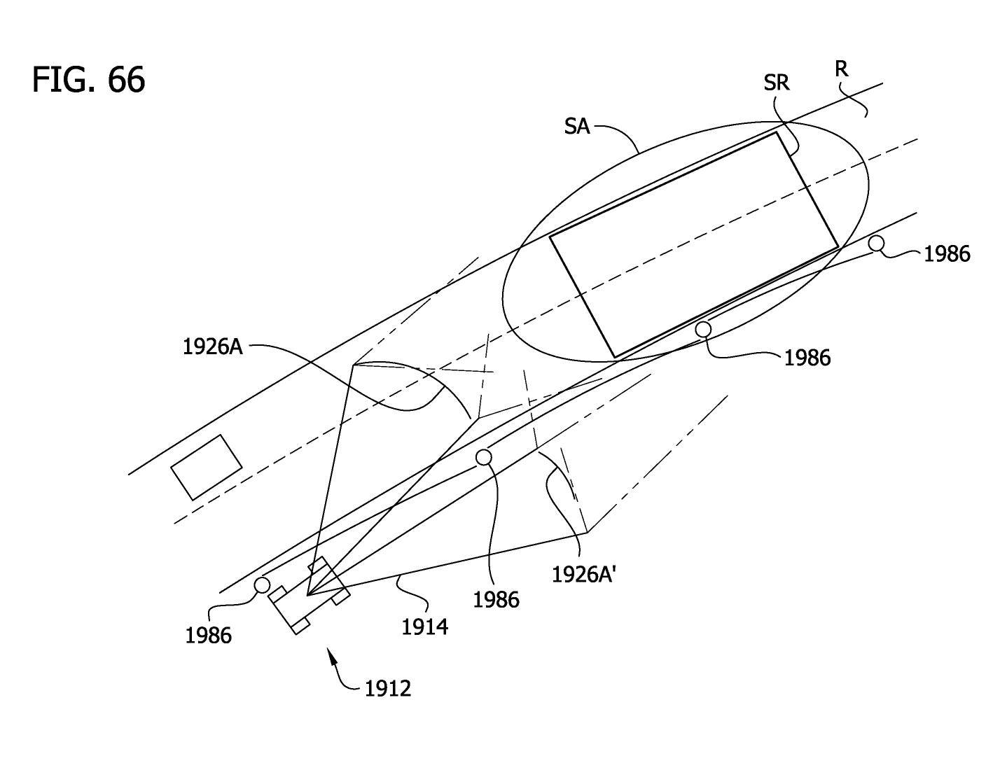

FIG. 66 shows a special situation in which the scan region SR is limited by the desire not to interfere with the roadway R and also by environmental objects such as utility poles 1986, poles 1982, signs 1980 (FIG. 65) or other obstructions. The planning information described can, in addition to determining the scan position, etc. for the scan to be accomplished, also provide “geo-fencing” to prevent the boom 1914 carrying the SAR pod 1916 from hitting environmental objects. The control can be in the form of proximity warnings or actual direct control of boom movements. In FIG. 66, a first scan path 1926A is illustrated extending over the roadway R. This scan path 1926A may be undesirable due to swinging the boom 1914 out into or over traffic and due to the obstruction of the utility poles 1986 (and associated utility lines). A second and in some cases more desired scan path 1926A′ is illustrated beside the roadway R. In this case, the field computer 1965, display device 1963, and/or off-site computer 1761 may have planned for location of the boom 1914 to be beside the roadway R and planned for the boom to execute the scan path 1926A′ to the side of the roadway by taking into consideration the desire to avoid the traffic and utility poles 1986. In one example, the off-site computer 1761 planned for execution of the first scan path 1926A over the roadway R. The display device 1963 and/or field computer 1965 may be adapted for modifying the planned scan paths. For example, a person may input into the display device 1963 or field computer 1965 environmental conditions such as high traffic volume, location of boom obstructions (e.g., utility poles, trees, etc.) location of potential false radar reflection points, location of vehicle obstructions (e.g., car parked in planned position for SAR vehicle), and/or other parameters such that the display device 1963, field computer 1965, and/or off-site computer 1761 (in communication with the display device or field computer) may determine a secondary suggested position for the SAR vehicle 1912 and/or orientation of the boom 1914 for executing the desired scan.

Various methods may be used to actually position the vehicle 1912 and/or boom 1914 in a planned position for execution of an SAR scan. For example and without limitation, an image such as shown in FIG. 60 may be displayed to the person attempting to position the vehicle 1912 and boom 1914. The display (e.g., of the field computer 1965 or display device 1963) may show in real time or semi real time the location of the vehicle 1912 and boom 1914 with respect to their planned positions for indicating to an operator how to move them into their respective planned positions. It may be desirable to precisely position the vehicle 1912 and/or boom 1914 to ensure the performed scan covers the desired scan area SA. For example without limitation, referring to FIG. 60, one of the indicated vehicle positions 1914 may be the current position of the vehicle, with the estimated scan area SA1 of that vehicle position also being indicated. The other indicated vehicle position 1912 may be the suggested position for the vehicle, with its scan area SA2 also being shown. Thus, the display may show the current position of the vehicle 1912 with respect to the suggested position for assistance in moving the vehicle and/or moving the boom 1914 to the suggested position for performing the SAR scan of the desired scan area SA. Other techniques may be used to position the vehicle 1912 and boom 1914 in the planned positions. The SAR pod 1916, field computer 1965, or display device 1963 may include a communication system including a signal generator other than a display for indicating to an operator the closeness of the vehicle or boom to their planned positions. For example and without limitation, a light or series of lights may illuminate, or a sound emitting device (e.g., speaker) may chirp, according to the proximity of the vehicle and/or boom to their planned positions. It may be desirable to use such a communication system to facilitate orienting the boom with respect to the scan area SA such that the SAR pod 1916 is aimed in the general direction of the scan area so an automatic orientation adjustment system such as described above may be permitted to more finely position the antenna structure of the pod with respect to the scan area. Moreover, it is envisioned that a totally robotic operation of the boom 1914 may be used, in which the image information can be input directly into the automated control system. The vehicle 1912 may automatically move or a person operating the vehicle may move the vehicle and/or boom 1914 toward the suggested position. Current position of the vehicle 1912 may be determined using a position indicating system described above.

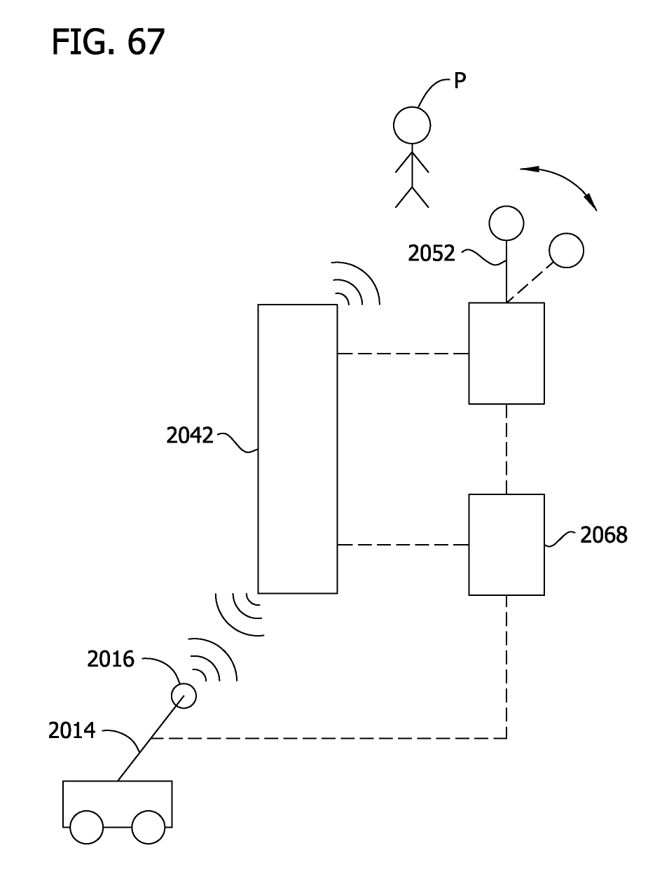

Some of the possible configurations for control of the boom 2014 for positioning or for performing an SAR scan are diagrammatically illustrated in FIG. 67. A system for performing the synthetic aperture radar scan may include a boom movement guidance system 2042. In a simple form, the guidance system 2042 may provide visual and or audible warnings to the boom operator P of proximity to an obstruction. As will be described more fully below, certain mechanical controls 2050, 2062 of the boom operating lever or levers 2052 can be used according to the information obtained to the planning stage of the scan. The mechanical controls can be simple stops 2050 or more sophisticated electromechanical controls 2062 of the lever. Finally, the scan information described above can be fed directly into the machinery or drive system 2068 of the boom 2014 to control the movement. The normal control lever 2052 would be overridden in that event.

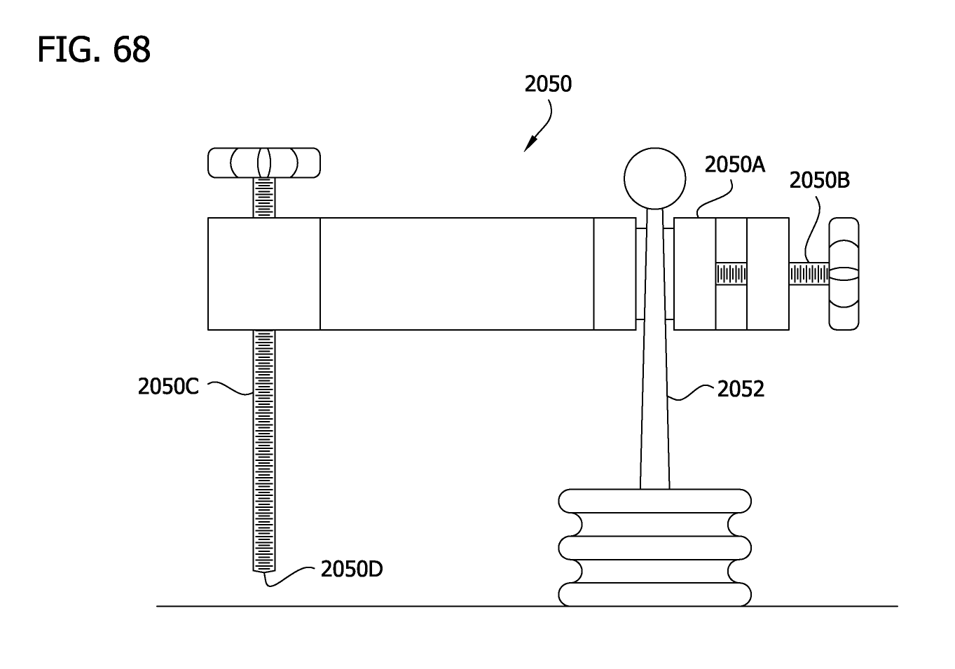

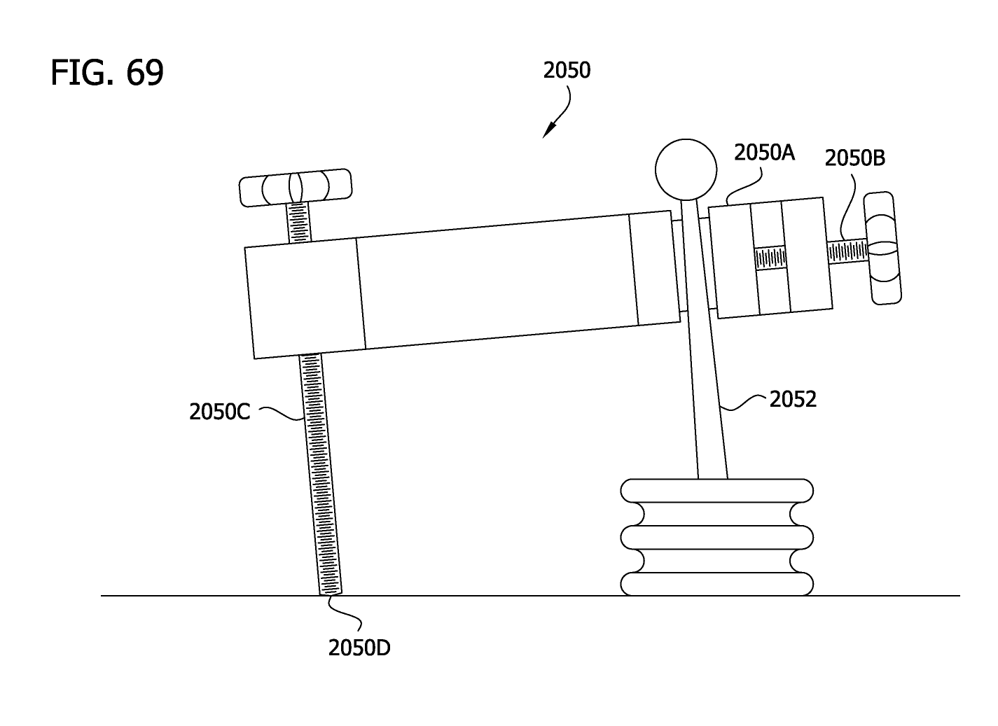

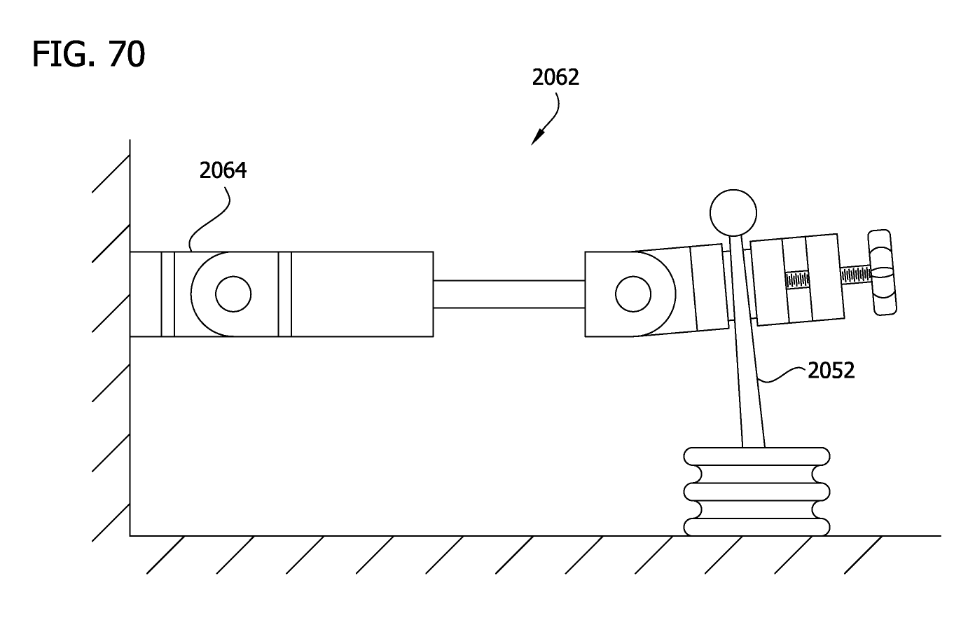

A basic mechanical stop or limiter 2050 is shown in FIG. 68. The stop 2050 is clamped on to the control lever 2052 for the boom control. In the illustrated embodiment, the stop includes a clamp 2050A including a knob-actuated screw 2050B. On the end of the stop 2050 away from the clamp 2050A, a stop element in the form of a longer knob-actuated screw 2050C having an engagement surface 2050D can be adjusted according to the information received from the scan planning so that it will engage a surface in the cabin of the vehicle having the boom to limit movement of the lever 2052 to the left (as seen in FIG. 68). This may limit maximum speed of the boom movement and/or prevent over-travel of the boom 2014 in one direction. The reasons for limiting speed or travel may be for safety, as described in the immediately preceding paragraphs, or to prevent movement of the boom 2014 and thus movement of the SAR pod 2016 to a degree which degrades the quality of the scan (e.g., excessive or inconsistent speed of movement). The limiting effect is illustrated in FIG. 69. A device similar to this can be used to completely control operation of the lever 2052. In FIG. 70, a control device 2062 is clamped on to the lever 2052, much as in the embodiment of FIGS. 68 and 69. However, in this case the control device 2062 is automatically actuated by a driving mechanism 2064 to move the lever 2052. As described above, other automatic systems could completely bypass the manual lever 2052 and operate the drive system 2068 (e.g., motors, valves, etc.) that control movement of the boom directly. The automatically actuated control device 2062 and/or the drive system 2068 may be operated in response to signals from the SAR pod 2016 indicative of speed of movement of the SAR pod and/or position of the SAR pod. The speed and position of the pod may be indicated by respective speed and position indicating systems, which, for example, may share a sensor such as a GPS antenna. The speed and/or position of the SAR pod 2016 can be automatically adjusted (e.g., if off by more than a predetermined threshold) to achieve desired movement of the SAR pod (e.g., along a desired scan path at a desired speed). A programmed raster pattern may be automatically performed.

It will be understood that the term “image” as used herein may refer to various types of depictions, representations including electronic representations, photographs, illustrations, or other images without departing from the scope of the present invention.

### OTHER STATEMENTS OF THE INVENTION

The following are statements of invention described in the present application. Although not currently presented as claims, they constitute applicant's statement of invention(s) believed to be patentable and may subsequently be presented as claims.

A1. A synthetic aperture radar pod adapted for mounting on a boom of a vehicle, the boom including an arm and an attachment connected to the arm, the attachment including at least one of a basket and an excavator tool and being connected to the arm by connection structure on the arm, the synthetic aperture radar unit being adapted for movement by the boom along a scan path for scanning material beneath a surface of a volume at a scan area, the synthetic aperture radar pod including:

a support structure;

a radar system mounted on the support structure, the radar system including:
a radar transmitter for providing an electromagnetic wave signal;
antenna structure operatively connected to the radar transmitter for receiving the electromagnetic wave signal from the radar transmitter and producing a radar signal in response to receiving the electromagnetic wave signal; and
a radar receiver operatively connected to the antenna structure for receiving reflected radar signals from the antenna structure, the reflected radar signals indicating distance of the antenna structure in time delay from production of the radar signal; and

a position indicating system mounted on the support structure adapted to generate information indicative of a position of the radar system corresponding to transmitted and received radar signals; and

a mount connected to the support structure adapted for releasably mounting the radar system and position indicating system on the boom of the vehicle.

A2. A synthetic aperture radar pod as set forth in claim A1 wherein the synthetic aperture radar pod is self-contained and portable pod such that components mounted on the support structure are movable with together with the support structure.

A3. A synthetic aperture radar pod as set forth in claim A1 wherein the mount is adapted for releasably mounting the radar system and position indicating system on the arm of the boom.

A4. A synthetic aperture radar pod as set forth in claim A1 wherein the mount is adapted for releasably mounting the radar system and position indicating system on the excavator tool of the boom.

A5. A synthetic aperture radar pod as set forth in claim A4 wherein the mount is adapted for releasably mounting the radar system and position indicating system on a rear side of the excavator tool.

A6. A synthetic aperture radar pod as set forth in claim A1 wherein the mount is adapted for releasably mounting the radar system and position indicating system on the basket of the boom.

A7. A synthetic aperture radar pod as set forth in claim A1 wherein the mount is adapted for releasably mounting the radar system and position indicating system on the connection structure on the arm in place of the at least one of the basket and the excavator tool.

A8. A synthetic aperture radar pod as set forth in claim A1 wherein the position indicating system includes an orientation indicating system, the orientation indicating system being adapted for indicating an orientation of the radar system with respect to the surface of the volume at the scan area.

A9. A synthetic aperture radar pod as set forth in claim A8 wherein the orientation indicating system includes a GPS antenna.

A10. A synthetic aperture radar pod as set forth in claim A8 wherein the orientation indicating system includes an inclinometer.

A11. A synthetic aperture radar pod as set forth in claim A8 wherein the orientation indicating system includes a compass.

A12. A synthetic aperture radar pod as set forth in claim A8 wherein the orientation indicating system includes a positional encoder adapted for indication rotational relationship of the antenna structure with respect to the mount.

A13. A synthetic aperture radar pod as set forth in claim A8 wherein the orientation indicating system includes a total station.

A14. A synthetic aperture radar pod as set forth in claim A8 further including a communication system in operative connection with the orientation indicating system for communicating the orientation of the synthetic aperture radar pod.

A15. A synthetic aperture radar pod as set forth in claim A14 wherein the communication system is adapted for indicating when the antenna structure is oriented at a Brewster angle with respect to the surface of the volume.

A16. A synthetic aperture radar pod as set forth in claim A14 further including an automatic orientation adjustment system adapted for orienting the antenna structure at the Brewster angle with respect to the surface of the volume.

A17. A synthetic aperture radar pod as set forth in claim A16 wherein the communication system is adapted for indicating when the antenna structure is oriented within a range of rotation of the automatic adjustment system with respect to the surface of the volume for permitting the automatic adjustment system to orient the antenna structure at the Brewster angle with respect to the surface of the volume.

A18. A synthetic aperture radar pod as set forth in claim A1 further including a safety connector, the safety connector being configured for connecting to the boom as a backup to the mount, the safety connector when not connected to the boom preventing operation of at least one of the radar system and the position indicating system.

A19. A synthetic aperture radar pod as set forth in claim A1 wherein the pod is adapted for mounting on a mounting structure so that the mounting structure is located generally on a side of the antenna structure that is opposite the side from which reflected radar signals are received.

A20. A method of performing a synthetic aperture radar scan with respect to a surface of a volume at a scan area, the method including:

performing a synthetic aperture radar scan using a synthetic aperture radar pod mounted on a boom of a vehicle, the synthetic aperture radar scan including the steps of:
orienting radar structure of the synthetic aperture radar pod toward the scan area;
moving the boom to move the antenna structure along a scan path;
directing a radar signal from the antenna structure toward the scan area;
receiving reflected radar signals with the antenna structure; and
indicating the positions of the antenna structure corresponding to transmitted and received radar signals.

A21. A method as set forth in claim A20 further comprising, before performing the synthetic aperture radar scan, moving the boom to orient the antenna structure at a Brewster angle with respect to the surface of the volume.

A22. A method as set forth in claim A21 further including receiving orientation signals from the synthetic aperture radar pod indicating orientation of the antenna structure, and wherein moving the boom comprises manually moving the boom in response to the orientation signals from the synthetic aperture radar pod to orient the antenna structure at the Brewster angle with respect to the surface of the volume.

A23. A method as set forth in claim A20 wherein moving the boom comprises generally orienting the antenna structure toward the scan area, and the method further comprises permitting the automatic orientation adjustment system to orient the antenna structure at a Brewster angle with respect to the surface of the volume.

A24. A method as set forth in claim A20 further comprising releasably mounting the synthetic aperture radar pod onto the boom of the vehicle.

A25. A method as set forth in claim A24 wherein releasably mounting the synthetic aperture radar pod on the boom includes releasably mounting the synthetic aperture radar pod on an arm of the boom at a position on the arm spaced from an excavator tool of the boom.

A26. A method as set forth in claim A24 further comprising excavating at the area using the excavator tool while the synthetic aperture radar pod remains releasably mounted on the arm.

A27. A method as set forth in claim A24 wherein releasably mounting the synthetic aperture radar pod on the boom includes releasably mounting the synthetic aperture radar pod on a basket of the boom.

A28. A method as set forth in claim A24 wherein releasably mounting the synthetic aperture radar pod on the boom includes releasably mounting the synthetic aperture radar pod on an excavator tool of the boom.

A29. A method as set forth in claim A24 wherein releasably mounting the synthetic aperture radar pod on the boom includes removing at least one of an excavator tool and basket from an arm of the boom and releasably mounting the synthetic aperture radar pod on mounting structure on the boom which previously mounted the at least one of the basket and excavator tool on the boom.

A30. A method as set forth in claim A20 wherein the method further comprises, after performing the synthetic radar aperture scan, removing the synthetic aperture radar pod from the boom.

A31. A method as set forth in claim A30 further comprising, after removing the synthetic aperture radar pod from the boom, excavating at the scan area using an excavator tool of the boom.

A32. A method as set forth in claim A20 further comprising, before performing the synthetic aperture radar scan, moving the synthetic aperture radar pod with respect to the boom from a first position to a scan position.

A33. A method as set forth in claim A32 wherein moving the synthetic aperture radar pod with respect to the boom comprises extending mounting structure mounting the synthetic aperture radar pod on the boom.

A34. A method as set forth in claim A32 further comprising moving the synthetic aperture radar pod toward the first position after performing the synthetic aperture radar scan.

A35. A method as set forth in claim A34 further comprising, after moving the synthetic aperture radar pod toward the first position, excavating at the scan area using an excavator tool of the boom.

A36. A method as set forth in claim A20 further comprising at least one of positioning surface markers and augmenting an excavation guidance system according to a location of material beneath the surface of the volume as indicated by the scan.

A37. A method as set forth in claim A20 further comprising maintaining the boom at a location which is on a side of the antenna that is opposite the side that receives the reflected radar signals.

A38. A method as set forth in claim A20 wherein while moving the boom to move the antenna structure along the scan path the boom inclines downwardly and rearwardly from the antenna structure.

A39. A method as set forth in claim A20 wherein while moving the boom, the boom is maintained at a substantially constant length.

A40. A vehicle adapted for performing a synthetic aperture radar scan with respect to the surface of a volume at a scan area, the vehicle including:

a boom including an arm; and

a synthetic aperture radar pod mounted on the boom, the synthetic aperture radar pod including:
a support structure;
a radar system mounted on the support structure, the radar system including:
   a radar transmitter for providing an electromagnetic wave signal;
   antenna structure operatively connected to the radar transmitter for receiving the electromagnetic wave signal from the radar transmitter and producing a radar signal in response to receiving the electromagnetic wave signal; and
   a radar receiver operatively connected to the antenna structure for receiving reflected radar signals from the antenna structure; and
a position indicating system mounted on the support structure adapted to generate information indicative of a position of the radar system corresponding to transmitted and received radar signals.

A41. A vehicle as set forth in claim A40 wherein the synthetic aperture radar pod is fixedly mounted on the boom.

A42. A vehicle as set forth in claim A40 wherein the synthetic aperture radar pod is releasably mounted on the boom.

A43. A vehicle as set forth in claim A40 further comprising a base supporting the boom, wherein the boom is inclined relative to the base upwardly and laterally away from the base.

A44. A vehicle as set forth in claim A40 wherein the synthetic aperture radar pod is mounted on the arm of the boom.

A45. A vehicle as set forth in claim A44 wherein the arm includes an elbow and the synthetic aperture radar pod is mounted on the arm adjacent the elbow.

A46. A vehicle as set forth in claim A40 wherein the boom includes an excavator tool adapted for excavating, the synthetic aperture radar pod being movable with respect to the boom while remaining mounted on the boom, the synthetic aperture radar pod having a scanning position with respect to the boom in which the synthetic aperture radar is positioned for scanning, and the synthetic aperture radar unit having an excavating position different than the scanning position in which the synthetic aperture radar is positioned for excavating by the excavator tool.

A47. A vehicle as set forth in claim A41 wherein the synthetic aperture radar pod includes mounting structure mounting the synthetic aperture radar pod on the arm of the boom, the mounting structure being movable for moving the synthetic aperture radar pod between first and second positions with respect to the boom.

A48. A vehicle as set forth in claim A47 wherein the mounting structure is extendable toward the first position and retractable toward the second position.

A49. A vehicle as set forth in claim A40 wherein the position indicating system includes an orientation indicating system, the orientation indicating system being adapted for indicating an orientation of the synthetic aperture radar pod with respect to the surface of the volume at the scan area.

A50. A vehicle as set forth in claim A49 wherein the orientation indicating system includes a GPS antenna.

A51. A vehicle as set forth in claim A49 wherein the orientation indicating system includes an inclinometer.

A52. A vehicle as set forth in claim A49 wherein the orientation indicating system includes a total station.

A53. A vehicle as set forth in claim A49 further including a communication system in operative connection with the orientation indicating system for communicating the orientation of the synthetic aperture radar pod.

A54. A vehicle as set forth in claim A49 wherein the communication system is adapted for indicating when the antenna structure is oriented at the Brewster angle with respect to the surface of the volume.

A55. A vehicle as set forth in claim A49 further including an automatic orientation adjustment system adapted for orienting the antenna structure at the Brewster angle with respect to the surface of the volume.

A56. A vehicle as set forth in claim A55 wherein the communication system is adapted for indicating when the antenna structure is oriented within a range of movement of the automatic adjustment system with respect to the surface of the volume for permitting the automatic adjustment system to orient the antenna structure at the Brewster angle with respect to the surface of the volume.

A57. A vehicle as set forth in claim A40 wherein the pod is mounted on the boom so that the boom is located generally on a side of the radar antenna that is opposite the side from which reflected radar signals are received.

A58. A vehicle as set forth in claim A40 wherein the arm has a fixed length.

B1. A vehicle adapted for performing a synthetic aperture radar scan with respect to the surface of a volume at a scan area, the vehicle including:

a boom including a base and an arm connected to the base, the boom having a longitudinal axis extending away from the base; and

a synthetic aperture radar unit mounted on the boom, the synthetic aperture radar system including:
support structure mounting the synthetic aperture radar system on the boom;
a radar transmitter for providing an electromagnetic wave signal;
antenna structure operatively connected to the radar transmitter for receiving the electromagnetic wave signal from the radar transmitter and producing a radar signal in response to receiving the electromagnetic wave signal; and
a radar receiver operatively connected to the antenna structure for receiving reflected radar signals from the antenna structure; and

a position indicating system mounted on the support structure adapted to generate information indicative of a position of the radar system corresponding to transmitted and received radar signals;

wherein the boom extends from the support structure of the radar system at an angle downwardly and laterally away from the support structure.

B2. A vehicle as set forth in claim B1 wherein the boom includes a proximal end and a distal free end, the proximal end being connected to the base, and the synthetic aperture radar system being mounted on the distal free end.

B3. A vehicle as set forth in claim B1 wherein the antenna structure is oriented in a direction facing away from the boom.

B4. A vehicle as set forth in claim B1 wherein the synthetic aperture radar system is connected to the boom on a side of the antenna structure that is opposite the side from which reflected radar signals are received.

B5. A method of performing a synthetic aperture radar scan with respect to a surface of a volume at a scan area using a synthetic aperture radar system mounted on a boom of a vehicle, the method including:

orienting radar structure of the synthetic aperture radar system toward the scan area;

moving the boom to move the antenna structure along a scan path;

maintaining the boom in an inclined orientation relative to the synthetic aperture radar system extending rearwardly and downwardly away from the synthetic radar system;

directing a radar signal from the antenna structure toward the scan area;

receiving reflected radar signals with the antenna structure; and

indicating the positions of the antenna structure corresponding to transmitted and received radar signals.

B6. A method as set forth in claim B5 wherein moving the boom comprises moving the boom to move the antenna structure along a raster including multiple scan paths.

B7. A method as set forth in claim B5 wherein at least some of the multiple scan paths are arcuate.

B8. A method as set forth in claim B5 wherein while moving the boom the antenna structure is oriented in a direction facing away from the base.

C1. A system for performing a synthetic aperture radar scan with respect to a surface of a volume at a scan area, the system including:

a base;

a boom connected to the base, the boom including an arm, the arm being for rotation about an axis of rotation causing the arm to travel along an arcuate path, the arcuate path having a concave side facing generally toward the axis of rotation and having a convex side facing generally away from the axis of rotation; and

a synthetic aperture radar pod mounted on the boom for travel along the arcuate path, the synthetic aperture radar pod including:
a radar system including:
a radar transmitter for providing an electromagnetic wave signal;
antenna structure operatively connected to the radar transmitter for receiving the electromagnetic wave signal from the radar transmitter and producing a radar signal in response to receiving the electromagnetic wave signal, the antenna structure being oriented away from the axis of rotation toward the scan area on the convex side of the arcuate path; and
   a radar receiver operatively connected to the antenna structure for receiving reflected radar signals from the antenna structure; and
a position indicating system for indicating a position of the radar system corresponding to transmitted and received radar signals.

C2. A system as set forth in claim 1 wherein the arm is mounted for rotation about a generally horizontal axis of rotation causing the arm to travel along a vertical arcuate path.

C3. A system as set forth in claim 1 wherein the boom is configured for rotating the arm about a generally vertical axis of rotation causing the arm to travel along a horizontal arcuate path.

C4. A system as set forth in claim 1 wherein the boom is inclined relative to the synthetic aperture radar pod downwardly and rearwardly away from the base.

C5. A system as set forth in claim 1 wherein the position indicating system is adapted for indicating an X-position and a Y-position of the radar system along respective X- and Y-axes of a three-dimensional Cartesian coordinate system.

C6. A system as set forth in claim 1 wherein the position indicating system is adapted for continuously indicating the position of the radar system as the synthetic aperture radar unit is moved along the arcuate path.

C7. A system as set forth in claim 1 wherein the antenna structure is adapted for continuously producing the radar signal and the radar receiver is adapted for continuously receiving reflected radar signals.

C8. A system as set forth in claim 1 further including a position accuracy indicating system for indicating accuracy of the indicated positions of the phase centers.

C9. A system as set forth in claim 8 wherein the position accuracy indicating system includes an inertial measurement device, the inertial measurement device monitoring inertia of the radar system as it moves along the arcuate path and signaling a deviation from the arcuate path based on a change in inertia of the radar system.

C10. A system as set forth in claim 8 wherein the position accuracy indicating system monitors the position of the antenna structure along the arcuate path and corrects detected position of the antenna structure if the detected position is indicated as being off the arcuate path.

C11. A system as set forth in claim 10 wherein the position accuracy indicating system signals to exclude received radar signals when the corresponding detected position of the radar system is outside of a threshold positional deviation with respect to the arcuate path.

C12. A system as set forth in claim 1 further comprising an aiming system for maintaining the antenna structure aimed toward the scan area as it is moved along the arcuate scan path.

C13. A system as set forth in claim 12 wherein the aiming system comprises at least two GPS antennas.

C14. A system as set forth in claim 12 wherein the aiming system includes a machine vision system.

C15. A system as set forth in claim 1 wherein the pod is adapted for mounting on a mounting structure so that the mounting structure is located generally on a side of the antenna structure that is opposite the side from which reflected radar signals are received.

C16. A method of performing a synthetic aperture radar scan with respect to a surface of a volume at a scan area, the method including:

orienting an antenna structure of a radar system toward the scan area;

moving the antenna structure along an arcuate scan path, the arcuate scan path having a convex side facing the scan area and having a concave side facing away from the scan area;

directing a radar signal from the antenna structure toward the scan area on the convex side of the arcuate scan path;

receiving reflected radar signals with the antenna structure from the convex side of the arcuate scan path; and

indicating the position of the radar system corresponding to transmitted and received radar signals.

C17. A method as set forth in claim 16 wherein moving the antenna structure along the arcuate scan path comprises moving the antenna structure generally vertically along an arcuate path.

C18. A method as set forth in claim 17 wherein moving the antenna structure comprises moving a boom on which the antenna structure is mounted, and while moving the boom to move the antenna structure along the scan path the boom is inclined relative to the antenna structure downwardly and rearwardly away from the antenna structure away from the scan area.

C19. A method as set forth in claim 16 wherein moving the antenna structure along the arcuate scan path comprises moving the antenna structure generally horizontally along an arcuate path.

C20. A method as set forth in claim 16 wherein moving the antenna structure comprises rotating a boom about an axis of rotation on which the antenna structure is mounted.

C21. A method as set forth in claim 16 wherein indicating the position of the radar system includes indicating an X-position and a Y-position of the radar system along respective X- and Y-axes of a three-dimensional Cartesian coordinate system.

C22. A method as set forth in claim 21 wherein indicating the position of the radar system includes indicating a Z-position of the radar system along a respective Z-axis of the three-dimensional Cartesian coordinate system.

C23. A method as set forth in claim 16 wherein indicating the position of the radar system includes continuously indicating the position of the radar system as the antenna structure is moved along the arcuate scan path.

C24. A method as set forth in claim 16 wherein the radar signal is continuously transmitted and the reflected radar signals are continuously received as the antenna structure is moved along the arcuate scan path.

C25. A method as set forth in claim 16 further comprising monitoring inertia of the radar system as the antenna structure is moved along the arcuate scan path and signaling a deviation from the arcuate scan path based on a change in inertia of the radar system.

C26. A method as set forth in claim 16 further comprising indicating accuracy of the detected positions of the radar system by comparing the detected positions of the radar system to positions along the arcuate scan path.

C27. A method as set forth in claim 26 further comprising, when an indicated position is indicated to be inaccurate, adjusting the indicated position of the radar system to a position along the arcuate scan path.

C28. A method as set forth in claim 27 further comprising, when an indicated position is indicated to be inaccurate beyond an acceptable threshold, disregarding the received reflected radar signals corresponding to the indicated inaccurate position.

C29. A method as set forth in claim 16 wherein moving the antenna structure along an arcuate path includes moving the antenna structure along a raster pattern including a generally serpentine path.

C30. A method as set forth in claim 16 further comprising maintaining the antenna structure of the radar unit aimed toward the scan area.

C31. A method as set forth in claim 30 wherein maintaining the antenna structure aimed toward the scan area includes automatically rotating the antenna structure as the antenna unit moves along the arcuate scan path.

C32. A method as set forth in claim 30 wherein maintaining the antenna structure aimed toward the scan area comprises rotating the antenna structure in response to signals indicative of aim of the antenna structure with respect to the scan area.

C33. A method set forth in claim 16 further comprising mounting the antenna structure on a mounting structure so that the mounting structure is located generally on a side of the radar antenna that is opposite the side from which reflected radar signals are received during the scan.

D1. A system for performing a synthetic aperture radar scan with respect to a surface of a volume at a scan area, the system being adapted for use with a vehicle including a boom operable, the vehicle including a drive system adapted for driving movement of the boom and at least one control lever movable along a range of movement for causing movement of the drive mechanism, the system including:

a radar system adapted for mounting on the boom, the radar system including:
a radar transmitter for providing an electromagnetic wave signal;
antenna structure operatively connected to the radar transmitter for receiving the electromagnetic wave signal from the radar transmitter and producing a radar signal in response to receiving the electromagnetic wave signal; and
a radar receiver operatively connected to the antenna structure for receiving reflected radar signals from the antenna structure;

a position indicating system for indicating a position of the radar system corresponding to transmitted and received radar signals; and

a boom movement guidance system adapted for guiding the boom to move the radar system along a generally arcuate scan path.

D2. A system as set forth in claim D1 wherein the boom movement guidance system includes a control lever movement limiting device, the control lever movement limiting device being adapted for limiting the range of movement of the control lever.

D3. A system as set forth in claim D2 wherein the control lever movement limiting device includes an engagement surface for limiting the range of movement of the control lever.

D4. A system as set forth in claim D2 wherein the control lever movement limiting device is mountable on the control lever for limiting movement of the control lever along the range of movement beyond a control lever position in which the boom moves the radar system at a predetermined desired speed.

D5. A system as set forth in claim D1 wherein the control lever movement limiting device is adjustable within the range of movement of the control lever for adjusting the limitation of movement of the control lever imparted by the control lever movement limiting device.

D6. A system as set forth in claim D1 wherein the boom movement guidance system includes instructions for moving the boom to move the radar system along a raster pattern which includes the generally arcuate scan path and is suitable for generating a three-dimensional image.

D7. A system as set forth in claim D1 further including a speed sensing device, the speed sensing device being adapted for sensing a speed at which the radar system is moving.

D8. A system as set forth in claim D7 further including a communication system adapted for communicating the speed of the radar system for indicating whether the radar system is moving at a desired speed.

D9. A system as set forth in claim D7 wherein the boom movement guidance system includes a control lever movement mechanism.

D10. A system as set forth in claim D9 wherein the control lever movement mechanism is engaged with the control lever and adapted for moving the control lever along the range of movement.

D11. A system as set forth in claim D10 wherein the control lever movement mechanism is in operative communication with the speed indicating system, the control lever movement mechanism being adapted for automatically moving the control lever along the range of movement in response to speed of the radar system indicated by the speed indicating system.

D12. A system as set forth in claim D10 wherein the control lever movement mechanism is adapted for maintaining the control lever at a position when the speed of the radar system indicated by the speed indicating system is a predetermined desired speed, for moving the control lever to decrease the speed of the radar system when the speed of the radar system indicated by the speed indicating system is greater than the predetermined desired speed, and for moving the control lever to increase the speed of the radar system when the speed of the radar system indicated by the speed indicating system is less than the predetermined desired speed.

D13. A system as set forth in claim D10 wherein the control lever movement mechanism is disengageable from the control lever for permitting movement of the control lever along the range of movement independent of the control lever movement mechanism.

D14. A system as set forth in claim D7 wherein the drive mechanism is in operative communication with the speed indicating system, the drive mechanism being adapted for automatically adjusting the speed of the boom in response to speed of the radar system indicated by the speed indicating system.

D15. A system as set forth in claim D14 wherein the drive mechanism is adapted for maintaining movement of the boom at a current speed when the speed of the radar system indicated by the speed indicating system is a predetermined desired speed.

D16. A system as set forth in claim D1 wherein the drive mechanism is in operative communication with the position indicating system, the drive mechanism being adapted for automatically moving the boom for moving the radar system along the arcuate path in response to signals received from the position indicating system indicating position of the radar system.

D17. A system as set forth in claim D16 wherein the drive system is adapted for correcting movement of the boom when the position indicating system indicates the radar system is off the arcuate scan path by more than a predetermined threshold.

D18. A system set forth in claim D1 wherein the radar system is adapted for mounting on the boom so that the boom is located generally on a side of the antenna structure that is opposite the side from which reflected radar signals are received.

D19. A method of performing a synthetic aperture radar scan with respect to a surface of a volume at a scan area, the method including:

orienting antenna structure of a radar system toward the scan area;

automatically moving a boom on which the radar system is mounted to move the antenna structure along an arcuate scan path;

directing a radar signal from the antenna structure toward the scan area;

receiving reflected radar signals with the antenna structure; and

indicating the positions of the radar system corresponding to transmitted and received radar signals.

D20. A method as set forth in claim D19 wherein automatically moving the boom includes monitoring a speed of the radar system and changing a speed of movement of the boom to achieve a desired speed of the radar system.

D21. A method as set forth in claim D20 wherein automatically moving the boom includes automatically moving a control lever for changing the speed of the boom in response to indicated speed of the radar system.

D22. A method as set forth in claim D20 wherein automatically moving the boom includes automatically controlling a boom drive system in response to indicated speed of the radar system.

D23. A method as set forth in claim D19 wherein automatically moving the boom includes automatically adjusting movement of the boom in response to indicated position of the radar system to achieve movement of the radar system along the arcuate scan path.

D24. A method as set forth in claim D23 wherein automatically moving the boom includes automatically correcting movement of the boom to cause the radar system to travel along the arcuate scan path if movement of the radar system is indicated as being off the predetermined arcuate scan path by greater than a predetermined threshold.

D25. A method as set forth in claim D19 wherein automatically moving the boom includes moving the boom to move the antenna structure along a predetermined raster pattern.

D26. A method as set forth in claim D19 wherein automatically moving the boom comprises maintaining the boom at an inclined orientation extending upwardly and laterally toward the scan area.

D27. A method as set forth in claim D19 wherein automatically moving the boom includes moving the boom to move the antenna structure along a raster pattern which includes the generally arcuate scan path and is suitable for generating a three-dimensional image.

D28. A method as set forth in claim D27 wherein the raster pattern lies in a generally spherical segment raster window.

D29. A method as set forth in claim D20 wherein automatically moving the boom includes moving the boom to move the radar system along a raster pattern which includes the generally arcuate scan path and is based on at least one of soil dielectrics at the scan area, desired scan area, desired image resolution, desired continuity, and obstructions at the scan area.

D30. A method as set forth in claim D29 further including receiving input from a user indicative of said at least one of soil dielectrics at the scan area, desired scan area, desired image resolution, desired continuity, and obstructions at the scan area.

D31. A method as set forth in claim D1 further comprising mounting the radar system on a mounting structure so that the mounting structure is located generally on a side of the antenna structure that is opposite the side from which reflected radar signals are received.

D32. A method of performing a synthetic aperture radar scan with respect to a surface of a volume at a scan area, the method including:

orienting antenna structure of a radar system toward the scan area;

moving a boom on which the radar system is mounted to move antenna structure along an arcuate scan path, wherein moving the boom includes limiting movement of a control lever controlling movement of the boom along a range of movement of the control lever;

directing a radar signal from the antenna structure toward the scan area;

receiving reflected radar signals with the antenna structure; and

indicating the positions of the radar system corresponding to transmitted and received radar signals.

D32. A method as set forth in claim D32 wherein moving the boom includes maintaining the control lever in a control lever limited movement position in the range of movement of the control lever to move the boom at a substantially constant speed associated with the control lever limited movement position.

D33. A method as set forth in claim D33 further including adjusting the control lever limited movement position in the range of movement of the control lever to move the boom a different substantially constant speed associated with the adjusted control lever limited movement position.

D34. A method as set forth in claim D34 further including sensing the speed of the radar system, and wherein adjusting the control lever limited movement position includes adjusting the position based on the sensed speed of the radar system.

D35. A method as set forth in claim D32 further comprising receiving signals indicative of the speed of the radar system and adjusting the control lever limited movement position until the signals indicate the speed of the radar system is at a predetermined desired speed.

D36. A method as set forth in claim D36 wherein receiving the signals comprises receiving at least one of audio and visual signals indicating the speed is at least one of greater than or less than the predetermined desired speed.

D37. A method as set forth in claim D32 further including mounting a control lever movement limiting device on the control lever.

D38. A method as set forth in claim D32 further including removing the control lever movement limiting device from the control lever.

D39. A method as set forth in claim D32 further comprising mounting the antenna structure on the boom so that the boom is located generally on a side of the antenna structure that is opposite the side from which reflected radar signals are received.

E1. A computer adapted for planning positioning of a synthetic aperture radar system for collection of image data suitable for generating a three-dimensional image of material beneath a surface of a volume at a scan region, the computer comprising:

an input device adapted for receiving data associated with at least one of the scan region and the radar system;

a processor adapted for processing the data associated with the at least one of the scan region and the radar system;

a tangible computer readable storage medium including instructions for the processor to determine a suggested position of the synthetic aperture radar system for performing a synthetic aperture radar scan based on the data associated with the at least one of the scan region and the radar system.

E2. A computer as set forth in claim E1 wherein the storage medium includes instructions for the processor to determine a suggested position of the synthetic aperture radar system for performing the synthetic aperture radar scan based on soil dielectric properties present at the scan region.

E3. A computer as set forth in claim E1 wherein the storage medium includes instructions for the processor to determine a suggested position of the synthetic aperture radar system for performing the synthetic aperture radar scan based on a right of way at the scan region.

E4. A computer as set forth in claim E1 wherein the storage medium includes instructions for the processor to determine a suggested position of the synthetic aperture radar system for performing the synthetic aperture radar scan based on an obstruction at the scan region.

E5. A computer as set forth in claim E1 wherein the storage medium includes instructions for the processor to determine a suggested position of the synthetic aperture radar system for performing the synthetic aperture radar scan based on a desired scan area at the scan region.

E6. A computer as set forth in claim E1 wherein the storage medium includes instructions for the processor to determine a suggested position of the synthetic aperture radar system for performing the synthetic aperture radar scan based on a desired resolution of the three-dimensional image.

E7. A computer as set forth in claim E1 wherein the storage medium includes instructions for the processor to determine a suggested position of the synthetic aperture radar system for performing the synthetic aperture radar scan based on a desired overlap of a scan area with respect to another scan area at the scan region.

E8. A computer as set forth in claim E1 wherein the scan area is a first scan area and the storage medium includes instructions for the processor to determine a suggested position of the synthetic aperture radar system for performing the synthetic aperture radar scan based on adequacy of common correlative positional reference points with respect to a second scan area adjacent the first scan area.

E9. A computer as set forth in claim E1 wherein the storage medium includes instructions for the processor to determine whether an estimated scan area corresponding to the suggested position of the radar system includes an entirety of the predetermined scan region.

E10. A computer as set forth in claim E9 wherein the suggested position of the radar system is a first suggested position and the storage medium includes instructions for the processor to determine a second suggested position of the radar system for performing a second synthetic aperture radar scan if the processor determines the estimated scan area corresponding to the first suggested position of the radar system does not include the entirety of the predetermined scan region.

E11. A computer as set forth in claim E1 wherein the storage medium includes instructions for the processor to determine whether a past scan area includes an entirety of the predetermined scan region.

E12. A computer as set forth in claim E1 wherein the storage medium further includes instructions for the processor to determine whether a plurality of past scan areas includes an entirety of the predetermined scan region.

E13. A computer as set forth in claim E1 wherein the storage medium is adapted for storing data associated with at least one of the radar system and the position indicating system.

E14. A computer as set forth in claim E1 wherein the storage medium is adapted for storing data representative of a scan area associated with a radar scan.

E15. A method of planning positioning of a synthetic aperture radar system for collection of image data suitable for generating a three-dimensional image of material beneath a surface of a volume at a predetermined scan region, the method comprising:

inputting information into a computer for defining the scan region; and

receiving with the computer data associated with at least one of the synthetic aperture radar system and the scan region;

processing with the computer the data associated with at least one of the synthetic aperture radar system and the scan region to determine a suggested position for the synthetic aperture radar system for performing a synthetic aperture radar scan at the scan region.

E16. A method as set forth in claim E15 wherein processing the data includes processing data associated with soil dielectric properties present at the scan region.

E17. A method as set forth in claim E15 wherein processing the data includes processing data representative of a right of way at the scan region.

E18. A method as set forth in claim E15 wherein processing the data includes processing data representative of an obstruction at the scan region.

E19. A method as set forth in claim E15 wherein processing the data includes processing data representative of a desired scan area for the synthetic aperture radar scan at the scan region.

E20. A method as set forth in claim E15 wherein processing the data includes processing data representative of a desired resolution of the three-dimensional image.

E21. A method as set forth in claim E15 wherein processing the data includes processing data representative of a desired overlap of a scan area for the synthetic aperture radar scan at the scan region with respect to another scan area at the scan region.

E22. A method as set forth in claim E15 wherein processing the data includes determining whether an estimated scan area corresponding to the suggested position of the radar system includes an entirety of the predetermined scan region.

E23. A method as set forth in claim E22 wherein the suggested position for the synthetic aperture radar system is a first suggested position and processing the data further includes determining a second suggested position of the radar system for performing a second synthetic aperture radar scan if the estimated scan area corresponding to the first suggested position of the radar system does not include the entirety of the predetermined scan region.

E24. A method as set forth in claim E22 wherein processing the data includes determining adequacy of common correlative positional reference points with respect to another scan area at the scan region and the suggested position is determined to achieve adequacy of common correlative positional reference points.

E25. A method as set forth in claim E15 wherein processing the data includes determining whether a past scan area includes an entirety of the predetermined scan region.

E26. A method as set forth in claim E15 wherein processing the data includes determining whether a plurality of past scan areas includes an entirety of the predetermined scan region.

F1. A system adapted for a user to perform a synthetic aperture radar scan, the system including:

a radar system movable along a scan path for generating data representative of a three-dimensional image, the radar system including:
a radar transmitter for providing an electromagnetic wave signal;
antenna structure operatively connected to the radar transmitter for receiving the electromagnetic wave signal from the radar transmitter and producing a radar signal in response to receiving the electromagnetic wave signal; and
a radar receiver operatively connected to the antenna structure for receiving reflected radar signals from the antenna structure;

a position indicating system adapted to generate information indicative of a position of the radar system corresponding to transmitted and received radar signals; and

a position communication system in operative communication with the position indicating system for communicating to the user the position of the radar system with respect to a desired position of the radar system for performing a synthetic aperture radar scan.

F2. A system as set forth in claim F1 further comprising an input adapted for receiving input data representative of the desired position of the radar system for performing the synthetic aperture scan for defining the desired position.

F3. A system as set forth in claim F2 wherein the communication system is adapted for generating at least one of an audio signal and visual signal indicative to the user of the position of the radar system with respect to the desired position for performing the synthetic aperture radar scan.

F4. A system as set forth in claim F3 wherein the position communication system includes a display adapted for displaying the position of the radar system with respect to the desired position for performing the synthetic aperture radar scan.

F5. A system as set forth in claim F4 wherein the display is adapted for displaying the position of a vehicle carrying the radar system with respect to the desired position of the vehicle for performing the synthetic aperture radar scan.

F6. A system as set forth in claim F3 wherein the position communication system includes a speaker adapted for generating audio signals indicative of the position of the radar system with respect to the desired position for performing the synthetic aperture radar scan.

F7. A system as set forth in claim F1 wherein the position communication system includes at least one light adapted for indicating the position of the radar system with respect to the desired position for performing the synthetic aperture radar scan.

F8. A system as set forth in claim F1 wherein the position indicating system includes a GPS antenna.

F9. A system as set forth in claim F1 wherein the position indicating system includes a total station.

F10. A system as set forth in claim F1 further comprising a computer adapted for suggesting the desired position of the synthetic aperture radar system with respect to the scan region for performing the synthetic aperture radar scan.

F11. A system as set forth in claim F1 wherein the radar system is adapted for mounting on a mounting structure so that the mounting structure is located generally on a side of the antenna structure that is opposite the side from which reflected radar signals are received.

F12. A method of positioning a synthetic aperture radar system in a desired position of the radar system with respect to a predetermined scan region for performing a synthetic aperture radar scan at the scan region, the method comprising:

generating a signal indicative of a position of the radar system with respect to the desired position of the radar system for performing the synthetic aperture radar scan; and

moving the radar system in response to the signal to move the radar system closer to the desired position of the radar system for performing the synthetic aperture radar scan.

F13. A method as set forth in claim F12 wherein generating the signal includes generating at least one of an audio signal and visual signal.

F14. A method as set forth in claim F13 wherein generating the signal includes displaying on a display the position of the radar system with respect to the desired position.

F15. A method as set forth in claim F14 wherein generating the signal includes displaying on a display the position of a vehicle carrying the radar system with respect to the desired position of the vehicle.

F16. A method as set forth in claim F12 further comprising determining the position of the radar system with respect to the desired position.

F17. A method as set forth in claim F16 wherein determining the position of the radar system includes receiving GPS signals.

F18. A method as set forth in claim F16 wherein determining the position of the radar system includes operating a total station.

F19. A method as set forth in claim F12 wherein moving the radar system comprises moving a vehicle on which the radar system is mounted.

F20. A method as set forth in claim F19 wherein moving the radar system includes moving a boom of the vehicle on which the radar system is mounted.

F21. A method as set forth in claim F12 further comprising indicating an obstruction obstructing the radar system from being moved toward the desired position.

F22. A method as set forth in claim F21 further comprising determining a different desired position for the radar system for performing the synthetic aperture radar scan in response to the indicated obstruction.

F23. A method as set forth in claim F12 further comprising mounting the radar system on a mounting structure so that the mounting structure is located generally on a side of the radar system that is opposite the side from which reflected radar signals are received.

G1. A system adapted for a user to perform a synthetic aperture radar scan, the system including:

a radar system movable along a scan path for generating data representative of a three-dimensional image, the radar system including:
a radar transmitter for providing an electromagnetic wave signal;
antenna structure operatively connected to the radar transmitter for receiving the electromagnetic wave signal from the radar transmitter and producing a radar signal in response to receiving the electromagnetic wave signal; and
a radar receiver operatively connected to the antenna structure for receiving reflected radar signals from the antenna structure;

a position indicating system adapted to generate information indicative of a position of the radar system corresponding to transmitted and received radar signals; and

a display device including a display adapted for displaying an aerial image representative of at least a portion of the scan region and for displaying information associated with the radar system on the aerial image.

G2. A system as set forth in claim G1 wherein the display device is adapted for displaying a real-time position of the radar system on the aerial image as indicated by the position indicating system.

G3. A system as set forth in claim G1 wherein the display device is adapted for displaying an estimated future scan area on the aerial image.

G4. A system as set forth in claim G1 wherein the display device is adapted for displaying a suggested position of the radar system for producing radar signals and receiving reflected radar signals.

G5. A system as set forth in claim G1 wherein the display device is adapted for displaying multiple future scan areas on the aerial image in relation to each other.

G6. A system as set forth in claim G1 wherein the display device is adapted for displaying a past scan area on the aerial image.

G7. A system as set forth in claim G6 wherein the display device is adapted for displaying multiple past scan areas on the aerial image in relation to each other.

G8. A system as set forth in claim G1 wherein the display device comprises a hand-held wireless portable device.

G9. A system as set forth in claim G1 wherein the display device includes a receiver adapted for receiving a wireless signal transmitting the aerial image to the device.

G10. A system as set forth in claim G1 further comprising a camera, the camera being adapted for generating the aerial image.

G11. A system as set forth in claim G10 wherein the camera is positioned with respect to the antenna structure such that the camera is aimed in generally the same direction as the antenna structure for generating the aerial image representative of the surface of the volume in the direction in which the antenna structure is aimed.

G12. A system as set forth in claim G10 wherein the camera is in operative communication with the display device for transmitting the aerial image to the display device.

G13. A system as set forth in claim G10 wherein the display device is in wireless communication with the camera for receiving the aerial image from the camera.

G14. A system as set forth in claim G1 further comprising a computer in operative communication with the display device.

G15. A system as set forth in claim G14 wherein the computer is adapted for estimating a future scan area associated with a position of the radar system.

G16. A system as set forth in claim G14 wherein the computer is adapted for determining a suggested position of the radar system for performing a synthetic aperture radar scan.

G17. A system as set forth in claim G16 wherein the computer is adapted for determining a suggested position of the radar system based on a characteristic of the scan region.

G18. A system as set forth in claim G14 wherein the computer is separate from the display device.

G19. A system as set forth in claim G18 wherein the computer is adapted for wireless communication with the display device.

G20. A system as set forth in claim G14 wherein the computer is connected to the display device.

G21. A system as set forth in claim G20 wherein the computer and display device are provided as a portable handheld unit.

G22. A system as set forth in claim G1 further including an input device, the input device being adapted for receiving user-input information associated with at least one of the radar system and the scan region.

G23. A system as set forth in claim G22 further including an aiming system adapted for maintaining the radar structure aimed in the direction of the scan region as the radar structure is moved, the input device being adapted for receiving user-input information defining a reference point in the scan region used by the aiming system for maintaining the antenna structure aimed in the direction of the scan region.

G24. A system as set forth in claim G1 wherein the radar system is adapted for mounting on a mounting structure so that the mounting structure is located generally on a side of the antenna structure that is opposite the side from which reflected radar signals are received.

G25. A method of operating a radar system capable of providing data for generating a three-dimensional image of a scan area at a predetermined scan region, the method comprising:

emitting a radar signal from the radar system toward the scan area as the radar unit moves;

receiving reflected radar signals from the scan area with the radar system as the radar system moves;

generating in real time information indicative of the position of the radar unit; and

displaying an aerial image representative of at least a portion of the scan region and displaying information associated with the radar system on the aerial image.

G26. A method as set forth in claim G25 wherein displaying information associated with the radar system includes displaying a real-time position of the radar system on the aerial image.

G27. A method as set forth in claim G25 wherein displaying information associated with the radar system includes displaying a suggested position for the radar system for scanning a designated scan area.

G28. A method as set forth in claim G27 further comprising determining a suggested position of the radar system based on a characteristic of the scan region.

G29. A method as set forth in claim G28 wherein the suggested position of the radar system is determined based on soil dielectric properties present at the scan region.

G30. A method as set forth in claim G28 wherein the suggested position of the radar system is determined based on a right of way at the scan region.

G31. A method as set forth in claim G28 wherein the suggested position of the radar system is determined based on an obstruction at the scan region.

G32. A method as set forth in claim G25 wherein displaying information associated with the radar system includes displaying an estimated future scan area on the aerial image.

G33. A method as set forth in claim G32 wherein the estimated future scan area is displayed on the aerial image in relation to the predetermined scan region.

G34. A method as set forth in claim G32 wherein the displayed estimated future scan area is based on the current position of the radar system.

G35. A method as set forth in claim G32 further comprising displaying multiple future scan areas on the aerial image in relation to each other.

G36. A method as set forth in claim G25 wherein displaying information associated with the radar system includes displaying a past scan area on the aerial image.

G37. A method as set forth in claim G36 further comprising displaying multiple past scan areas on the aerial image in relation to each other.

G38. A method as set forth in claim G36 wherein the past scan area is displayed on the aerial image in relation to the predetermined scan region.

G39. A method as set forth in claim G25 further comprising generating the aerial image with a camera positioned adjacent the antenna structure and aimed in generally the same direction as the antenna structure.

G40. A method as set forth in claim G25 further comprising mounting the radar system on a mounting structure so that the mounting structure is located generally on a side of the antenna structure that is opposite the side from which reflected radar signals are received.

Having described the invention in detail, it will be apparent that modifications and variations are possible without departing from the scope of the invention defined in the appended claims.

When introducing elements of the present invention or the preferred embodiments(s) thereof, the articles “a,” “an,” “the,” and “said” are intended to mean that there are one or more of the elements. The terms “comprising,” “including,” and “having” are intended to be inclusive not exclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

1. A synthetic aperture radar pod adapted for movement along a scan path for scanning material in a volume beneath a surface of the volume at a scan area, the synthetic aperture radar pod including:
a support structure;
a radar system mounted on the support structure, the radar system including:
a radar transmitter for providing an electromagnetic wave signal;
antenna structure operatively connected to the radar transmitter for receiving the electromagnetic wave signal from the radar transmitter and producing a radar signal in response to receiving the electromagnetic wave signal; and
a radar receiver operatively connected to the antenna structure for receiving reflected radar signals from the antenna structure, the reflected radar signals indicating distance of the material beneath the surface of the volume from the antenna structure in time delay from production of the radar signal; and
a position indicating system mounted on the support structure adapted to generate information indicative of a position of the radar system corresponding to transmitted and received radar signals.

2. A synthetic aperture radar pod as set forth in claim 1 wherein the synthetic aperture radar pod is self-contained and portable such that components mounted on the support structure are movable together with the support structure.

3. A synthetic aperture radar pod as set forth in claim 1 wherein the position indicating system is adapted for indicating an X-position and a Y-position of the radar system along respective X- and Y-axes of a three-dimensional Cartesian coordinate system.

4. (canceled)

5. A synthetic aperture radar pod as set forth in claim 1 wherein the position indicating system is adapted for continuously indicating the position of the radar system as the synthetic aperture radar pod is moved along the scan path.

6. A synthetic aperture radar pod as set forth in claim 5 wherein the radar transmitter is adapted for continuously providing the electromagnetic wave signal and the radar receiver is adapted for continuously receiving reflected radar signals.

7-9. (canceled)

10. A synthetic aperture radar pod as set forth in claim 1 further comprising an aiming system for maintaining the antenna structure aimed toward the scan area as the synthetic aperture radar pod is moved along the scan path.

11-16. (canceled)

17. A synthetic aperture radar pod as set forth in claim 10 wherein the aiming system includes a camera adapted for generating at least one of video and photographic images.

18-21. (canceled)

22. A synthetic aperture radar pod as set forth in claim 10 wherein the aiming system is adapted for automatically maintaining the antenna structure aimed toward the scan area.

23. A synthetic aperture radar pod as set forth in claim 10 wherein the aiming system comprises at least two GPS antennas.

24. (canceled)

25. A synthetic aperture radar pod as set forth in claim 10 wherein the aiming system comprises a machine vision system including a vision device mounted on the support structure adapted for generating signals indicative of a position of a reference marker in the scan area.

26-27. (canceled)

28. A synthetic aperture radar pod as set forth in claim 1 wherein the position indicating system includes a local position indicating system for indicating a local position of the radar system with respect to a benchmark.

29-30. (canceled)

31. A synthetic aperture radar pod as set forth in claim 1 wherein the position indicating system includes a GPS antenna.

32. (canceled)

34. A synthetic aperture radar pod as set forth in claim 1 further including a wireless modem.

35-36. (canceled)

37. A synthetic aperture radar pod as set forth in claim 1 further including a computer mounted on the support structure operatively connected to the radar system and position indicating system, the computer being operative for controlling the radar system and position indicating system.

38-51. (canceled)

52. A method of operating a radar unit capable of providing data for generating a three-dimensional image, the method comprising:
emitting a radar signal from the radar unit toward the scan area as the radar unit moves;
receiving reflected radar signals from the scan area with the radar unit as the radar unit moves;
generating in real time information indicative of the position of the radar unit; and
correlating the position of the radar unit with the emitted and received reflected radar signals.

53-56. (canceled)

57. A method as set forth in claim 52 wherein the information indicative of the position of the radar unit is generated by a position indicating system including a position signal sensor positioned above a phase center of the radar system.

58. A method as set forth in claim 57 further including adjusting the information indicative of the position of the radar unit to correspond to an approximate position of the phase center by accounting for the position of the position signal receiver above the phase center.

59. A method as set forth in claim 52 further comprising moving the antenna structure along a raster pattern including a generally serpentine path.

60. A method as set forth in claim 52 further comprising maintaining antenna structure of the radar unit aimed toward the scan area.

61. A method as set forth in claim 60 wherein maintaining the antenna structure aimed toward the scan area includes automatically rotating the antenna structure as the antenna unit moves along the scan path.

62-94. (canceled)
